(19) United States
(12) Patent Application Publication
(10) Pub. No.: US 2023/0138163 A1
(43) Pub. Date: May 4, 2023

(54) SAFETY METRICS BASED PRE-CRASH WARNING FOR DECENTRALIZED ENVIRONMENT NOTIFICATION SERVICE

(71) Applicant: Intel Corporation, Santa Clara, CA (US)

(72) Inventors: Kathiravetpillai Sivanesan, Portland, OR (US); Leonardo Gomes Baltar, Muenchen (DE); Satish C. Jha, Portland, OR (US); Vesh Raj Sharma Banjade, Portland, OR (US); Arvind Merwaday, Beaverton, OR (US)

(21) Appl. No.: 18/089,862

(22) Filed: Dec. 28, 2022

Related U.S. Application Data
(60) Provisional application No. 63/311,858, filed on Feb. 18, 2022.

(51) Int. Cl. G08G 1/16

(52) U.S. Cl. CPC G08G 1/162; G08G 1/166

(57) ABSTRACT

The present disclosure is related to connected vehicles, computer-assisted and/or autonomous driving vehicles, Internet of Vehicles (IoV), Intelligent Transportation Systems (ITS), and Vehicle-to-Everything (V2X) technologies, and in particular, to enhanced decentralized environment notification (DEN) services and safety metrics based pre-crash warning for DEN messages (DENMs). The enhanced DEN services include mechanisms to alert road users of detected dangerous events due to safety metric violations, which are calculated based on sensor data/measurements. Safety metric-specific attributes are included in the DENM á la-carte container to carry the safety metrics violation to the neighboring stations. Additionally, the DENM situation container is also enhanced/expanded such that event type values can incorporate the safety metric violations and/or related events. For each metric, there is a threshold for triggering a DENM warning message, and the triggering conditions and logic for message generation are also described.

### RELATED APPLICATIONS

The present application claims priority to U.S. Provisional App. No. 63/311,858 filed on Feb. 18, 2022, the contents of which is hereby incorporated by reference in its entirety.

### TECHNICAL FIELD

The present disclosure is generally related to connected vehicles, computer-assisted and/or autonomous driving vehicles, Internet of Vehicles (IoV), Intelligent Transportation Systems (ITS), and Vehicle-to-Everything (V2X) technologies, and in particular, to safety metrics based pre-crash warning for decentralized environment notification (DEN) service.

### BACKGROUND

Intelligent Transport Systems (ITS) comprise advanced applications and services related to different modes of transportation and traffic to enable an increase in traffic safety and efficiency, and to reduce emissions and fuel consumption. Various forms of wireless communications and/or Radio Access Technologies (RATs) may be used for ITS. Cooperative Intelligent Transport Systems (C-ITS) have been developed to enable an increase in traffic safety and efficiency, and to reduce emissions and fuel consumption. In C-ITS, vehicles communicate with each other and/or with roadside infrastructure. C-ITS can greatly increase the quality and reliability of information available about the vehicles, their location, and the road environment. C-ITS improves existing services and will likely lead to new services for the road users, which, in turn, will bring major social and economic benefits and lead to greater transport efficiency and increased safety. C-ITS and its evolution to increasingly improve road safety and pave the way towards the realization of full autonomous driving based on the exchange of information via direct wireless short range communications dedicated to C-ITS and Road Transport and Traffic Telematics (RTTT).

### BRIEF DESCRIPTION OF THE DRAWINGS

In the drawings, which are not necessarily drawn to scale, like numerals may describe similar components in different views. Like numerals having different letter suffixes may represent different instances of similar components. Some implementations are illustrated by way of example, and not limitation, in the figures of the accompanying drawings in which:

FIG. 1 depicts an example road scenario for safety metrics measurement from vehicles or roadside infrastructure.

FIG. 2 illustrates decentralized environment notification message (DENM) structure and a Pre-Crash DENM á la carte container structure.

FIG. 3 illustrates an example representation of a measurement point for a pre-crash á la carte container and related quantities.

FIG. 4 illustrates an operative Intelligent Transport System (ITS) environment and/or arrangement.

FIG. 5 depicts an ITS-S reference architecture.

FIG. 6 depicts a decentralized environment notification basic service functional model.

FIG. 7 depicts a vehicle station.

FIG. 8 depicts a personal station.

FIG. 9 depicts a roadside infrastructure node.

FIG. 10 depicts example components of an example compute node.

FIG. 11 depicts an example neural network (NN).

FIG. 12 depicts an example reinforcement learning architecture.

### DETAILED DESCRIPTION

### 1. Decentralized Environment Notification (DEN) Aspects

Driving is a collaborative social activity, and it comes with a set of rules and regulations specified by local governmental authorities. Drivers have a social responsibility to keep other road users and properties safe while enjoying the driving privilege. Annually traffic accidents are causing thousands of deaths, injuries, and billions of dollars of property damage across the world. Human error, faulty equipment, and unpropitious environmental conditions are major causes of these accidents. According to the public data, human error is the prime reason for most accidents (see e.g., Shalev-Shwartz et al., On a Formal Model of Safe and Scalable Self-driving Cars, MOBILEYE, arXiv:1708.06374v6 [cs.RO] (27 Oct. 2018) (“[ShalevSchwartz]”). When facing dangerous or near dangerous situations while driving, drivers take some actions to prevent accidents and show some gestures and cues (e.g., facial or hand gestures, switching lights, honking) to warn other drivers and road users of any danger or compliment them for their actions.

Connectivity between vehicles (V2V) or vehicles and infrastructure (V2I) can be used to warn the drivers or autonomous vehicles about the dangerous situations in their surroundings and the possible crash. The onboard sensors on the vehicles or roadside infrastructure measure the environment variables. Based on the sensor measurements, the safety metrics are continuously calculated. The vehicles and roadside infrastructure have predefined safety envelopes for weather conditions, lighting, vehicle speed, presence of pedestrians, and other vulnerable road users (VRUs). The safety envelope basically defines the thresholds for safety metrics to generate warnings of dangerous situations.

Currently, there are no existing solutions dealing with imminent threats. [EN302637-3] discusses Decentralized Environmental Notification (DEN) basic service, which focuses on detecting various events and alerting road users of detected event(s) by transmitting a facility layer message called DEN message (DENM). DENMs alert road users of a detected event that has a potential impact on road safety or traffic conditions. However, current DEN basic service and DENM implementations do not consider events/warnings related to safety metric violations.

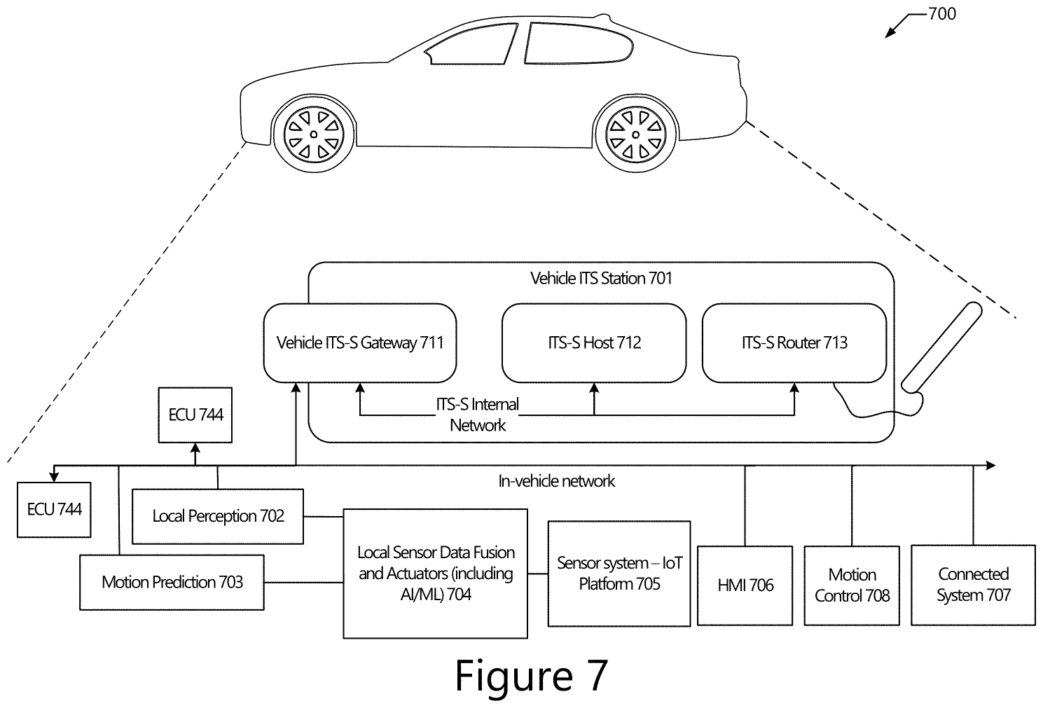

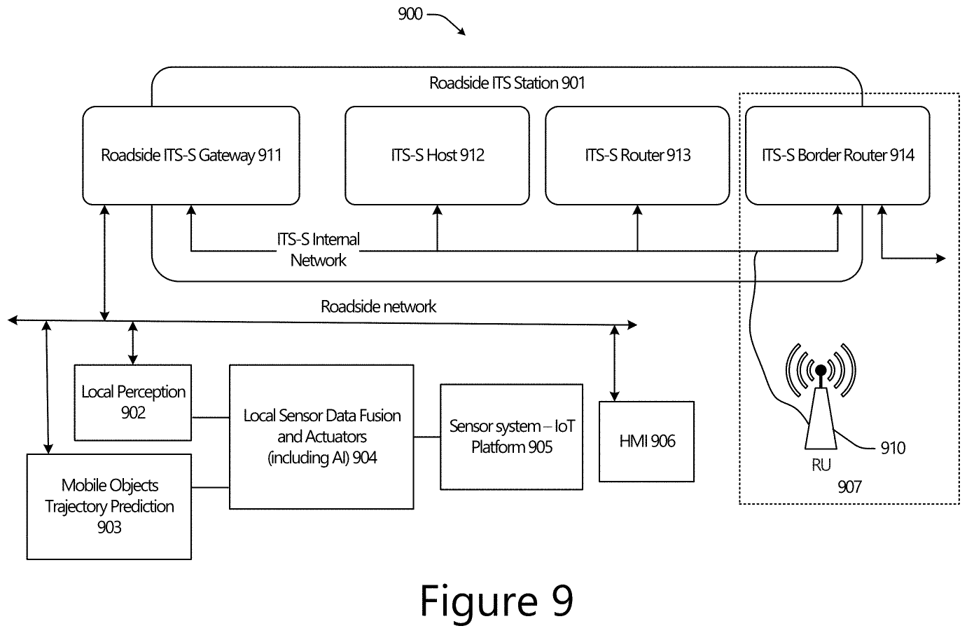

The present disclosure discusses several safety metrics to be used in determining the dangerous situations, including: minimum safe distances (e.g., longitudinal, lateral, and elevation); proper response action; minimum safety distance factor; rules of the road violation; behavioral competency; modified time to collision; and post encroachment time. The safety metrics are calculated or otherwise determined at the infrastructure (e.g., roadside infrastructure system 900 and/or R-ITS-S 901 discussed infra with respect to FIG. 9) and/or vehicles (e.g., vehicle system 700 and/or V-ITS-S 701 discussed infra with respect to FIG. 7) based on the sensor measurements (or sensor data). Violation of these safety metrics result in the event that has a potential impact on road safety or traffic condition, and therefore, such violation events should be disseminated to the neighbors as soon as possible to warn of the impending danger. Safety metric-specific attributes are included in the decentralized environment notification message (DENM) la-carte container to carry the safety metrics violation to the neighboring ITS-Ss (e.g., road users, such as roadside infrastructure 130, vehicles 110, VRUs, and/or the like). An extension to the existing DENM situation container is also provided to expand the eventType values to incorporate the safety metric violations and related events. For each safety metric, there is a threshold for triggering the DENM warning message. The triggering conditions and the logic for message generation are also described infra. The solutions in the present disclosure enable efficient and safe connected (autonomous) driving environments in a resource efficient manner.

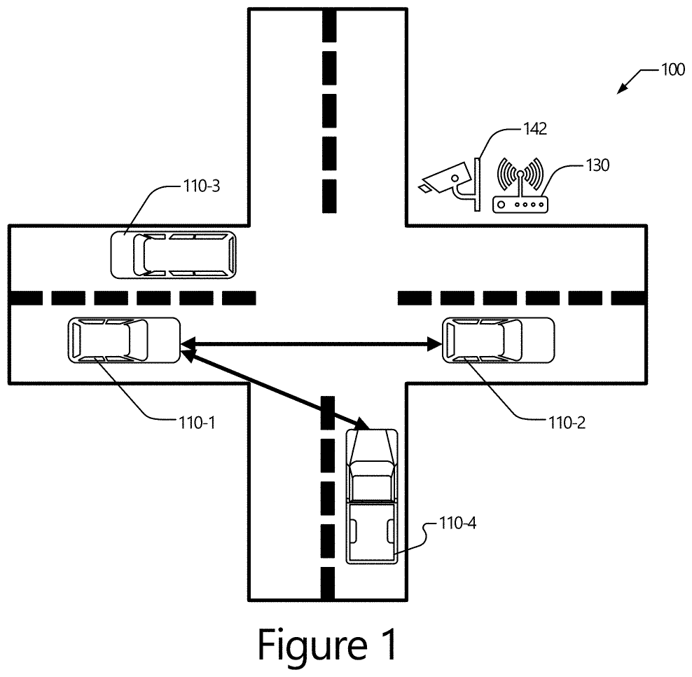

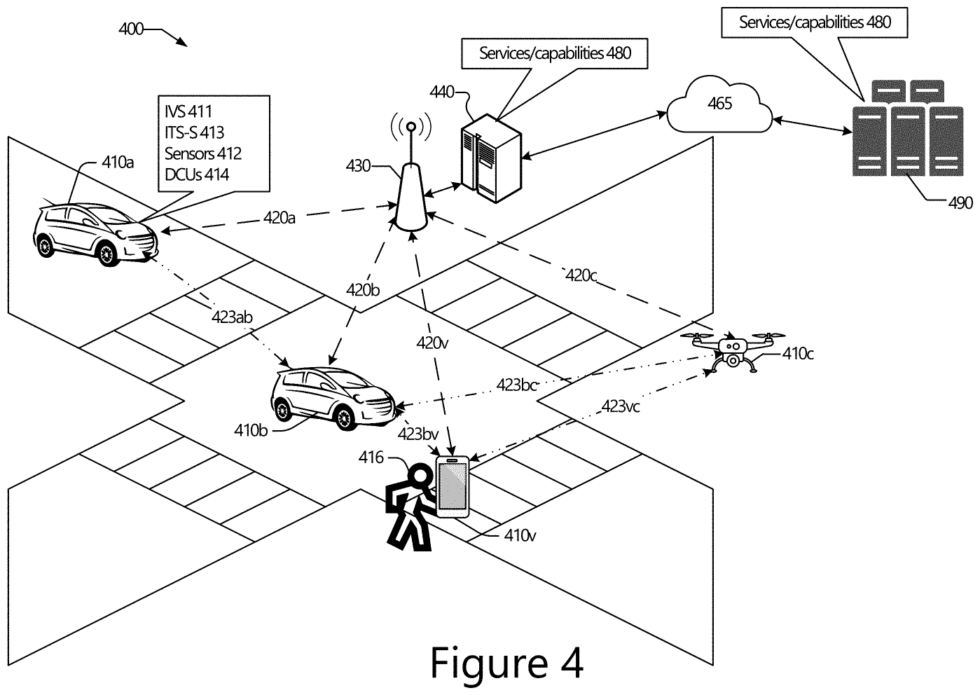

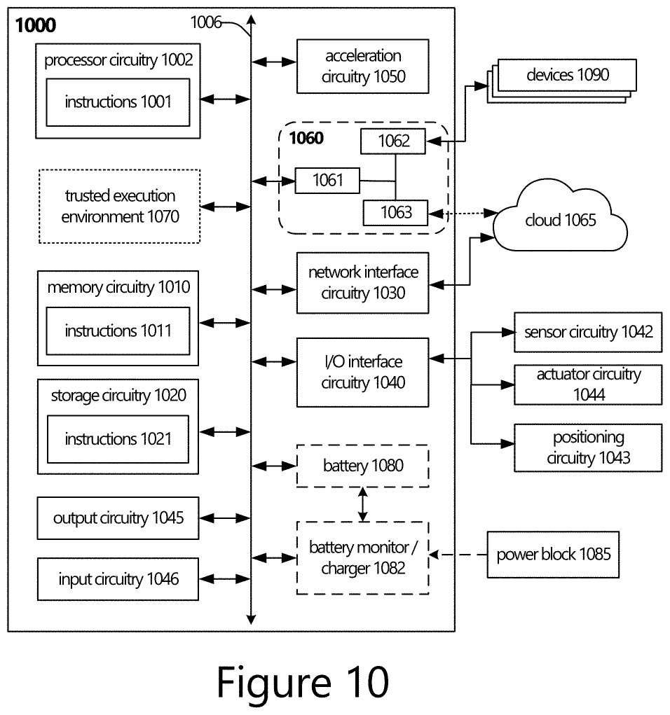

FIG. 1 shows an example road scenario 100 for safety metrics measurement from vehicles or roadside infrastructure. In this example scenario 100, one or more sensors 142 (e.g., cameras, Lidar, radar, microphones and/or other audio sensors, and/or the like) are connected to roadside infrastructure 130. The roadside infrastructure 130 may be the same or similar as the NANs 430 and vehicles 110-1 to 110-4 (collectively referred to as “vehicles 110” or “vehicle 110) may be the same or similar as the UEs 410 of FIG. 4. Additionally or alternatively, the one or more sensors 142 may be the same or similar as any of the sensors 1042 discussed infra w.r.t FIG. 10.

The roadside infrastructure 130 performs environment perception, identifying zero or more objects (e.g., vehicles 110, other road users (e.g., VRUs and the like), static and/or dynamic obstacles, and/or the like), and estimates kinematic parameters (e.g., speed, location, acceleration, heading, and/or the like) and tracking. Based on the estimated parameters, map data, and context information (e.g., system, environmental, and/or network conditions), the roadside infrastructure 130 calculates one or multiple of the following safety metrics: minimum safe distances (e.g., longitudinal, lateral and elevation); proper response action; minimum safety distance factor; rules of the road violation; driving behavioral competency; modified time to collision; and/or post encroachment time.

Additionally or alternatively, one or more of the vehicles 110 includes various sensors (e.g., such as any of those discussed herein) and performs environment perception, identifying zero or more objects (e.g., other vehicles 110, road users (e.g., VRUs and the like), static and/or dynamic obstacles, RSUs, and/or the like), and estimates kinematic parameters (e.g., speed, location, acceleration, heading, and/or the like) and tracking. Based on the estimated parameters, map data, and context information, the vehicle(s) 110 calculates one or multiple of the following safety metrics: minimum safe distances (e.g., longitudinal, lateral and elevation); proper response action; minimum safety distance factor; rules of the road violation; driving behavioral competency; modified time to collision; and/or post encroachment time.

In various implementations, DENMs include a pre-crash á la carte container that allows ITS-Ss the possibility to share information about a critical object in the surroundings (or environment), which has been detected by one or more sensors (e.g., cameras or other information sources mounted to the station), and with which a collision is imminent, for example, the time to collision (TTC) is very low and a complete mitigation of a collision is unlikely.

A representative pre-crash situation can include a first vehicle 110-1 that is about to have a collision with a stationary second vehicle 110-2, the TTC is so low, that a collision is likely (e.g., <1.5 seconds). In this situation, the vehicle 110-2 could take appropriate measures to mitigate the severity of the collision (e.g., tension the seatbelts) if it knew about the imminent collision. In this representative pre-crash situation, the vehicle 110-2 is equipped with V2X, but is not equipped with rear sensor(s); the oncoming vehicle 110-1 detects the vehicle 110-2 with its front sensors and determines that a collision is imminent; the vehicle 110-1 sends DENM with a pre-crash á la carte container; and the vehicle 110-2 prepares for a possible collision based on the DENM from the vehicle 110-1.

The Time-To-Collision (TTC) parameter is a calculated data element enabling the selection of the nature and urgency of a collision avoidance action to be undertaken (see e.g., [TR103300-1], [TS103300-2], [TS103300-3], and the like). The TTC is based on the relative speed between two objects divided by the spatial separation, and reflects the estimated time taken for collision based on the latest onboard sensor measurements and VRU awareness messages (VAMs). However, for conventional TTC include, the acceleration profiles of the objects are not considered, and the trajectory/path conflict are not taken into account.

Another representative use case includes the vehicle 110-1 not being equipped with V2X and where the vehicle 110-2 is equipped with V2X and not with rear sensor(s). An R-ITS-S 130 obtains object information from stationary sensors 142 (e.g., mounted on a traffic light or the like) and is able to detect a pre-crash situation between vehicle 110-2 and vehicle 110-1. The use case sequence for this example includes: (1) the vehicle 110-2 being equipped with V2X, but is not equipped with rear sensor(s); (2) R-ITS-S 130 and/or sensor(s) 142 recognize an approaching vehicle 110-1 having a high rear-collision risk with vehicle 110-2; (3) the R-ITS-S 130 sends a DENM with a pre-crash ala carte container; and (4) vehicle 110-2 prepares for a possible collision based on the received DENM.

In some examples, the Pre-Crash á la carte container for the DENM allows a road user to communicate a critical object with which a collision is likely and/or the R-ITS-S 130 is able to communicate a critical object for which a collision is likely. This allows other ITS-Ss to assess the situation and determine whether they are the communicated critical object themselves, and perform crash mitigation actions. An example of such crash mitigation actions is the so called Rear-End Collision Alert Signal (RECAS), which describes the flashing of the amber hazard warning signal as defined by the UN ECE Regulation No. 48.

1.1. Safety Metrics

1.1.1. Minimum Safe Distances

Minimum safe distance checks give a more accurate indication of the dangerous situations than conventional TTCs, and can be used to reduce the false alarm acceleration profiles and trajectory/path conflicts. Here, distance metrics, such as longitudinal distance (LoD), lateral distance (LaD), and vertical distances (VD), are calculated or otherwise determined continuously and/or periodically. Additionally, minimum safe distance thresholds include thresholds minimum safe LoD (MSLoD), minimum safe LaD (MSLaD), and minimum safe VD (MSVD). When the LoD, LaD, or VD fall below any combination of the thresholds MSLoD, MSLaD, and/or MSVD, a danger warning (e.g., DENM generation) is triggered. In some implementations, a warning is triggered when the LoD, LaD, and VD fall below the thresholds MSLoD, MSLaD, and/or MSVD simultaneously.

The minimum safe distance between two objects, such as an originating ITS-S (e.g., a V-ITS-S 110, VRU ITS-S, R-ITS-S 130, and/or the like) and a (perceived) object (e.g., another V-ITS-S 110, VRU ITS-S, R-ITS-S 130, a static and/or dynamic obstacle, and/or the like) is based on one or more of a (relative) distance between the originating ITS-S and the (perceived) object, a relative position of the originating ITS-S w.r.t the (perceived) object (e.g., the (perceived) object being in front of, behind, or lateral from the originating ITS-S, or the like), a relative speed between the originating ITS-S and the (perceived) object, a maximum possible acceleration of the originating ITS-S and/or the (perceived) object, a maximum possible deceleration of the originating ITS-S and/or the (perceived) object, a minimum possible deceleration of the originating ITS-S or the (perceived) object, and/or a response time of the originating ITS-S and/or the (perceived) object, and/or other parameters, conditions, and/or criteria. When vehicles 110 are traveling in the same or opposite direction, the LoDs and LaDs between vehicles 110 depends on the speeds (v), possible maximum accelerations (longitudinal a_{max,accel}^{long} lateral a_{max,accel}^{lat}), possible maximum decelerations (longitudinal a_{max,accel}^{lat} and lateral a_{min,brake}^{lat}), and response times of the front and rear vehicles 110 (ρ₁, ρ₂). See e.g., equations 1, 2, and 3.

$${d}_{min}^{long , same} = {[ {v}_{rear} {ρ}_{1} + \frac{1}{2} {a}_{max , accel}^{long} {ρ}_{1}^{2} + \frac{{( {v}_{rear} + {ρ}_{1} {a}_{max , accel}^{long} )}^{2}}{2 {a}_{min , decel}^{long}} - \frac{{v}_{front}^{2}}{2 {a}_{max , decel}^{long}} ]}_{+} \qquad ( 1 )$$

Equation 1 is used to calculate a MSLoD for a rear and front vehicles 110 driving in the same direction.

$${d}_{min}^{lat} = μ + [ \frac{2 {v}_{1} + {ρ}_{1} {a}_{max , accel}^{lat}}{2} ρ + \frac{{( {v}_{1} + {ρ}_{1} {a}_{1 max , accel}^{lat} )}^{2}}{2 {a}_{1 min , decel}^{lat}} - ( \frac{2 {v}_{2} - {ρ}_{1} {a}_{2 max , accel}^{lat}}{2} ρ - \frac{{( {v}_{2} - ρ {a}_{2 max , accel}^{lat} )}^{2}}{2 {a}_{min , decel}^{lat}} ) ] \qquad ( 2 )$$

Equation 2 is used to calculate a MSLaD, where vehicle₁ is to the left of vehicle₂, if the vehicles 110 travel in the opposite directions.

$${d}_{min}^{long , Opp} = \begin{matrix}[ {v}_{rear} {ρ}_{1} + \frac{1}{2} {a}_{1 , max , accel}^{long} {ρ}_{1}^{2} + \frac{{( {v}_{rear} + {ρ}_{1} {a}_{1 , max , accel}^{long} )}^{2}}{2 {a}_{1 , min , decel}^{long}} + \\ {\frac{2 \vert {v}_{front} \vert + {ρ}_{2} {a}_{max , accel}^{long}}{2} {ρ}_{2} + \frac{{( \vert {v}_{front} \vert + {ρ}_{2} {a}_{2 max , accel}^{long} )}^{2}}{2 {a}_{2 max , decel}^{long}} ]}_{+}\end{matrix} \qquad ( 3 )$$

Equation 3 is used to calculate a MSLoD for a rear and front vehicles 110 driving in the opposite direction.

Additionally, the minimum elevation (vertical) distance (dₘᵢₙ^{ele} or dₑₗₑ^{min}) is the difference between the lowest height of a static object (e.g., road structure, bridge, overpass, tree limb, street signs, and/or the like) and the highest point of a dynamic object (e.g., vehicle 110, VRU, and/or the like). In some examples, the values for the variables in equations 1, 2, and 3, and the elevation (vertical) distance and/or minimum elevation (vertical) distance can be position or negative to indicate directions relative to the ego station/user. The roadside infrastructure 130 or the ego vehicle 110 continuously and/or periodically calculates these metrics. The roadside infrastructure 130 and/or vehicles 110 will have minimum safe distance value thresholds in their decision systems or controllers. These thresholds can be defined or configured based on various vehicle parameters and/or capabilities and/or context information (e.g., system state information, environmental conditions, network conditions, and/or the like).

1.1.2. Proper Response Action

Suppose two objects (e.g., vehicles 110, other road users (e.g., VRUs and the like), static and/or dynamic obstacles, and/or the like) are in a dangerous or conflicting situation. A Proper Response Action (PRA) is defined as an instance of an action (e.g., acceleration or deceleration in longitudinal, lateral, and/or vertical directions, change of path and/or trajectory, and/or any other control action based on station/device capabilities) taken by the involved stations/users (e.g., vehicles 110, other road users (e.g., VRUs and the like)) to restore themselves to their calculated safety boundaries after a safe distance violation has occurred. The PRA may occur at a pre-determined or configured time and rate in order to be deemed a sufficient response.

1.1.3. Minimum Safety Distance Factor

The Minimum Safe Distance Factor (MSDF) is defined as the ratio of the principal directional distance and the minimum safe distance in that principal direction. There are MSDFs for longitudinal, lateral, and elevation (vertical) directions. The MSDFs give an indication of a safety level for the situation for individual stations/users (e.g., vehicles 110, other road users (e.g., VRUs and the like)), such as how safe the situation is for an ego station/user. As examples, the MSDFs can be expressed using equations 4a, 4b, and 4c.

$${MSDF}^{lat} = \frac{{d}_{lat}}{{d}_{lat}^{min}} \qquad ( 4 a )$$

$${MSDF}^{lon} = \frac{{d}_{lon}}{{d}_{lon}^{min}} \qquad ( 4 b )$$

$${MSDF}^{ele} = \frac{{d}_{ele}}{{d}_{ele}^{min}} \qquad ( 4 c )$$

In equation 4a, MSDF^{lat} is the MSDF in the lateral direction, dₗₐₜ is the principal lateral distance, and the dₗₐₜ^{min} is the minimum lateral distance (e.g., MSLaD). In equation 4b, MSDF^{lot} is the MSDF in the longitudinal direction, dₗₒₙ is the principal longitudinal distance, and the dₗₒₙ^{min} is the minimum longitudinal distance (e.g., MSLoD). In equation 4c, MSDF^{ele} is the MSDF in the vertical (elevation) direction, dₑₗₑ is the principal elevation (vertical) distance, and the dₑₗₑ^{min} is the minimum elevation (vertical) distance (e.g., MSVD). In some implementations, a larger (e.g., >1) MSDFs (e.g., lateral, longitudinal, and/or vertical) are good for maintaining safety, but could result in inefficient use of road/transportation resources. Additionally or alternatively, maintaining MSDF=1 can provide optimal operation in terms of safety and resource usage efficiency.

1.1.4. Rules of the Road Violation

The Rules of the Road Violation (RRV) is defined as an instance of road users violating a traffic regulation at that jurisdiction. Possible road violations to consider include but are not limited to disregarding a red light, disregarding a stop or yield sign, an illegal crossover of designated lane markings, exceeding speed limits, and improper or non-use of turn signals. It should be noted that there may be situations where it is necessary to violate a rule of the road to achieve a safe outcome. For example, if a vehicle is instructed to drive over the centerline by a police officer directing traffic, the vehicle should follow such instructions even though doing so would initiate a rule of road violation.

1.1.5. Driving Behavioral Competency

The Driving Behavioral Competency (DBC) is a confirmation that the originating ITS-S (e.g., vehicles and road users) have correctly executed a specific behavioral competency action(s) or maneuver(s). Sensors on the road infrastructure or vehicles monitor them continuously. This is applicable to both human-driven and autonomous vehicles. The behavioral competencies include maintaining proper speed for the road segment, merging, yielding, maneuvering around obstacles and road structures, proper braking/acceleration, giving right of way, and/or the like.

1.1.6. Modified Time to Collision (MTTC)

The MTTC is defined as the (predicted) time until a collision between two objects if both maintain their speed, acceleration, and/or trajectory profiles. In some implementations, roadside infrastructure 130 and/or vehicles 110 perform MTTC calculations based on sensor measurements (sensor data), environment perception data, localization, tracking, and AI/ML analytics. The roadside infrastructure or vehicles will have a minimum MTTC value threshold in their system for any two or more objects in conflicting maneuvers.

1.1.7. Post Encroachment Time (PET)

The Post Encroachment Time (PET) is defined as the (predicted) time from the end of an encroachment of the a first object (e.g., a lead vehicle 110 or lead road user (e.g., VRUs and the like), static and/or dynamic obstacle/object, and/or the like) to the beginning of encroachment of a second object (e.g., another vehicle 110, road user (e.g., VRUs and the like), static and/or dynamic obstacle/object, and/or the like) to a potential point of a collision or another conflict. The PET is a measure of how safe the road users are when they have conflicting objectives. A violation occurs if the measured PET is below a pre-determined threshold.

1.2. Trigger, Update, Repetition, and Termination Conditions

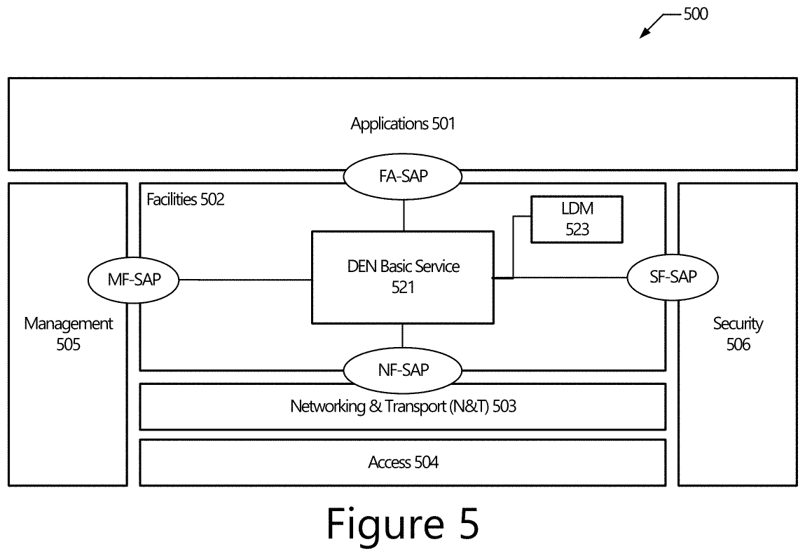

An ITS facilities layer (e.g., facilities layer 502 of FIG. 5) entity (a “facility”) (e.g., the DENBS 521, LDM 523, and/or the like) obtains sensor data/measurements and generates a 2D and/or 3D world view of the surrounding environment (e.g., state space representation) using AI/ML analytics, fusion, localization, tracking, and/or other like mechanisms, such as any of those discussed herein. The facility, another facility, or an ITS application calculates and/or tracks one or more of the aforementioned safety metrics continuously and/or on a periodic basis. The ITS-S (e.g., roadside infrastructure 130, vehicles 110, VRUs, and/or the like) will carry predetermined or configured threshold values of the metrics specified by the deploying entity. If the safety metrics cross the threshold, that entity will create a warning message (e.g., DENM) to be disseminated the surrounding stations (e.g roadside infrastructure 130, vehicles 110, VRUs, and/or other road users) resulting in a new DENM dissemination trigger. For example, the ITS application/facility can send an AppDENM_trigger request to the DENBS 521 (see e.g., Table 3-1 infra).

Once a New DENM dissemination is triggered, it can be repeated for a specified repetition duration using a repetition mechanism similar to that discussed in [EN302637-3].

If there is a change in one or more safety metrics beyond a given threshold (e.g., DENM_Update_Threshold) and safety metric violation is still valid, an update DENM is triggered. For example, the ITS application/facility can send an AppDENM_update request to DENBS 521 (see e.g., Table 3-1 infra) resulting in dissemination of an update DENM.

If there is a change in one or more safety metrics after a new or updated DENM trigger, the safety metric violation is now not valid, and there are no other detected events (e.g., existing events described in [EN302637-3] to be reported), DENM termination is triggered. For example, the ITS application/facility can send an AppDENM_termination request to the DENBS 521 (see e.g., Table 3-1 infra) resulting in dissemination/transmission of a cancellation DENM or a negation DENM to inform other ITS-Ss of the event termination.

If there is a change in one or more safety metrics after a new or updated DENM trigger and safety metric violation is now not valid; however, there is/are other detected event(s) (existing events described in [EN302637-3]) to be reported, an update DENM is triggered. For example, the ITS application/facility can send an AppDENM_update request to the DENBS 521 (see e.g., Table 3-1 infra) resulting in dissemination/transmission of a UpdateDENM.

Some or all of the safety metrics discussed previously are based on vehicle capabilities and parameters and/or context information (also referred to as “contextual information” or simply “context”). In some implementations, ITS-S (e.g., roadside infrastructure 130, vehicles 110, VRUs, and/or the like) periodically share that information among themselves to calculate the safety metrics accurately, or can share such information in response to a predefined and/or configured conditions, parameters, and/or criteria.

As examples, the context information includes or indicates a system state of the ITS-S, environmental conditions of (or surrounding) the ITS-S, and/or networking conditions/information. The context may include other information, both outside and inside the ITS-S, data, and/or conclusions that may be drawn from that information/data. The system state information may include or indicate data about the operation of the ITS-S such as, for example, hardware performance measurements and/or metrics, such as power consumption, processor performance, memory and/or storage utilization and/or free space, component load, battery state such as available power, and/or thermal data; OS and/or application parameters and requirements such as computational needs, input/output characteristics, and volume of exchanged data (e.g., upload or download); overload conditions experienced by the ITS-S; and/or any other metrics such as those discussed herein and/or those discussed in Intel® VTune™ Profiler User Guide, INTEL CORP., version 2022 (2 Jun. 2022) (“[VTune]”), the contents of which are hereby incorporated by reference in its entirety. The system state information can be collected by one or more sensors, telemetry agents, and/or internal components of various hardware and/or software subsystems implemented by the ITS-S, such as any of those discussed herein. The environment information includes or indicates data about an environment surrounding the ITS-S, such as, for example, current (outside) temperature, humidity, moisture, altitude, ambient light, ambient sound/volume, information/data related to geographic objects (e.g., mountains) and/or human-created objects (e.g., buildings, highways, and the like), weather data for a given location, and/or other like environmental measurements. The networking information includes or indicates data about a networks that the ITS-S is connected to, or is capable of connecting to. As examples, the networking information can include radio and/or channel state conditions; network connectivity metrics; data transfer rates; network and/or session parameters (e.g., network ID/addresses, session ID, port numbers, etc.); amount of data received over a network; security aspects of a currently attached network; and/or the like, including any of the measurements/metrics discussed herein.

1.3. Confidence Level of the Safety Metrics

As mentioned previously, the safety metrics discussed herein are calculated from various sensor data and/or other measurements. The AI/ML systems (e.g., computer vision, perception, object tracking, and/or other techniques) are used to extract information out of the sensor data/measurements. These techniques/algorithms can also provide confidence levels for corresponding outputs. Additionally, if fusion techniques of multiple sensor data/measurements are used, the corresponding enhanced confidence level can also be obtained from the algorithm. The confidence level of the safety metrics is/are derived using the aforementioned confidence values. In some examples, the confidence level of the corresponding safety metrics can also be included in the generated DENM along with the safety metrics.

1.4. Pre-Crash DENM (Á La Carte Container) Dissemination

The DEN basic service (e.g., DENBS 521 of FIG. 5 discussed infra) is an application support facility provided by the facilities layer 502, which resides below the application layer 501 and above Layer 3 (e.g., the N&T layer 503 in FIG. 5). The DENBS 521 constructs, manages, and processes the DENMs. The construction of a DENM is triggered by an (ITS-S) application. A DENM contains information related to a road hazard or an abnormal traffic condition, such as its type and its position. The DENBS 521 delivers the DENM as payload to the ITS N&T layer 503 for DENM dissemination. A DENM is disseminated to ITS-Ss that is/are located in a geographic area through direct V2V and/or V2I communications, or using other V2X technologies.

At the receiving (Rx) side, the DENBS 521 of the Rx ITS-S processes the received DENM and provides the DENM content to an ITS-S application. This ITS-S application may present the information to the driver if information of the road hazard or traffic condition is assessed to be relevant to the driver. The user (e.g., driver) is then able to take appropriate actions to react to the situation accordingly. In the case of connected (semi-)autonomous vehicles, the received DENM will be processed by the autonomous driver assistance system(s) (ADAS) in its planning and actuation and reflected in the vehicle navigation.

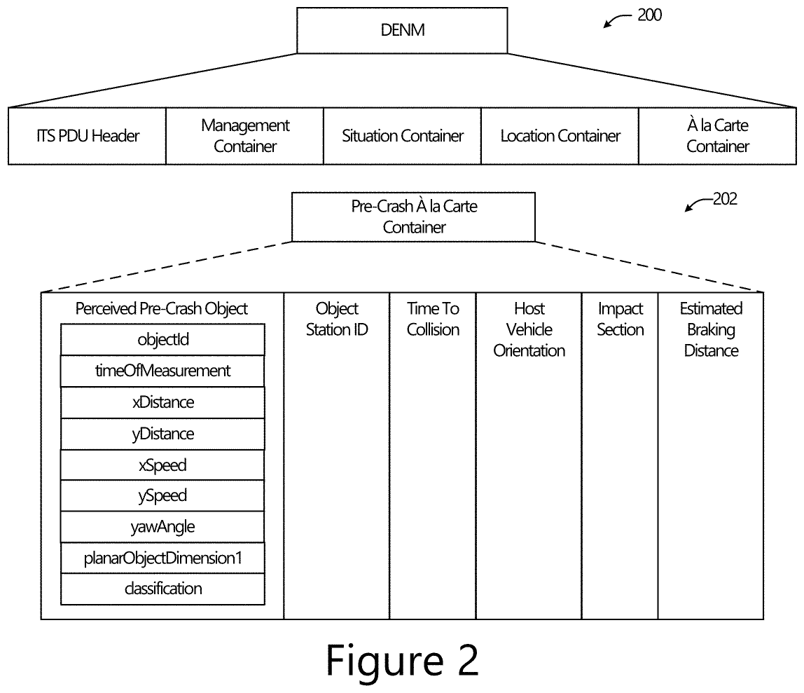

The structure of the DENM is illustrated in FIG. 2. A DENM is composed of a common ITS PDU header and multiple containers including, inter alia, an á la carte container. The á la carte container contains information specific to the use case, which requires the transmission of additional information that is not included in the three previous containers. The new safety metrics-based warnings may be included in the á la carte container. Aspects of this and other DENM containers is discussed infra in section 1.7.

Dissemination of the pre-crash pre-crash DENM with its á la carte container should be triggered with a CauseCode “collisionRisk” (97) and SubCauseCode (5) for Pre-Crash that is not yet defined. See e.g., Table 1.6-1, infra. The triggering conditions and profiling V2X messages can be implementation-specific and/or based on the various aspects discussed herein.

In one example, the conditions for the triggering of the DENM are: the computed TTC with the identified object is smaller than 1.5 seconds and the relative speed between the identified object and the host vehicle is smaller than −10 km/h. In another example, the conditions for the triggering of the DENM are based on the minimum safe distance metrics discussed herein. In either example, as the ITS-S closes in on the critical object, the DENM is updated every X milliseconds (ms) (e.g., X=100 ms) together with the data elements until the use case is terminated. A repetition of the DENM may or may not be used.

In some cases, a DENM is not triggered again as long as the previous use case is not terminated. When a change of the critical object is detected, the previous DENM is terminated and a new DENM with a new ActionID is triggered. When a DENM is terminated because the previous use case is not relevant anymore, a cancellation DENM is triggered. In some examples, repetition is not used for cancellation DENMs and/or negation DENMs are not used.

1.5. Den Service Application Types

1.5.1. DENM Trigger

A DENM trigger refers to the process of the generation and transmission of a DENM when the DENBS 521 of the originating ITS-S receives an application request with the type AppDENM_trigger. A DENM trigger triggers a new DENM to be generated. For DENM trigger, an unused actionID value is created by the DENBS 521.

When a new event occurs in the vicinity of an originating ITS-S (e.g., roadside infrastructure 130, vehicles 110, VRUs, and/or the like), the ITS-S creates an event with new actionID (e.g., unused value of the actionID in the sequence).

1.5.2. DENM Update

The originating ITS-S may detect the evolution of an event some time after the DENM trigger. The ITS-S application provides the update information to the DENBS 521 using the application request AppDENM_update. The DENBS 521 then generates an update DENM. This process is denoted as “DENM update”.

The parameter referenceTime is the identifier for DENM update referring to a specific actionID. The referenceTime represents the time at which a DENM is generated by the DENBS 521, after receiving the application request. For each DENM update, the referenceTime is updated and the value is greater than the referenceTime value of the previous DENM update for the same actionID. The actionID remains unchanged for DENM update, as long as the stationID of the originating ITS-S remains unchanged. The actionID remains unchanged when the validityDuration is updated, as long as the stationID of the originating ITS-S remains unchanged.

In some situations, the event already created by the originating ITS-S (e.g., roadside infrastructure 130, vehicles 110, VRUs, and/or the like) may need to be updated to accurately reflect some attributes. In the updated DENM, the actionID and the stationID do not change, but the other attributes could be updated.

1.5.3. DENM Repetition

In between two consequent DENM updates, a DENM may be repeated by the DENBS 521 of the originating ITS-S at a pre-defined or configured repetition interval in order that new ITS-Ss entering the destination area during the event validity duration may also receive the DENM. This process is referred to as “DENM repetition”.

The DENM repetition is activated under the request from the ITS-S application. If ITS-S application at the originating ITS-S requires the repetition of DENM, it provides the repetitionInterval and repetitionDuration in the application request as specified in [EN302637-3] § 5.4.1. If any of these data are not provided by the ITS-S application, the DENBS 521 does not execute the DENM repetition. At the reception of the application request, the DENM repetition scheduling starts from the referenceTime, corresponding to the time at which DENM is generated. For one particular actionID, DENM repetition should apply to the most updated DENM. In some implementations, a DENM is repeated for specified time and duty cycle with same actionID and stationID.

1.5.4. DENM Termination

The DENM termination indicates the end of the detected event. A DENM termination is either a cancelation or a negation. Cancellation DENM can only be transmitted by the originating ITS-S that originally requested the DENM trigger. A negation DENM can be transmitted by other ITS-Ss.

DENM termination by the originating ITS-S that requested the DENM trigger: For originating ITS-S that requested the DENM trigger, the DENBS 521 stops the DENM repetition automatically at the end of the repetitionDuration. The repetitionDuration may be updated by the ITS-S application of the originating ITS-S. Moreover, before the expiration of the validityDuration, the originating ITS-S may detect the termination of the event. In this case, the DENBS 521 generates a cancellation DENM as defined in [EN302637-3] § 4.2. The parameter termination is used for the cancellation DENM. For the generation of a cancellation DENM, termination is set to is Cancellation. For the generation of a cancellation DENM, the actionID value is identical to the actionID as set for the application request appDENM_trigger, as long as the stationID remains unchanged. In a cancellation DENM, the stationID value included in the actionID is identical to the stationID of the originating ITS-S.

DENM termination by an originating ITS-S that has not requested the DENM trigger, i.e. that has not created actionID of the event for which the DENM termination is intended: If an ITS-S has received a DENM from other ITS-S regarding an event, passes the indicated event position when the received DENM is still valid (i.e. validityDuration is not expired), and detects that the event has terminated, then the ITS-S application at this ITS-S may send a AppDENM_termination request to the DENBS 521, upon which the DENBS 521 generates a negation DENM as defined in [EN302637-3] § 4.2. The parameter termination is used for the negation DENM. For the generation of a negation DENM, termination is set to is Negation. For the generation of a negation DENM, the actionID is set to the actionID of the event for which the DENM negation refers to. The referenceTime is set to the value of the latest received DENM of the same actionID from the originating ITS, in order that the receiving ITS-S is able to match to which DENM the negation is reported by the negation DENM. In a negation DENM, the stationID value included in the actionID is not identical to the stationID value in the itsPduHeader (defined in Annex A) of the originating ITS-S that constructs the negation DENM. The ITS-S that initiates the negation DENM satisfies some predefined conditions as defined by ITS applications in [TS101539-1], [TS101539-2], and [TS101539-3].

For the cancellation DENM and negation DENM, the detectionTime is set as the time at which the event termination is detected by the originating ITS-S. Once the DENM is expired, the corresponding entry might be detected and the corresponding actionID may be used for future new DENM generation. Once a cancellation DENM or a negation DENM is verified to be trustworthy by the receiving ITS-S, all information related to the previously received DENMs concerning the same actionID may be considered as not valid any more, the DENBS 521 may notify ITS-S applications of the event termination.

A cancellation DENM or negation DENM is transmitted at least once by the originating ITS-S per application request. It may be repeated by the DENBS 521 of the originating ITS-S.

In some situations, the surrounding ITS-Ss (e.g., roadside infrastructure 130, vehicles 110, VRUs, and/or the like) may not agree or see the danger reported in the DENM message through their sensor data/measurements. In such situations one or more of these ITS-Ss may send the Negation DENM with original actionID and their own stationID. In some other situations the event created by a vehicle or roadside infrastructure may need to be terminated because the factors causing the event improved and don't cause any safety issues. The actionID and stationID are kept the same in the termination DENM.

1.5.5. DENM Relevance Area

A DENM should be disseminated to as many ITS-Ss as possible located in an area of relevance, denoted as relevance area. This includes ITS-Ss entering the relevance area until the validityDuration and ITS-Ss that have no connectivity to the originating ITS-S when the DENM is transmitted.

The relevance area is set by the ITS-S application of the originating ITS-S and is included in the DENM when the information is available. A receiving ITS-S may make use of the relevance area information to realize the relevance check.

According to the event type and the event location, the size and the shape of the relevance area varies. In some implementations, a relevanceDistance and a relevanceTrafficDirection are used as the relevance area information. The relevanceDistance is the distance within which the event is considered relevant to the receiving ITS-S. The relevanceTrafficDirection is the traffic direction along which the receiving ITS-Ss may encounter the event. Therefore, it is also the direction along which the DENM should be disseminated. As an example, for an accident on a motorway, the relevant traffic direction of a DENM related to the event may be the upstream direction of the accident location. While for the accident occurred in rural two-way roads, the relevanceTrafficDirection may be both traffic directions (including also the opposite carriageway). The relevanceDistance and the relevanceTrafficDirection are also specified in [EN302637-3], Annex A.

1.5.6. Location Referencing

Complementary to the relevance area, a DENM provides location referencing information of the event position. Here, the location referencing used by DENM is denoted as traces. A trace contains a list of well-ordered waypoints that forms an itinerary approaching towards the event position. The data formatting rules for waypoints and traces to be included in DENM are specified in [EN302637-3], Annex A. However, the total length covered by a trace or density of waypoints in a trace may vary depending on ITS application needs and/or implementation.

A DENM includes at least one trace. Multiple traces may be included in DENM, for example, in case there are more than one possible paths in which a detected event may be approached, e.g. in an intersection area. The traces location referencing is defined and provided by the ITS-S application of the originating ITS-S and is included in DENM. An Rx ITS-S may compare its own itinerary with the trace in order to realize the relevance check. The traces is as specified in [EN302637-3], Annex A.

1.5.7. DENM Destination Area

The destination area is used by the ITS networking & transport layer for the DENM transmission. According to ETSI EN 302 931 V1.1.1 (2011 July) (“[EN302931]”), three geometric shapes are defined, each shape being represented by the combination of one or several geographical point and distance information: circular shape; rectangular shape; and elliptical shape.

The DENBS 521 of the originating ITS-S provides the destination area information to the ITS N&T layer 503. The size and the shape of the relevance area are not necessarily identical to the destination area. The DENBS 521 provides the destination area in the format compliant to the one as specified in [EN302931] to the ITS N&T layer 503.

1.6. Dissemination of Safety Metrics in the DENM

The safety metrics are included in the DENM message by expanding the Situation container and á la carte container. The situation container carries the enentType and it is specified by the Cause Code. A snippet of the ASN.1 highlighted for the eventType and linkedCause is shown by Table 1.6-0.

TABLE 1.6-0

SituationContainer ::= SEQUENCE {
informationQuality InformationQuality,
eventType CauseCode,
linkedCause CauseCode OPTIONAL,
eventHistory EventHistory OPTIONAL,
...
}

The cause codes and sub cause codes (see e.g., Table 10 in [EN302637-3]) are extended to indicate the new safety metrics based warnings or violations, as shown by Table 1.6-1.

TABLE 1.6-1
cause codes and sub-cause codes

| | Direct | | |
|---|---|---|---|
| Causecode | cause | Sub | |
| description | code | Causecode | Sub-cause description |
| Collision | 97 | 0 | Unavailable |
| Risk | | 1 | Longitudinal collision risk |
| | | 2 | Crossing collision risk |
| | | 3 | lateral collision risk |
| | | 4 | Collision risk involving vulnerable |
| | | | road user |
| | | 5 | Minimum safe distance risk |
| | | 6 | Proper response action risk |
| | | 7 | Modified Time to collision or post |
| | | | encroachment time risk |
| Dangerous | 99 | 0 | Unavailable |
| Situation | | 1 | Emergency electronic brake lights |
| | | 2 | Pre-crash system activated |
| | | 3 | ESP(Electronic Stability Program) |
| | | | activated |
| | | 4 | ABS (Anti-lock braking system) |
| | | | activated |
| | | 5 | AEB (Automatic Emergency |
| | | | Braking) activated |
| | | 6 | Brake warning activated |
| | | 7 | Collision risk warning activated |
| | | 8 | Rules of the road violation |
| | | 9 | Driving behavior competency issues |

Additionally or alternatively, dissemination of the Pre-Crash á la carte container (discussed infra) may include: a Pre-Crash DENM with its á la carte Container should be triggered with a CauseCode “collisionRisk” (97) and SubCauseCode (5) for preCrashInformation that is not yet defined.

Additionally or alternatively, the following dissemination aspects may also be used for dissemination of the the Pre-Crash á la carte container: The conditions for the triggering of the DENM are: the computed time to collision with the identified object is smaller than n seconds (e.g., n=1.5 seconds) and the relative speed between the identified object and the host vehicle is smaller than −10 km/h; as the ITS Station closes in on the critical object, the DENM is updated every X milliseconds (e.g., X=100 ms) together with the data elements until the use case is terminated; a repetition of the DENM is not used; the DENM is not triggered again as long as the previous use case is not terminated; when a change of the critical object is detected the previous DENM is terminated and a new DENM with a new ActionID is triggered; when a DENM is terminated because the previous use case is not relevant anymore, a cancellation DENM is triggered; repetition is not used for cancellation DENMs; and/or negation DENMs are not used.

The á La Carte container carries details of the safety metrics violations as discussed previously. The ASN.1 implementation of the DENM is modified to include these metrics as shown by Table 1.6-2.

```
TABLE 1.6-2
DENM-PDU-Descriptions {itu-t (0) identified-organization (4) etsi (0)
itsDomain (5) wg1 (1) en
(302637) denm (1) version (1)
}
DEFINITIONS AUTOMATIC TAGS ::=
BEGIN
IMPORTS
ItsPduHeader, CauseCode, Speed, InformationQuality, ReferencePosition,
ClosedLanes,
DangerousGoodsExtended, Heading, LanePosition, LightBarSirenInUse, RoadType,
HeightLonCarr,
PosLonCarr, PosCentMass, PositioningSolutionType, RequestResponseIndication,
StationType,
SpeedLimit, StationarySince, TimestampIts, WheelBaseVehicle, TurningRadius,
PosFrontAx,
PositionOfOccupants, Temperature, VehicleMass, VehicleIdentification,
EnergyStorageType, ActionID,
ItineraryPath, NumberOfOccupants, PositionOfPillars,
RelevanceTrafficDirection, RestrictedTypes,
Traces, TransmissionInterval, ValidityDuration, RelevanceDistance,
EventHistory, TrafficRule,ActionDeltaTime,
DeltaReferencePosition FROM ITS-Container {
itu-t (0) identified-organization (4) etsi (0) itsDomain (5) wg1 (1) ts
(102894) cdd (2) version (1)
};
DENM ::= SEQUENCE {
header ItsPduHeader,
denm DecentralizedEnvironmentalNotificationMessage
}
DecentralizedEnvironmentalNotificationMessage ::= SEQUENCE {
management ManagementContainer,
situation SituationContainer OPTIONAL,
location LocationContainer OPTIONAL,
alacarte AlacarteContainer OPTIONAL
}
ManagementContainer ::= SEQUENCE {
actionID ActionID,
detectionTime TimestampIts,
referenceTime TimestampIts,
termination Termination OPTIONAL,
eventPosition ReferencePosition,
relevanceDistance RelevanceDistance OPTIONAL,
relevanceTrafficDirection RelevanceTrafficDirection OPTIONAL,
validityDuration ValidityDuration DEFAULT defaultValidity,
transmissionInterval TransmissionInterval OPTIONAL,
stationType StationType,
...
}
SituationContainer ::= SEQUENCE {
informationQuality InformationQuality,
eventType CauseCode,
linkedCause CauseCode OPTIONAL,
eventHistory EventHistory OPTIONAL,
...
}
LocationContainer ::= SEQUENCE {
eventSpeed Speed OPTIONAL,
eventPositionHeading Heading OPTIONAL,
traces Traces,
roadType RoadType OPTIONAL,
...
}
ImpactReductionContainer ::= SEQUENCE {
heightLonCarrLeft HeightLonCarr,
heightLonCarrRight HeightLonCarr,
posLonCarrLeft PosLonCarr,
posLonCarrRight PosLonCarr,
positionOfPillars PositionOfPillars,
posCentMass PosCentMass,
wheelBaseVehicle WheelBaseVehicle,
turningRadius TurningRadius,
posFrontAx PosFrontAx,
positionOfOccupants PositionOfOccupants,
vehicleMass VehicleMass,
requestResponseIndication RequestResponseIndication
}
RoadWorksContainerExtended ::= SEQUENCE {
lightBarSirenInUse LightBarSirenInUse OPTIONAL,
closedLanes ClosedLanes OPTIONAL,
restriction RestrictedTypes OPTIONAL,
speedLimit SpeedLimit OPTIONAL,
incidentIndication CauseCode OPTIONAL,
recommendedPath ItineraryPath OPTIONAL,
startingPointSpeedLimit DeltaReferencePosition OPTIONAL,
trafficFlowRule TrafficRule OPTIONAL,
referenceDenms ReferenceDenms OPTIONAL
}
StationaryVehicleContainer ::= SEQUENCE {
stationarySince StationarySince OPTIONAL,
stationaryCause CauseCode OPTIONAL,
carryingDangerousGoods DangerousGoodsExtended OPTIONAL,
numberOfOccupants NumberOfOccupants OPTIONAL,
vehicleIdentification VehicleIdentification OPTIONAL,
energyStorageType EnergyStorageType OPTIONAL
}
AlacarteContainer ::= SEQUENCE {
lanePosition LanePosition OPTIONAL,
impactReduction ImpactReductionContainer OPTIONAL,
externalTemperature Temperature OPTIONAL,
roadWorks RoadWorksContainerExtended OPTIONAL,
positioningSolution PositioningSolutionType OPTIONAL,
stationaryVehicle StationaryVehicleContainer OPTIONAL,
minimumsafeDistanceIndication MinimumSafeDistanceIndication OPTIONAL,
rulesOfTheRoadViolationIndication RulesOfTheRoadViolationIndication OPTIONAL,
...
}
defaultValidity INTEGER ::= 600
Termination ::= ENUMERATED {isCancellation(0), isNegation (1)}
ReferenceDenms ::= SEQUENCE (SIZE(1..8, ...)) OF ActionID
MinimumSafeDistanceIndication ::= SEQUENCE {
  subjectStation1 StationID OPTIONAL,
      subjectStation2 StationID OPTIONAL,
  stationSafeDistanceIndication StationSafeDistanceIndication, OPTIONAL,
      properResponseActionIndication ProperResponseActionIndication
OPTIONAL,
        minimumsafeDistanceFactorIndication
MinimumSafeDistanceFactorIndication OPTIONAL,
        modifiedTimeToCollisionIndication ActionDeltaTime OPTIONAL,
        postEncroachmentTimeIndication ActionDeltaTime OPTIONAL,
...
  }
    StationSafeDistanceIndication ::= BOOLEAN
    ProperResponseActionIndication ::= BOOLEAN
    MinimumSafeDistanceFactorIndication ::= INTEGER {
        unsafe (0),
        caution (1),
        safe (2),
    ...
        } (0..2)
RulesOfTheRoadViolationIndication ::= SEQUENCE {
    subjectStation1 StationID OPTIONAL,
    ViolationIndication violationIndication,
    drivingBehavioralCompetencyIndication
DrivingBehavioralCompetencyIndication OPTIONAL,
}
ViolationIndication ::= ENUMERATED {
  vehicleSuddenDecelerationOrStop (0),
  vehicleDriftingFromLane (1),
  vehicleImproperChangingLanes (2),
  vehicleControlLoss (3),
  vehicleBackingUpintoAnotherVehicle (4) ,
  max(15)
}
DrivingBehavioralCompetencyIndication ::= ENUMERATED {
    vehicleDrivingAboveSpeedLimit (0) ,
    vehicleDringVerySlow (1),
    vehicleDrivingRecklessly (2),
      max(7)
}
END
```

1.7. Den Messages (DENM)

1.7.1. DENM Structure and Formats

FIG. 2 illustrates the structure of an example DENM 200. The DENM 200 is a facilities layer message that is mainly used by ITS applications in order to alert road users of a detected event using ITS communication technologies. DENM is used to describe a variety of events that can be detected by ITS stations (ITS-S). A set of ITS applications are specified in [TS101539-1], [TS101539-2], and [TS101539-3], which includes multiple ITS use cases.

A DENM 200 comprises a common ITS PDU header and multiple containers, which together constitute a DENM payload (also referred to as “DENM 200”). Each container comprises a sequence of optional and/or mandatory data elements (DEs) and/or data frames (DFs). The DEs and DFs included in the CPM format are based on the ETSI Common Data Dictionary (CDD) (see e.g., ETSI TS 102 894-2 v1.3.1 (2018 August) (“[TS102894-2]”)) and/or makes use of certain elements defined in Intelligent transport systems Cooperative ITS Using V2I and I2V communications for applications related to signalized intersections, INTERNATIONAL ORGANIZATION FOR STANDARDIZATION (ISO) Technical Committee (TC) 204, Ed. 2 (2019 June) (“[CEN-ISO/TS19091]”). Some or all DEs and DFs are defined in Annex A of ETSI TS 103 324 v.0.0.22 (2021 May) and ETSI TS 103 324 v.0.0.44 (2022 November) (“[TS103324]”), ETSI TR 103 832 v0.0.3.4 (2022 May) (“[TR103832]”), and/or [EN302637-3], the contents of each of which are hereby incorporated by reference in their entireties.

In this example, the DENM payload includes four fixed order parts: the management container, the situation container, the location container and the á la carte container. For all types of DENMs 200, the ITS PDU header and the management container may always be present. In some implementations, one or more of the situation container, the location container and the á la carte container are optional containers. In other implementations, one or more of the situation container, the location container and the á la carte container are mandatory containers. For a cancellation DENM 200 or a negation DENM 200, the situation container, location container and á la carte container may or may not be present. If the situation container is present, the location container may also be present. In some implementations, the á la carte container is present only when applicable as specified in application specification standards, such as [TS101539-1], [TS101539-2], and [TS101539-3].

1.7.1.1. ITS PDU Header

DENMs 200 include an ITS PDU header. The ITS PDU header is a common header that includes the information of the protocol version, the message type, and the ITS-S identifier (ID) of the originating (Tx) ITS-S. The ITS PDU header is included as specified in [TS102894-2]. Detailed data presentation rules of the ITS PDU header in the context of a DENM 200 is as specified in Annex A of [EN302637-3].

1.7.1.2. DENM Management Container

The management container contains information related to the DENM management and the DENM protocol. The management container includes some or all of the following information:

actionID as defined in [EN302637-3] §§ 6.1.1 and B.7; detectionTime as defined in [EN302637-3] § B.11; referenceTime as defined in [EN302637-3] § B.37. termination as defined in [EN302637-3] §§ 6.1.2 and B.50 (in some implementations, this DE is is present for cancellation DENM and negation DENM); eventPosition: The event position is use case specific and provided by the ITS-S application to the DENBS 521, is as defined in [EN302637-3] § B.14; relevanceDistance as specified in [EN302637-3] §§ 6.1.3.1 and B.38 (if the ITS application of the originator ITS-S provides such information to the DENBS 521, the relevanceDistance is present); relevanceTrafficDirection as specified in [EN302637-3] §§ 6.1.3.1 and B.39 (if the ITS application of the originator ITS-S provides such information to the DENBS 521, the relevanceTrafficDirection is present); validityDuration as defined in [EN302637-3] § B.55 (in some implementations, this information is provided by the application layer, the validityDuration is present. The validityDuration value may be updated or extended by the ITS-S application of the Tx ITS-S. At the end of this validityDuration, the event is regarded as terminated, and all information related to the event may be deleted by the DENBS 521); transmissionInterval as defined in [EN302637-3] § B.53 (if the ITS application of the originator ITS-S provides such information to the DENBS 521, the transmissionInterval is present); stationType as specified in [EN302637-3] § B.49.

1.7.1.3. DENM Situation Container

The situation container contains information related to the type of the detected event and/or describes a detected event. As examples, an event may include a road hazard, driving environment, and/or traffic condition. The situation container includes at least the informationQuality DE and eventType DF, and may include linkedCause DF and eventHistory DF, as follows.

informationQuality is defined in clause B.23 of [EN302637-3]. The value ranges from lowest (1) to highest (7). The informationQuality value is provided by the application layer of the Tx ITS-S. The value 0 is set when the information is unavailable.

eventType: This DF provides a description of the event type being detected, and is defined in clause B.17 of [EN302637-3]. For each specific event type, a unique code can be used. The eventType includes two DEs, namely the causeCode and subCauseCode (see e.g., [ShalevSchwartz]).
causeCode: the direct cause code provides a high level description of the detected event type. The value of the causeCode is based on the TPEG TEC specification as defined in TISA specification TAWG11071 (2011 Nov. 7) (“[TAWG11071]”).
subCauseCode: This DE is used to provide more detailed information of the event related to the causeCode. The value of the sub cause code is based on the TPEG TEC specification as

defined in [TAWG11071]. The subCauseCode may be set to 0 if no specific information of the subCauseCode is available.

linkedCause: This DF indicates an event which may be linked with the eventType and is defined in clause B.26 of [EN302637-3]. An example use of this container may be when traffic events are the combination of more than one situation. This DF is present in the situation container, if the application provides such information to the DENBS 521.

In many cases, the traffic events are the combination of more than one situation, for example, accident due to the bad weather conditions, break down vehicle resulting the people on the road situation. Therefore, the linkedCause information is added.

eventHistory: This DF indicates the list of positions that a plain event (e.g., potential collision or violation) has been detected prior to the eventPosition. It is as defined in clause B.13 of [EN302637-3]. The eventHistory is an optional DF. This DF is present in the situation container, if the application provides such information to the DENBS 521.

Table 10 of [EN302637-3] lists the causeCode and subCauseCode values for all ITS use cases as defined in [TS101539-1], [TS101539-2], and [TS101539-3] that make use of the DENBS 521. ETSI TC ITS harmonizes causeCode and subCauseCode values with the [TAWG11071]. For the event types that have been assigned with the causeCode and subCauseCode values in [TAWG11071], the same values are used. For events types, for which the causeCode and subCauseCode values are not assigned in [TAWG11071], a value is assigned by ETSI TC ITS. In Table 10 of [EN302637-3], references to [TAWG11071] cause codes and related sub cause codes are indicated when applicable.

1.7.1.4. DENM Location Container

The location container contains information of the event location, and the location referencing. The location container describes the location of the detected event. The location container includes traces DF and may include eventSpeed, eventPositionHeading, and roadType DE and DFs, as follows: eventSpeed: is defined in [EN302637-3] § B.16 (this DF is may be present if the information is provided by the ITS-S application to the DENBS 521 of the Tx ITS-S); eventPositionHeading: is as defined in [EN302637-3] § B.15 (this DF may be present if the information is provided by the ITS application layer to the DENBS 521 of the originator ITS-S); traces: is as specified in [EN302637-3] §§ 6.1.3.2 and B.51; and/or roadType: is defined in [EN302637-3] § B.42 (this DE may be present if the information is provided by the ITS application layer to the DENBS 521 of the Tx ITS-S).

1.7.1.5. DENM Á La Carte Container

The á la carte container 202 contains information specific to the use case which requires the transmission of additional information that is not included in the previously described containers. The á la carte container 202 contains additional information that is not provided by other containers. This container 202 provides the possibility for ITS-S application to include application specific data in a DENM. In some implementations, some or all information included in the á la carte container 202 is optional. This container 202 may be present when the data is provided by an ITS-S application. The á la carte container 202 may be used for use cases as specified in [TS101539-1], [TS101539-2], and [TS101539-3], and/or includes some or all of the use case specific containers.

lanePosition: This information may be added to indicate the corresponding lane position of the event position. It is as defined in [EN302637-3] § B.24.

impactReduction: This container may be added when potential collision is detected. It includes vehicle data for the collision mitigation. It is as defined in [EN302637-3] § B.21.

external Temperature: This information may be added for the adverse weather condition use case as specified in [TS101539-1]. It indicates the ambient temperature at the event position. It is as defined in [EN302637-3] § B.18.

roadWorks: This container may be added for the roadwork use case as specified in [TS101539-1]. It includes information of the roadwork zone and specific access conditions. It is as defined in [EN302637-3] § B.43.

positioningSolution: This information may be added for the emergency vehicle approaching, slow vehicle and stationary vehicle use cases as specified in [TS101539-1]. It indicates the type of positioning solution being used for the resolution of the event position. It is as defined in [EN302637-3] § B.30.

stationary Vehicle: This container may be added for the stationary vehicle use case as specified in [TS101539-1]. It is as defined in [EN302637-3] § B.48.

Additionally or alternatively, the á la carte container 202 is or includes a pre-crash á la carte container (also referred to as “pre-crash á la carte container 202” or the like). The pre-crash specific á la carte container 202 in the DENM 200 shares dedicated information about a critical/pre-crash situation with other ITS-Ss in the immediate surrounding, in cases where a collision is likely. The Pre-Crash á la carte container 202 provides use case relevant data about the sender vehicle and the detected critical objects (e.g., relative speed and distance between the sending vehicle and the critical object). This enables a Rx ITS-S (e.g., V-ITS-S, VRU ITS-S, or the like) to assess the individual risk and take appropriate pre-crash measures

The benefits of a DENM Pre-Crash á la carte container 202 is the event based character of the DENM 200. The Pre-Crash Use Case is event based—giving very specific danger and object information, so the receiver is made aware of a potentially dangerous situation directly at the moment of message reception. A DENM with a Pre-Crash á la carte container 202 can even be prioritized for the safety use case. It is also possible to send information about emergency braking actions in the same message for further evaluations. Further, the use case can operate and utilize the DEN Service on the already used channel 180 (formerly control channel).

The Pre-Crash Use Case cannot solely rely on CAMs because CAM transmission rates might be lower and the priority is lower than for a DENM. Also the relative positioning on the receiver side just based on external GNSS-Positions received via CAMs might not be sufficient for Pre-Crash measures. A DENM á la carte container would include the relative distances between the Vehicle 1 and Vehicle 2, measured by a sensor from Vehicle 1. This is assumed to be far better than distance calculations based on relative GNSS positions.

Another closely related service is the Collective Perception Service (CPS). Although the purpose of the CPS is transmitting object information, it is rather intended for continuous transmission of the whole field of view, including many sensor information. The CPM is not intended to be used only in specific situations and to provide only information about one critical object. Further, the amount of data required for CPM exchange will likely require a dedicated communication channel and a Rx C-ITS station would have to support multi-channel operation. A future variant of the Pre-Crash use case may however consider a migration path to the CPM.

A complementary concept is the dissemination of a DENM with an Impact Reduction Container (IRC). With an IRC the Rx vehicle of the Pre-Crash use case would be able to communicate beneficial crash points where the vehicle crash integrity is optimal for the upcoming collision. So the whole use case would benefit from a dissemination of a DENM with an IRC parallel to the DENM with a Pre-Crash container 202 that is coming from the other car.

The Pre-Crash á la carte container 202 for the DENM offers ITS stations the possibility to share information about an critical object in the surrounding, which has been detected by sensors, cameras or other information sources mounted to the station, and with which a collision is imminent such as when the time to collision is very low and/or a complete mitigation of a collision is unlikely.

FIG. 2 also depicts the structure of the Pre-Crash DENM á la carte container 202. The container 202 includes the perceived pre-crash object (perceivedCrashObject). This data field is slimmed-down from the perceivedObject data field of the CPM. This data field includes the relative distances in x and y direction to the perceived pre-crash object alongside its relative speed in x and y, time of measurement, object id, yaw angle and one planar dimension. For the perceivedPreCrashObject it is assumed that the reference point of the measurement is always located in the middle of the side for which also the perceivedPreCrashObject::planarObjectDimensionl (e.g., width) is given. Container 202 in FIG. 2 also gives an overview of the distance and direction data elements and their relation to each other.

Table 1.7.5-1 provides information about each DE and/or DF that constitutes a Pre-Crash extension (e.g., Pre-Crash DENM á la carte container 202). References to data type declarations are provided as applicable.

TABLE 1.7.5-1
Pre-Crash á la carte Container

| | |
|---|---|
| perceivedPreCrashObject | A customized data field of a PerceivedObject of a CPM as |
| | described in [TR103562]. This data element contains all the relative |
| | information of the perceived object. |
| perceivedPreCrashObject::objectId | A constant identifier of the perceived object and is set according |
| | to [TR103562] |
| perceivedPreCrashObject::timeOfMeasurement | Relative time, describing the moment in time when the |
| | provided measurement data was generated by the on-board |
| | sensor. |
| | The relative value is provided in relation to the DE detectionTime. |
| perceivedPreCrashObject::xDistance | X-component (host vehicle reference frame) of the relative distance |
| | between the host vehicle reference point and the reference point of |
| | the measurement as measured by the on-board sensor. |
| | The measurement delay (measurement time to detection time) is |
| | less than 100 ms. |
| perceivedPreCrashObject::yDistance | Y-component (host vehicle reference frame) of the relative distance |
| | between the host vehicle reference point and reference point of the |
| | measurement as measured by the on-board sensor. |
| | The measurement delay (measurement time to detection time) is |
| | less than 100 ms |
| perceivedPreCrashObject::xSpeed | X-component (host vehicle reference frame) of the relative speed |
| | between the host vehicle and the object as measured by the on- |
| | board sensor. |
| | The measurement delay (measurement time to detection time) is |
| | less than 100 ms. |
| perceivedPreCrashObject::ySpeed | Y-component (host vehicle reference frame) of the relative speed |
| | between the host vehicle and the object as measured by the on- |
| | board sensor. |
| | The measurement delay (measurement time to detection time) is |
| | less than 100 ms. |
| perceivedPreCrashObject::yawAngle | The yaw angle represents the relative angle measured between the |
| | host vehicle orientation and the vector perpendicular to the |
| | perceived object side (planarObjectDimension1). |
| | This DE/DF is set according to [TR103562]. |
| | The measurement delay (measurement time to detection time) is |
| | less than 100 ms. |
| | This data element is optional. |
| perceivedPreCrashObject::planarObjectDimension1 | Perceived width of the side of the object on which the reference |
| | point of the measurement is located. |
| | The measurement delay (measurement time to detection time) is |
| | less than 100 ms. |
| | Note: This width might be shorter or longer than the real object |
| | width due to sensor vision limitations (e.g., obstructions). |
| perceivedPreCrashObject:classification | Provides the classification of the perceived object. Multi- |
| | dimensional classification may be provided along with confidences. |
| | is set according to [TR103562] |
| objectStationId | The stationID of the object for which the values are provided. is set |
| | according to [TS102894-2]. |
| | This data element is optional. |
| | Note: The stationID of the object may change during the use case, |
| | when the object changes its AT. |
| timeToCollision | The calculated (or measured) time to collision towards the object, |
| | determined by the host vehicle. |
| | This data element is optional. |
| hostVehicleOrientation | Absolute orientation of the host vehicle body in the world coordinate |
| | system and is set according to [TR103562]. |
| impactSection | Indication of the object's section where the impact will most likely |
| | occur. When the target object is likely to be a vehicle, than this data |
| | element should be made available, otherwise (every other type of |
| | object) the data element is not provided. |
| | Note: It is permissible to derive the required object dimensions and |
| | orientation from models to provide a best guess. |
| estimatedBrakingDistance | Estimated distance the host vehicle would need to come to a |
| | complete hold, if no obstruction was in the way. |
| | This data element is optional. |

Additionally or alternatively, various data elements and data frames that constitute a Pre-Crash á la carte container 202 are provided in the following tables. References to data type declarations are provided as applicable.

TABLE 1.7.5-2
perceivedPreCrashObject

| | |
|---|---|
| Description | This DF contains information about the perceived pre-crash object. |
| Data setting and | The DF should be of type perceivedObject as specified in [TS102894-2]. The following |
| presentation | Data Fields and Data Elements of the perceivedObject are mandatory (marked as |
| requirements | PRESENT or excluded (marked as ABSENT) for the Pre-Crash á la carte container. |
| | objectID ABSENT, |
| | zCoordinate ABSENT, |
| | velocityMagnitude ABSENT, |
| | velocityDirection ABSENT, |
| | zVelocity ABSENT, |
| | accelerationMagnitude ABSENT, |
| | accelerationDirection ABSENT, |
| | xAcceleration ABSENT, |
| | yAcceleration ABSENT, |
| | zAcceleration ABSENT, |
| | lowerTriangularCorrelationMatrixColumns ABSENT, |
| | planarObjectDimension1 PRESENT, |
| | planarObjectDimension2 ABSENT, |
| | verticalObjectDimension ABSENT, |
| | objectAge ABSENT, |
| | objectConfidence ABSENT, |
| | sensorIdList ABSENT, |
| | dynamicStatus ABSENT, |
| | classification ABSENT, |
| | mapPosition ABSENT |

TABLE 1.7.5-3
objectStationID

| | |
|---|---|
| Description | The object station id of the object for which the values are provided. |
| | Note: The object station id of the object may change during the use case, when the |
| | object changes its AT. |
| Data setting and | This DE should be of type stationID as specified in [TS102894-2]. |
| presentation | This data element should be optional. |
| requirements | |

TABLE 1.7.5-4
timeToCollision

| | |
|---|---|
| Description | The calculated (or estimated) time to collision of the vehicle towards the pre-crash |
| | object, determined by the host vehicle or a roadside ITS system. The computation of |
| | the time to collision should include the velocities, accelerations and relative distances |
| | between the vehicles. |
| Data setting and | This DE should be of type DeltaTimeMilliSecondPos as specified in [TS102894-2]. |
| presentation | This data element should be optional. |
| requirements | |

TABLE 1.7.5-5
localCoordinateSystemOrientation

| | |
|---|---|
| Description | Absolute orientation of the host vehicle body or of an arbitrary reference system in the |
| | world coordinate system. |
| Data setting and | This DF should be of type WGS84Angle as specified in ETSI TR 103 562 [i.6]. |
| presentation | |
| requirements | |

TABLE 1.7.5-6
impactSection

| | |
|---|---|
| Description | Indication of the object's section where the impact will most likely occur. When the |
| | target object is likely to be a vehicle, than this data element should be made available, |
| | otherwise (every other type of object) the data element should not be provided. |
| | Note: It is permissible to derive the required object dimensions and orientation from |
| | models to provide a best guess. |
| Data setting and | This DE should be of type ObjectFace as specified in [TS102894-2]. |
| presentation | |
| requirements | |

TABLE 1.7.5-7
estimatedBrakingDistance

| | |
|---|---|
| Description | Estimated distance the host vehicle would need to come to a complete hold, if no |
| | obstruction was in the way. |
| | This data element should be optional. |
| Data setting and | This DE should be of type StandardLength12b as specified in [TS102894-2]. |
| presentation | |
| requirements | |

1.7.2. Object Measurements and Reference Frame

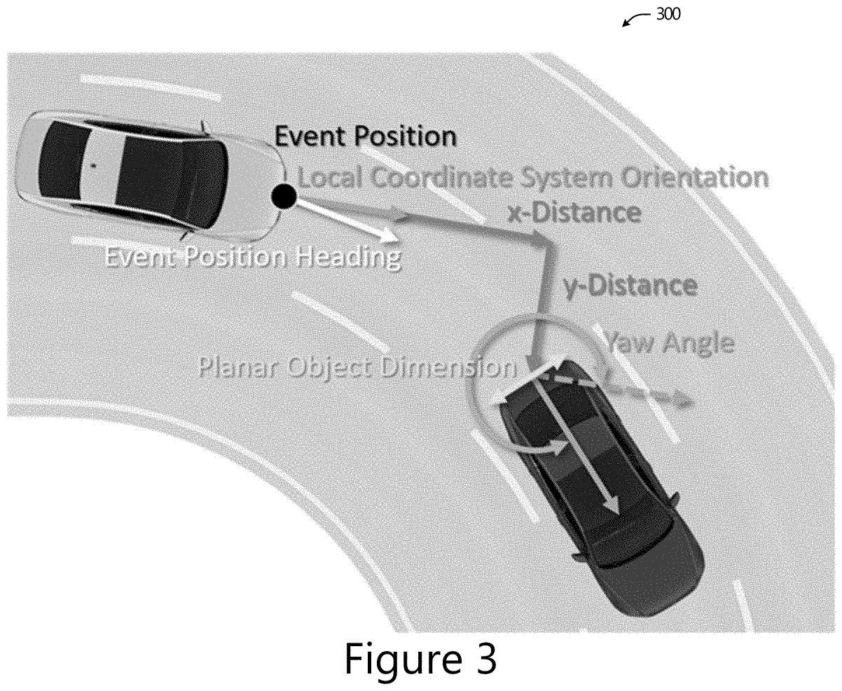

FIG. 3 illustrates an example representation 300 of a measurement point for a pre-crash ä la carte container and related quantities Independent of the use case characteristic (e.g., the DENM 200 being sent from a V-ITS-S or an R-ITS-S), the following reference frame and object measurements apply, as depicted in FIG. 3.

The event position of the DENM 200 marks the reference point of the measurements and values given in the Pre-Crash á la carte container 202. In case of a vehicle 410 disseminating the DENM 200, the event position should be the reference position of the vehicle 410 as defined in [EN302637-2] referencePosition. For example, the reference point is the ground position of the centre of the front side of the bounding box of the vehicle 410. In case of an R-ITS-S 430 disseminating the DENM 200, the event position should be the estimated reference position of the vehicle 410 that approaches the other vehicle 410. The event position heading in the DENM 200 should be set in conformance with [EN302637-2] heading, to the direction of movement of the vehicle 410, that approaches the other vehicle 410.

The orientation of the local coordinate system in which the distances are represented is defined by the data field localCoordinateSystemOrientation. In case of a vehicle 410 disseminating the DENM 200, the local coordinate system orientation should represent the vehicle 410 body orientation. In case of an R-ITS-S 430 disseminating the DENM 200, the local coordinate system orientation can be a arbitrarily chosen, in a favorable manner.

The x- and y-distance given in the perceivedPreCrashObject field of the Pre-Crash á la carte container 202 mark the distances of the event position to the middle of the closest edge of the perceivedPreCrashObject. The distances should be given in the local coordinate system, defined by the reference position and the local coordinate system orientation. The yaw angle given in the perceivedPreCrashObject field of the Pre-Crash á la carte container 202 mark the estimated orientation of the perceivedPreCrashObject in the local coordinate system. The planar object dimension given in the perceivedPreCrashObject field of the Pre-Crash á la carte container 202 mark the estimated width of the perceivedPreCrashObject, perpendicular to the orientation given with the yaw angle.

1.7.3. DENM Format and Decoding Rules

The DENM format makes use of the common data dictionary as defined in [TS102894-2]. Where applicable, DEs and DFs that are not defined in the present document is imported from the common data dictionary as specified in [TS102894-2]. Detailed descriptions of some or all DEs and DFs in the context of DENM 200 are presented in the normative Annex B of [EN302637-3].

The DENM format is presented in ASN.1. Unaligned packed encoding rules (PER) as defined in Recommendation ITU-T X.691/ISO/IEC 8825-2 are used for DENM encoding and decoding. The ASN.1 representation of DENM are specified in Annex A of [EN302637-3] and shown herein.

### 2. Intelligent Transport System (ITS) Configurations and Arrangements

FIG. 4 illustrates an overview of an vehicular network environment 400, which includes vehicles 410a, 410b, and 410c (collectively referred to as “vehicle 410” or “vehicles 410”), vulnerable road user (VRU) 416, a network access node (NAN) 430, edge compute node 440, and a service provider platform (SPP) 490 (also referred to as “cloud computing service 490”, “cloud 490”, “servers 490”, or the like). Vehicles 410a and 410b are illustrated as motorized vehicles, each of which are equipped with an engine, transmission, axles, wheels, as well as control systems used for driving, parking, passenger comfort and/or safety, and/or the like. The terms “motor”, “motorized”, and/or the like as used herein refer to devices that convert one form of energy into mechanical energy, and include internal combustion engines (ICE), compression combustion engines (CCE), electric motors, and hybrids (e.g., including an ICE/CCE and electric motor(s)), which may utilize any suitable form of fuel. Vehicle 410c is illustrated as a remote controlled or autonomous flying quadcopter, which can include various components such as, for example, a fuselage or frame, one or more rotors (e.g., either fixed-pitch rotors, variable-pitch rotors, coaxial rotors, and/or the like), one or more motors, a power source (e.g., batteries, hydrogen fuel cells, solar cells, hybrid gas-electric generators, and the like), one or more sensors, and/or other like components (not shown), as well as control systems for operating the vehicle 410c (e.g., flight controller (FC), flight controller board (FCB), UAV systems controllers, and the like), controlling the on-board sensors, and/or for other purposes. The vehicles 410a, a10b may represent motor vehicles of varying makes, models, trim, and/or the like, and/or any other type of vehicles, and vehicle 410c may represent any type of flying drone and/or unmanned aerial vehicle (UAV). Additionally, the vehicles 410 may correspond to the vehicle computing system 700 of FIG. 7.

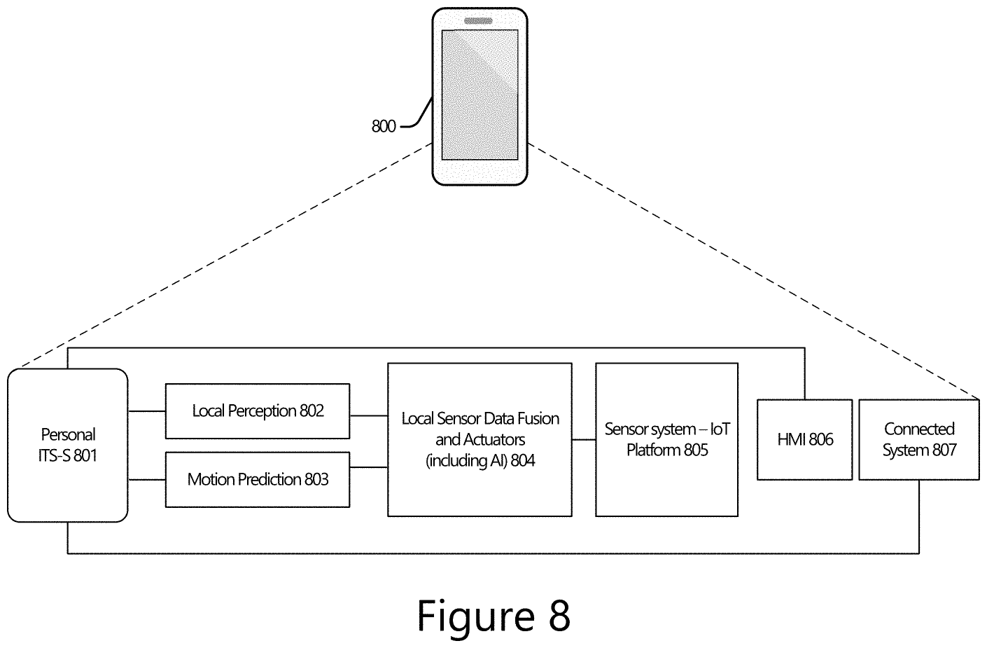

Environment 400 also includes VRU 416, which includes a VRU device 410v (also referred to as “VRU equipment 410v”, “VRU system 410v”, or simply “VRU 410v”). The VRU 416 is a non-motorized road user, such as a pedestrian, light vehicle carrying persons (e.g., wheelchair users, skateboards, e-scooters, Segways, and/or the like), motorcyclist (e.g., motorbikes, powered two wheelers, mopeds, and/or the like), and/or animals posing safety risk to other road users (e.g., pets, livestock, wild animals, and/or the like). The VRU 410v includes an ITS-S that is the same or similar as the ITS-S 413 discussed previously, and/or related hardware components, other in-station services, and sensor sub-systems. The VRU 410v could be a pedestrian-type VRU device 410v (e.g., a personal computing system 800 of FIG. 8, such as a smartphone, tablet, wearable device, and the like), a vehicle-type VRU device 410v (e.g., a device embedded in or coupled with a bicycle, motorcycle, or the like, or a pedestrian-type VRU device 410v in or on a bicycle, motorcycle, or the like), or an IoT device (e.g., traffic control devices) used by a VRU 410v integrating ITS-S technology. Various details regarding VRUs and VAMs are discussed in ETSI TR 103 300-1 V2.3.1 (2022 November) (“[TR103300-1]”), ETSI TS 103 300-2 v2.2.1 (2021 April) (“[TS103300-2]”), and ETSI TS 103 300-3 v2.1.2 (2021 March) (“[TS103300-3]”). For purposes of the present disclosure, the term “VRU 410v” may to refer to both the VRU 416 and its VRU device 410v unless the context dictates otherwise. The various vehicles 410 referenced throughout the present disclosure, may be referred to as vehicle UEs (vUEs) 410, vehicle stations 410, vehicle ITS stations (V-ITS-S) 410, computer-assisted or autonomous driving (CA/AD) vehicles 410, drones 410, robots 410, and/or the like. Additionally, the term “user equipment 410”, “UE 410”, “ITS-S 410”, “station 410”, or “user 410” (either in singular or plural form) may to collectively refer to the vehicle 410a, vehicle 410b, vehicle 410c, and VRU 410v, unless the context dictates otherwise.

For illustrative purposes, the following description is provided for deployment scenarios including vehicles 410 in a 2D freeway/highway/roadway environment wherein the vehicles 410 are automobiles. However, other types of vehicles are also applicable, such as trucks, busses, motorboats, motorcycles, electric personal transporters, and/or any other motorized devices capable of transporting people or goods. In another example, the vehicles 410 may be robots operating in an industrial environment or the like. 3D deployment scenarios are also applicable where some or all of the vehicles 410 are implemented as flying objects, such as aircraft, drones, UAVs, and/or to any other like motorized devices. Additionally, for illustrative purposes, the following description is provided where each vehicle 410 includes in-vehicle systems (IVS) 411. However, it should be noted that the UEs 410 could include additional or alternative types of computing devices/systems, such as, for example, smartphones, tablets, wearables, PDAs, pagers, wireless handsets, smart appliances, single-board computers (SBCs) (e.g., Raspberry Pi®, Arduino®, Intel® Edison®, and/or the like), plug computers, laptops, desktop computers, workstations, robots, drones, in-vehicle infotainment system, in-car entertainment system, instrument cluster, head-up display (HUD) device, onboard diagnostic device, on-board unit, dashtop mobile equipment, mobile data terminal, electronic engine management system, electronic/engine control unit, electronic/engine control module, embedded system, microcontroller, control module, and/or any other suitable device or system that may be operable to perform the functionality discussed herein, including any of the computing devices discussed herein.

Each vehicle 410 includes an in-vehicle system (IVS) 411, one or more sensors 412, ITS-S 413, and one or more driving control units (DCUs) 414 (also referred to as “electronic control units 414”, “engine control units 414”, or “ECUs 414”). For the sake of clarity, not all vehicles 410 are labeled as including these elements in FIG. 4. Additionally, the VRU 410v may include the same or similar components and/or subsystems as discussed herein w.r.t any of the vehicles 410, such as the sensors 412 and ITS-S 413. The IVS 400 includes a number of vehicle computing hardware subsystems and/or applications including, for example, instrument cluster subsystems, a head-up display (HUD) subsystem, infotainment/media subsystems, a vehicle status subsystem, a navigation subsystem (NAV), artificial intelligence and/or machine learning (AI/ML) subsystems, and/or other subsystems. The NAV provides navigation guidance or control, depending on whether vehicle 410 is a computer-assisted vehicle, or an autonomous driving vehicle. The NAV may include or access computer vision functionality of the and/or the AI/ML subsystem to recognize stationary or moving objects based on sensor data collected by sensors 412, and may be capable of controlling DCUs 414 based on the recognized objects.

The UEs 410 also include an ITS-S 413 that employs one or more Radio Access Technologies (RATs) to allows the UEs 410 to communicate directly with one another and/or with infrastructure equipment (e.g., network access node (NAN) 430). In some examples, the ITS-S 413 corresponds to the ITS-S 500 of FIG. 5. The one or more RATs may refer to cellular V2X (C-V2X) RATs (e.g., V2X technologies based on 3GPP LTE, 5G/NR, and beyond), a WLAN V2X (W-V2X) RAT (e.g., V2X technologies based on DSRC in the USA and/or ITS-G5 in the EU), and/or some other RAT, such as any of those discussed herein.

For example, the ITS-S 413 utilizes respective connections (also referred to as “channels” or “links”) 420a, 420b, 420c, 420v to communicate data (e.g., transmit and receive) data with the NAN 430. The connections 420a, 420b, 420c, 420v are illustrated as an air interface to enable communicative coupling consistent with one or more communications protocols, such as any of those discussed herein. The ITS-Ss 413 can directly exchange data with one another via respective direct links 423ab, 423bc, 423vc, each of which may be based on 3GPP or C-V2X RATs (e.g., LTE/NR Proximity Services (ProSe) link, PC5 links, sidelink channels, and the like), IEEE or W-V2X RATs (e.g., WiFi-direct, [IEEE80211p], IEEE 802.11bd, [IEEE802154], ITS-G5, DSRC, WAVE, and/or the like), or some other RAT (e.g., Bluetooth®, and/or the like). The ITS-Ss 413 exchange ITS protocol data units (PDUs) (e.g., CAMs, CPMs, DENMs 200, misbehavior reports, and/or the like) and/or other messages with one another over respective links 423 and/or with the NAN 430 over respective links 420.

The ITS-S 413 are also capable of collecting or otherwise obtaining radio information, and providing the radio information to the NAN 430, the edge compute node 440, and/or the cloud system 490. The radio information may be in the form of one or more measurement reports, and/or may include, for example, signal strength measurements, signal quality measurements, and/or the like. Each measurement report is tagged with a timestamp and the location of the measurement (e.g., the current location of the ITS-S 413 or UE 410). The radio information may be used for various purposes including, for example, cell selection, handover, network attachment, testing, and/or other purposes. As examples, the measurements collected by the UEs 410 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (a/N0), energy per chip to interference power density ratio (Ec/I0), energy per chip to noise power density ratio (Ec/N0), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v16.2.0 (2021 Mar. 31) (“[TS36214]”), 3GPP TS 38.215 v16.4.0 (2021 Jan. 8) (“[TS38215]”), 3GPP TS 38.314 v16.4.0 (2021 Sep. 30) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the aforementioned measurements (or combination of measurements) may be collected by the NAN 430 and provided to the edge compute node(s) 440 and/or cloud compute node(s) 490. The measurements/metrics can also be those defined by other suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., [MEC]), IEEE/WiFi (e.g., [IEEE80211], [WiMAX], [IEEE16090], and/or the like), and/or any other like standards such as those discussed elsewhere herein. Some or all of the UEs 410 can include positioning circuitry (e.g., positioning circuitry 1043 of FIG. 10) to (coarsely) determine their respective geolocations and communicate their current position with one another and/or with the NAN 430 in a secure and reliable manner. This allows the UEs 410 to synchronize with one another and/or with the NAN 430.

The DCUs 414 include hardware elements that control various (sub)systems of the vehicles 410, such as the operation of the engine(s)/motor(s), transmission, steering, braking, rotors, propellers, servos, and/or the like. DCUs 414 are embedded systems or other like computer devices that control a corresponding system of a vehicle 410. The DCUs 414 may each have the same or similar components as compute node 1000 of FIG. 10 discussed infra, or may be some other suitable microcontroller or other like processor device, memory device(s), communications interfaces, and the like. Additionally or alternatively, one or more DCUs 414 may be the same or similar as the actuators 1044 of FIG. 10. Furthermore, individual DCUs 414 are capable of communicating with one or more sensors 412 and one or more actuators 1044 within the UE 410.

The sensors 412 are hardware elements configurable or operable to detect an environment surrounding the vehicles 410 and/or changes in the environment. The sensors 412 are configurable or operable to provide various sensor data to the DCUs 414 and/or one or more AI agents to enable the DCUs 414 and/or one or more AI agents to control respective control systems of the vehicles 410. In particular, the IVS 411 may include or implement a facilities layer and operate one or more facilities within the facilities layer. The sensors 412 include(s) devices, modules, and/or subsystems whose purpose is to detect events or changes in its environment and send the information (sensor data) about the detected events to some other a device, module, subsystem, and/or the like. Some or all of the sensors 412 may be the same or similar as the sensor circuitry 1042 of FIG. 10.

The NAN 430 is a network element that is part of an access network that provides network connectivity to the UEs 410 via respective interfaces/links 420. In V2X scenarios, the NAN 430 may be or act as an road side unit (RSU) or roadside (R-ITS-S), which refers to any transportation infrastructure entity used for V2X communications. In these scenarios, the NAN 430 includes an ITS-S that is the same or similar as ITS-S 413 and/or may be the same or similar as the roadside infrastructure system 900 of FIG. 9.

The access network may be Radio Access Networks (RANs) such as an NG-RAN or a 5G RAN for a RAN that operates in a 5G/NR cellular network, an E-UTRAN for a RAN that operates in an LTE or 4G cellular network, a legacy RAN such as a UTRAN or GERAN for GSM or CDMA cellular networks, an Access Service Network for WiMAX implementations, and/or the like. All or parts of the RAN may be implemented as one or more RAN functions (RANFs) or other software entities running on server(s) as part of a virtual network, which may be referred to as a cloud RAN (CRAN), Cognitive Radio (CR), a virtual RAN (vRAN), RAN intelligent controller (MC), and/or the like. The RAN may implement a split architecture wherein one or more communication protocol layers are operated by the RANF or controller and other communication protocol entities are operated by individual NANs 430. In either implementation, the NAN 430 can include ground stations (e.g., terrestrial access points) and/or satellite stations to provide network connectivity or coverage within a geographic area (e.g., a cell). The NAN 430 may be implemented as one or more dedicated physical devices such as a macrocell base stations and/or a low power base station for providing femtocells, picocells, or other like cells having smaller coverage areas, smaller user capacity, or higher bandwidth compared to macrocells.

As alluded to previously, the RATs employed by the NAN 430 and the UEs 410 may include any number of V2X RATs may be used for V2X communication, which allow the UEs 410 to communicate directly with one another, and/or communicate with infrastructure equipment (e.g., NAN 430). As examples, the V2X RATs can include a WLAN V2X (W-V2X) RAT based on IEEE V2X technologies and a cellular V2X (C-V2X) RAT based on 3GPP technologies.

The C-V2X RAT may be based on any suitable 3GPP standard including any of those mentioned herein. The W-V2X RATs include, for example, IEEE Guide for Wireless Access in Vehicular Environments (WAVE) Architecture, IEEE Std 1609.0-2019, pp. 1-106 (10 Apr. 2019) (“[IEEE16090]”), V2X Communications Message Set Dictionary, SAE Std J2735_202211 (14 Nov. 2022) (“[J2735]”), Intelligent Transport Systems in the 5 GHz frequency band (ITS-G5), the [IEEE80211p] (which is the layer 1 (L1) and layer 2 (L2) part of WAVE, DSRC, and ITS-G5), and sometimes IEEE Standard for Air Interface for Broadband Wireless Access Systems, IEEE Std 802.16-2017, pp. 1-2726 (2 Mar. 2018) (sometimes referred to as “Worldwide Interoperability for Microwave Access” or “WiMAX”) (“[WiMAX]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE80211p]-based RATs) that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302 663 V1.3.1 (2020 January) (“[EN302663]”) and describes the access layer of the ITS-S reference architecture 500. The ITS-G5 access layer comprises [IEEE80211] (which now incorporates [IEEE80211p]) and/or IEEE/ISO/IEC 8802-2-1998 protocols, as well as features for Decentralized Congestion Control (DCC) methods discussed in ETSI TS 102 687 V1.2.1 (2018 April) (“[TS102687]”). The access layer for 3GPP C-V2X based interface(s) is outlined in, inter alia, ETSI EN 303 613 V1.1.1 (2020-01), 3GPP TS 23.285 v17.0.0 (2022 Mar. 29) (“[TS23285]”); and 3GPP 5G/NR-V2X is outlined in, inter alia, 3GPP TR 23.786 v16.1.0 (2019 June) and 3GPP TS 23.287 v17.2.0 (2021-12-23) (“[TS23287]”).

The NAN 430 or an edge compute node 440 may provide one or more services/capabilities 480. In an example implementation, RSU 430 is a computing device coupled with radio frequency circuitry located on a roadside that provides connectivity support to passing UEs 410. The RSU 430 may also include internal data storage circuitry to store intersection map geometry, traffic statistics, media, as well as apps/software to sense and control ongoing vehicular and pedestrian traffic. The RSU 430 provides various services/capabilities 480 such as, for example, very low latency communications required for high speed events, such as crash avoidance, traffic warnings, and the like. Additionally or alternatively, the RSU 430 may provide other services/capabilities 480 such as, for example, cellular/WLAN communications services. In some implementations, the components of the RSU 430 may be packaged in a weatherproof enclosure suitable for outdoor installation, and may include a network interface controller to provide a wired connection (e.g., Ethernet or the like) to a traffic signal controller and/or a backhaul network. Further, RSU 430 may include wired or wireless interfaces to communicate with other RSUs 430 (not shown by FIG. 4).

The network 465 may represent a network such as the Internet, a wireless local area network (WLAN), or a wireless wide area network (WWAN) including proprietary and/or enterprise networks for a company or organization, a cellular core network, a backbone network, an edge computing network, a cloud computing service, a data network, an enterprise network, and/or combinations thereof. As examples, the network 465 and/or access technologies may include cellular technology (e.g., 3GPP LTE, NR/5G, MuLTEfire, WiMAX, and so forth), WLAN (e.g., WiFi and the like), and/or any other suitable technology such as those discussed herein.

The service provider platform 490 may represent one or more app servers, a cloud computing service that provides cloud computing services, and/or some other remote infrastructure. The service provider platform 490 may include any one of a number of services and capabilities 480 such as, for example, ITS-related apps and services, driving assistance (e.g., mapping/navigation), content (e.g., multi-media infotainment) streaming services, social media services, and/or any other services.

An edge compute node 440 (or a collection of edge compute nodes 440 as part of an edge network or “edge cloud”) is colocated with the NAN 430. The edge compute node 440 may provide any number of services/capabilities 480 to UEs 410, which may be the same or different than the services/capabilities 480 provided by the service provider platform 490. For example, the services/capabilities 480 provided by edge compute node 440 can include a distributed computing environment for hosting applications and services, and/or providing storage and processing resources so that data and/or content can be processed in close proximity to subscribers (e.g., UEs 410). The edge compute node 440 also supports multitenancy run-time and hosting environment(s) for applications, including virtual appliance apps that may be delivered as packaged virtual machine (VM) images, middleware and infrastructure services, cloud-computing capabilities, IT services, content delivery services including content caching, mobile big data analytics, and computational offloading, among others. Computational offloading involves offloading computational tasks, workloads, apps, and/or services to the edge compute node 440 from the UEs 410, core network, cloud service, and/or server(s) 490, or vice versa. For example, a device app or client app operating in a ITS-S 410 may offload app tasks or workloads to one or more edge servers 440. In another example, an edge server 440 may offload app tasks or workloads to one or more UEs 410 (e.g., for distributed ML computation or the like).

The edge compute node 440 includes or is part of an edge computing network (or edge cloud) that employs one or more edge computing technologies (ECTs). In one example implementation, the ECT is and/or operates according to the MEC framework, as discussed in ETSI GR MEC 001 v3.1.1 (2022 January), ETSI GS MEC 003 v3.1.1 (2022 March), ETSI GS MEC 009 v3.1.1 (2021 June), ETSI GS MEC 010-1 v1.1.1 (2017 October), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 V2.2.1 (2022 January), ETSI GS MEC 014 v2.1.1 (2021 March), ETSI GS MEC 015 v2.1.1 (2020 June), ETSI GS MEC 016 v2.2.1 (2020 April), ETSI GS MEC 021 v2.2.1 (2022 February), ETSI GR MEC 024 v2.1.1 (2019 November), ETSI GS MEC 028 V2.2.1 (2021 July), ETSI GS MEC 029 v2.2.1 (2022 January), ETSI MEC GS 030 v2.1.1 (2020 April), and ETSI GR MEC 031 v2.1.1 (2020 October) (collectively referred to herein as “[MEC]”), the contents of each of which are hereby incorporated by reference in their entireties.

In another example implementation, the ECT is and/or operates according to the Open RAN alliance (“O-RAN”) framework, as described in O-RAN Architecture Description v07.00, O-RAN ALLIANCE WG1 (October 2022); O-RAN Working Group 2 AI/ML workflow description and requirements v01.03 O-RAN ALLIANCE WG2 (October 2021); O-RAN Working Group 2 Non-RT RIC: Functional Architecture v01.01, O-RAN ALLIANCE WG2 (June 2021); O-RAN Working Group 3 Near-Real-time RAN Intelligent Controller Architecture & E2 General Aspects and Principles v02.02 (July 2022); O-RAN Working Group 3 Near-Real-time Intelligent Controller E2 Service Model (E2SM) v02.01 (March 2022); and/or any other 0-RAN standard/specification (collectively referred to as “[O-RAN]”) the contents of each of which are hereby incorporated by reference in their entireties.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v1.2.0 (2020 Dec. 7) (“[TS23558]”), 3GPP TS 23.501 v17.6.0 (2022 Sep. 22) (“[TS23501]”), 3GPP TS 23.548 v17.4.0 (2022 Sep. 22) (“[TS23548]”), and U.S. application Ser. No. 17/484,719 filed on 24 Sep. 2021 (“[′719]”) (collectively referred to as “[SA6Edge]”), the contents of each of which are hereby incorporated by reference in their entireties.

In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety.

In another example implementation, the ECT operates according to the Multi-Access Management Services (MAMS) framework as discussed in Kanugovi et al., Multi Access Management Services (MAMS), INTERNET ENGINEERING TASK FORCE (IETF), Request for Comments (RFC) 8743 (March 2020), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi Access (GMA) Convergence Encapsulation Protocols, IETF RFC 9188 (February 2022) (collectively referred to as “[MAMS]”), the contents of each of which are hereby incorporated by reference in their entireties.

Any of the aforementioned example implementations, and/or in any other example implementation discussed herein, may also include one or more virtualization technologies, such as those discussed in ETSI GR NFV 001 V1.3.1 (2021 March); ETSI GS NFV 002 V1.2.1 (2014 December); ETSI GR NFV 003 V1.6.1 (2021 March); ETSI GS NFV 006 V2.1.1 (2021 January); ETSI GS NFV-INF 001 V1.1.1 (2015 January); ETSI GS NFV-INF 003 V1.1.1 (2014 December); ETSI GS NFV-INF 004 V1.1.1 (2015 January); ETSI GS NFV-MAN 001 v1.1.1 (2014 December); Israel et al., OSM Release FIVE Technical Overview, ETSI OPEN SOURCE MANO, OSM White Paper, 1st ed. (January 2019); E2E Network Slicing Architecture, GSMA, Official Doc. NG.127, v1.0 (3 Jun. 2021); Open Network Automation Platform (ONAP) documentation, Release Istanbul, v9.0.1 (17 Feb. 2022); 3GPP Service Based Management Architecture (SBMA) as discussed in 3GPP TS 28.533 v17.1.0 (2021 December 23) (“[TS28533]”); the contents of each of which are hereby incorporated by reference in their entireties.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge networks/ECTs described herein. Further, the techniques disclosed herein may relate to other IoT ECTs, edge networks, and/or and configurations, and other intermediate processing entities and architectures may also be applicable to the present disclosure. For example, many ECTs and/or edge networking technologies may be applicable to the present disclosure in various combinations and layouts of devices located at the edge of a network. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

### 3. ITS Aspects

3.1. ITS Architecture Aspects

FIG. 5 shows an ITS-S reference architecture 500. Some or all of the components depicted by FIG. 5 follows the ITSC protocol, which is based on the principles of the OSI model for layered communication protocols extended for ITS apps. The ITS-S 500 includes an access layer 504 that corresponds with the OSI layers 1 and 2, a networking & transport (N&T) layer 503 that corresponds with OSI layers 3 and 4, the facilities layer which corresponds with OSI layers 5, 6, and at least some functionality of OSI layer 7, and an apps layer 501 that corresponds with some or all of OSI layer 7. Each of these layers are interconnected via respective observable interfaces, service access points (SAPs), APIs, and/or other like connectors or interfaces (see e.g., ETSI EN 302 665 v1.1.1 (2010 September) and ETSI TS 103 898 (“[TS103898]”)). The interconnections in this example include the MF-SAP, FA-SAP, NF-SAP, and SF-SAP.

The applications layer 501 provides ITS services, and ITS apps are defined within the app layer 501. An ITS app is an app layer entity that implements logic for fulfilling one or more ITS use cases. An ITS app makes use of the underlying facilities and communication capacities provided by the ITS-S. Each app can be assigned to one of the three identified app classes: (active) road safety, (cooperative) traffic efficiency, cooperative local services, global internet services, and other apps (see e.g., [EN302663]), ETSI TR 102 638 V1.1.1 (2009 June) (“[TR102638]”); and ETSI TS 102 940 v1.3.1 (2018 April), ETSI TS 102 940 v2.1.1 (2021 July) (collectively “[TS102940]”)). Examples of ITS apps may include driving assistance for cooperative awareness (CA), driving assistance for road hazard warnings (RHW), Automatic Emergency Braking (AEB), Forward Collision Warning (FCW), cooperative adaptive cruise control (CACC), control loss warning (CLW), queue warning, Automated Parking System (APS), pre-crash sensing warning, cooperative Speed Management (CSM) (e.g., curve speed warning and the like), mapping and/or navigation apps (e.g., turn-by-turn navigation and cooperative navigation), cooperative navigation (e.g., platooning and the like), location based services (LBS), community services, ITS-S lifecycle management services, transport related electronic financial transactions, and the like. A V-ITS-S 410 provides ITS apps to vehicle drivers and/or passengers, and may require an interface for accessing in-vehicle data from the in-vehicle network or in-vehicle system. For deployment and performances needs, specific instances of a V-ITS-S 410 may contain groupings of Apps and/or Facilities.

The facilities layer 502 comprises middleware, software connectors, software glue, or the like, comprising multiple facility layer functions (or simply a “facilities”). In particular, the facilities layer contains functionality from the OSI app layer, the OSI presentation layer (e.g., ASN.1 encoding and decoding, and encryption) and the OSI session layer (e.g., inter-host communication). A facility is a component that provides functions, information, and/or services to the apps in the app layer and exchanges data with lower layers for communicating that data with other ITS-Ss. C-ITS facility services can be used by ITS Apps. Examples of these facility services include: Cooperative Awareness (CA) provided by cooperative awareness basic service (CABS) facility (see e.g., ETSI EN 302 637-2 v1.4.1 (2019 April) (“[EN302637-2]”)) to create and maintain awareness of ITS-Ss and to support cooperative performance of vehicles using the road network; Decentralized Environmental Notification (DEN) provided by the DEN basic service (DENBS) 521 facility to alert road users of a detected event using ITS communication technologies; Cooperative Perception (CP) provided by a CP services (CPS) facility (see e.g., [TS103324]) complementing the CA service to specify how an ITS-S can inform other ITS-Ss about the position, dynamics and attributes of detected neighboring road users and other objects; Multimedia Content Dissemination (MCD) to control the dissemination of information using ITS communication technologies; VRU awareness provided by a VRU basic service (VBS) facility to create and maintain awareness of vulnerable road users participating in the VRU system; Interference Management Zone to support the dynamic band sharing in co-channel and adjacent channel scenarios between ITS stations and other services and apps; Diagnosis, Logging and Status for maintenance and information purposes; Positioning and Time management (PoTi) provided by a PoTi facility 522 that provides time and position information to ITS apps and services; Decentralized Congestion Control (DCC) facility (DCC-Fac) 525 contributing to the overall ITS-S congestion control functionalities using various methods at the facilities and apps layer for reducing at the number of generated messages based on the congestion level; Device Data Provider (DDP) 524 for a V-ITS-S 410 connected with the in-vehicle network and provides the vehicle state information; Local Dynamic Map (LDM) 523, which is a local georeferenced database (see e.g., ETSI EN 302 895 v1.1.1 (2014 September) (“[TS302895]”) and ETSI TR 102 863 v1.1.1 (2011 June) (“[TR102863]”)); Service Announcement (SA) facility 527; Signal Phase and Timing Service (SPATS); a Maneuver Coordination Services (MC S) entity; and/or a Multi-Channel Operations (MCO) facility (MCO-Fac) 528. A list of the common facilities is given by ETSI TS 102 894-1 v1.1.1 (2013 August) (“[TS102984-1]”), which is hereby incorporated by reference in its entirety. The DENBS 521 may exchange information with additional facilities layer entities not shown by FIG. 5 for the purpose of generation, transmission, forwarding, and reception of DENMs 200.

FIG. 5 shows the DEN-specific functionality, including interfaces mapped to the ITS-S architecture. The DEN-specific functionality is centered around the DENBS 521 located in the facilities layer 502. The DENBS 521 is a facility at the ITS-S facilities layer 502 configurable or operable to generate, receive, and process DENMs 200.

The DENBS 521 is a facilities layer entity that implements the DENM protocol. It interfaces with ITS-S applications in order to receive the application request for DENM 200 transmission (Tx) and to provide the received DENM content to the ITS-S applications. Furthermore, the DENBS 521 may interact with other facilities layer 502 entities, in particular the Local Dynamic Map (LDM) 523 as defined in ETSI EN 302 895 v1.1.1 (2014 September), which is a facilities layer database (see e.g., ETSI TR 102 863 v1.1.1 (2011 June)). ITS apps may retrieve information from the LDM 523 for further processing. At the Rx ITS-S, the LDM 523 may be updated with a received DENM 200 and ITS-S applications may retrieve event related information from the LDM 523 database for further processing. Although not shown, the DENBS 521 could interface with other facility layer functions (or simply a “facilities”), such and of those mentioned previously.

The DENBS 521 interfaces through the Network—Transport/Facilities (NF)-Service Access Point (SAP) with the N&T layer 503 for exchanging of DENMs 200 with other ITS-Ss. The DENBS 521 interfaces through the Security—Facilities (SF)-SAP with the Security entity 506 to access security services for Tx/Rx of DENMs 200. The DENBS 521 interfaces through the Management-Facilities (MF)-SAP with the Management entity 505 and through the Facilities—Application (FA)-SAP with the application layer if received DENMs' 200 data is provided directly to the applications. Each of the aforementioned interfaces/SAPs may provide the full duplex exchange of data with the facilities layer, and may implement suitable APIs to enable communication between the various entities/elements. Each of the aforementioned interfaces/Service Access Points (SAPs) may provide the full duplex exchange of data with the facilities layer, and may implement suitable APIs to enable communication between the various entities/elements.

DENMs 200 are facilities layer messages that are mainly used by ITS apps in order to alert road users of a detected event using ITS communication technologies. A DENM 200 is used to describe a variety of events that can be detected by an ITS-S. A set of ITS apps are specified in ETSI TS 101 539-1 v1.1.1 (2013 August) (“[TS101539-1]”), ETSI TS 101 539-2 v1.1.1 (2018 June) (“[TS101539-2]”), and ETSI TS 101 539-3 v1.1.1 (2013 November) (“[TS101539-3]”), which includes multiple ITS use cases.

The exchange of DENMs 200 among ITS-Ss is operated by DENM protocol (see e.g., ETSI EN 302 637-3 V1.3.1 (2019 April) (“[EN302637-3]”), the contents of which is hereby incorporated by reference in its entirety). The general processing procedure of an ITS use case that is supported by the DENM protocol is as follows: (i) upon detection of an event, an ITS-S transmits a DENM 200 in order to disseminate the information about this event to other ITS-Ss located inside an area of relevance (the ITS-S that transmits DENM 200 is denoted as the “originating ITS-S”, “transmitting ITS-S”, or “Tx ITS-S”); (ii) DENM 200 transmission is initiated and terminated by an ITS-S app at the ITS application layer 501 (see e.g., [TS101539-1], [TS101539-2], and [TS101539-3]); (iii) the transmission of a DENM 200 may be repeated; (iv) DENM 200 transmission may persist as long as the event is present; (v) an ITS-S may forward a DENM 200 (this ITS-S is denoted as the “forwarding ITS-S”); (vi) the termination of DENM 200 transmission is either automatically achieved by the facilities layer 502 (e.g., the DENBS 521 of the Tx ITS-S) when a predefined expiry time is reached, or by an ITS-S app that requests the generation of a DENM 200 to inform that the event has terminated; (vii) an ITS-S that receives a DENM 200, processes the information and may decide to present an appropriate warning or information to user, as long as the information in the received DENM 200 is relevant to the ITS-S (this ITS-S is denoted as the “receiving ITS-S” or “Rx ITS-S”).

A DENM 200 may be forwarded by intermediate ITS-Ss in order to disseminate DENM 200 from the Tx ITS-S to the Rx ITS-S, if the Rx ITS-S is not located in the direct communication range of the Tx ITS-S. This forwarding is realized by the ITS N&T layer 503. In addition, the DENBS 521 may provide forwarding functionality at the facilities layer, in order to maintain the DENM 200 retransmission in certain situations, for example when the Tx ITS-S has lost the capability to repeat DENM 200 transmission. This facilities layer forwarding functionality is illustrated as dotted lines in FIG. 1 of [EN302637-3].

The DENBS 521 is a facilities layer 502 entity that operates the DENM protocol, and provides services to entities at the ITS application layer 501. At a Tx ITS-S, an ITS-S app may trigger, update, and terminate the transmission of DENMs 200. At an Rx ITS-S, the DENBS 521 processes received DENMs 200 and makes the information available for usage in ITS-S applications process. In some examples, the DENBS 521 provides forwarding functionality.

The DENBS 521 uses the services provided by the protocol entities of the N&T layer 503 to disseminate DENM 200. Typically, for road safety ITS apps specified in [TS101539-1], [TS101539-2], and [TS101539-3], the destination of a DENM 200 transmission is one or more ITS-Ss that are located in a pre-defined geographic area close to the detected event position. A DENM 200 may also be disseminated over a long distance or to a central ITS-S(C-ITS-S), such as for vehicle rerouting or road traffic management purposes.

A DENM 200 contains information related to an event that has potential impact on road safety or traffic condition. Here, an event is characterized by an event type, an event position, a detection time and a time duration. These attributes may change over space and over time. In some situations, the Tx ITS-S transmits a DENM 200 of an event caused by the ITS-S itself, such as electronic brake light event. The Tx ITS-S manages the transmission and the termination of the DENM 200 for this event.

However, in some other situations, DENMs 200 related to the same event may be transmitted by more than one Tx ITS-Ss. In addition, in case the Tx ITS-S is mobile (e.g., V-ITS-S 410 or P-ITS-S 410v), an event may persist even after the Tx ITS-S has moved to a position far from the event position. For example, multiple vehicle ITS-Ss may detect black ice on the road surface and transmit DENMs 200. These DENMs 200 are relayed by other ITS-Ss even after the detecting vehicle ITS-Ss have left the black ice location. Therefore, the DENM 200 transmission is independent from the Tx ITS-S in this example. The DENM protocol is designed to manage these situations.

A DENM 200 can be, or have a DENM type, such as a new DENM 200, an update DENM 200, a cancellation DENM 200, and a negation DENM 200. A new DENM 200 is a DENM 200 generated by the DENBS 521 when an event is detected by a Tx ITS-S for the first time. Each new DENM 200 is assigned with a new identifier, denoted as actionID. A new DENM 200 provides event attributes, such as event position, event type, event detection time, and other attributes. An update DENM 200 is a DENM 200 generated by the DENBS 521 that includes update information of an event. An update DENM 200 is transmitted by the same Tx ITS-S, which had generated the new DENM 200 for the same event. A cancellation DENM 200 is a DENM 200 that informs the termination of an event. A cancellation DENM 200 is transmitted by the same Tx ITS-S which has generated the new DENM 200 for the same event. A negation DENM 200 is a DENM 200 that informs the termination of an event for which the new DENM 200 has been received by the Tx ITS-S from another ITS-S. A negation DENM 200 may be used to announce the termination of an event if the Tx ITS-S has the capacity to detect the termination of an event which has been previously announced by other ITS-Ss. As example, the Tx ITS-S of a new DENM 200 indicating black ice has left the event position, some time later, another ITS-S receiving this new DENM 200 reaches the indicated black ice position and detects that the back ice has disappeared. The latter ITS-S may in this case generate a negation DENM 200 for this event. Whether a negation DENM 200 is transmitted may depend on the application requirements and the deployment requirement.

The DENBS 521 of the Tx ITS-S is able to construct the aforementioned DENM 200 types. An ITS-S app of the Tx ITS-S sends an application request to the DENBS 521 in order to trigger the generation of DENMs 200. The type of the DENM 200 to be generated depends on the type of the application request. Due to the different detection capabilities of ITS-Ss, the quality of the provided information in a DENM 200 may vary. However, predefined conditions are to be satisfied by an ITS-S in order to initiate and terminate the transmission of DENMs 200 for a specific event. These conditions are specified as ITS application requirements in [TS101539-1], [TS101539-2], and [TS101539-3].

The DENMs 200 are included in ITS packets/messages, which are facilities layer PDUs that are passed to the access layer 504 via the N&T layer 503 or passed to the application layer 501 for consumption by one or more ITS apps. In this way, the DENM format (see e.g., FIG. 2) is agnostic to the underlying access layer 504 and is designed to allow DENMs 200 to be shared regardless of the underlying access technology/RAT.

Each of the aforementioned interfaces/Service Access Points (SAPs) may provide the full duplex exchange of data with the facilities layer 502, and may implement suitable APIs to enable communication between the various entities/elements. For a V-ITS-S 410, the facilities layer 502 is connected to an in-vehicle network via an in-vehicle data gateway as shown and described infra. The facilities and apps of a V-ITS-S 410 receive required in-vehicle data from the data gateway in order to construct ITS messages (e.g., CSMs, VAMs, CAMs, CPMs, MCMs, DENMs 200, and/or the like) and for ITS app usage.

The N&T layer 503 provides functionality of the OSI network layer and the OSI transport layer and includes one or more networking protocols, one or more transport protocols, and network and transport layer management. Each of the networking protocols may be connected to a corresponding transport protocol. Additionally, sensor interfaces and communication interfaces may be part of the N&T layer 503 and access layer 504. Examples of the networking protocols include GeoNetworking protocol (see e.g., ETSI EN 302 636-4-1 v1.4.1 (2020 January) (“[EN302636-4-1]”)), BTP (see e.g., [EN302636-5-1]), IPv4, IPv6, IPv6 networking with mobility support, IPv6 over GeoNetworking, CALM, CALM FAST, FNTP, and/or some other suitable network protocol such as those discussed herein. Examples of the transport protocols include BOSH, BTP, GRE, GeoNetworking protocol, MPTCP, MPUDP, QUIC, RSVP, SCTP, TCP, UDP, VPN, one or more dedicated ITSC transport protocols, and/or some other suitable transport protocol such as those discussed herein.

The access layer includes a physical layer (PHY) 504 connecting physically to the communication medium, a data link layer (DLL), which may be sub-divided into a medium access control sub-layer (MAC) managing the access to the communication medium, and a logical link control sub-layer (LLC), management adaptation entity (MAE) to directly manage the PHY 504 and DLL, and a security adaptation entity (SAE) to provide security services for the access layer 504. The access layer 504 may also include external communication interfaces (CIs) and internal CIs. The CIs are instantiations of a specific access layer technology or RAT and protocol such as 3GPP LTE, 3GPP 5G/NR, C-V2X (e.g., based on 3GPP LTE and/or 5G/NR), WiFi, W-V2X (e.g., including ITS-G5 and/or DSRC), DSL, Ethernet, Bluetooth, and/or any other RAT and/or communication protocols discussed herein, or combinations thereof. The CIs provide the functionality of one or more logical channels (LCHs), where the mapping of LCHs on to physical channels is specified by the standard of the particular access technology involved. As alluded to previously, the V2X RATs may include ITS-G5/DSRC and 3GPP C-V2X. Additionally or alternatively, other access layer technologies (V2X RATs) may be used in various other implementations.

The management entity 505 is in charge of managing communications in the ITS-S including, for example, cross-interface management, Inter-unit management communications (IUMC), networking management, communications service management, ITS app management, station management, management of general congestion control, management of service advertisement, management of legacy system protection, managing access to a common Management Information Base (MIB), and so forth.

The security entity 506 provides security services to the OSI communication protocol stack, to the security entity and to the management entity 505. The security entity 506 contains security functionality related to the ITSC communication protocol stack, the ITS station and ITS apps such as, for example, firewall and intrusion management; authentication, authorization and profile management; identity, crypto key and certificate management; a common security information base (SIB); hardware security modules (HSM); and so forth. The security entity 506 can also be considered as a specific part of the management entity 505.

The ITS-S reference architecture 500 may be applicable to the elements of FIGS. 7 and 9. The ITS-S gateway 711, 911 (see e.g., FIGS. 7 and 9) interconnects, at the facilities layer, an OSI protocol stack at OSI layers 5 to 7. The OSI protocol stack is typically is connected to the system (e.g., vehicle system or roadside system) network, and the ITSC protocol stack is connected to the ITS station-internal network. The ITS-S gateway 711, 911 (see e.g., FIGS. 7 and 9) is capable of converting protocols. This allows an ITS-S to communicate with external elements of the system in which it is implemented. The ITS-S router 711, 911 provides the functionality the ITS-S reference architecture 500 excluding the Apps and Facilities layers. The ITS-S router 711, 911 interconnects two different ITS protocol stacks at layer 3. The ITS-S router 711, 911 may be capable to convert protocols. One of these protocol stacks typically is connected to the ITS station-internal network. The ITS-S border router 914 (see e.g., FIG. 9) provides the same functionality as the ITS-S router 711, 911, but includes a protocol stack related to an external network that may not follow the management and security principles of ITS (e.g., the mgmnt layer 505 and security layer 506 in FIG. 5).

Additionally, other entities that operate at the same level but are not included in the ITS-S include the relevant users at that level, the relevant HMI (e.g., audio devices, display/touchscreen devices, and/or the like); when the ITS-S is a vehicle, vehicle motion control for computer-assisted and/or automated vehicles (e.g., both HMI and vehicle motion control entities may be triggered by the ITS-S apps); a local device sensor system and IoT platform that collects and shares IoT data; local device sensor fusion and actuator app(s), which may contain ML/AI systems, and aggregates the data flow issued by the sensor system; local perception and trajectory prediction apps that consume the output of the fusion app and feed the ITS-S apps; and the relevant ITS-S. The sensor system can include one or more cameras, radars, LIDARs, and/or the like, in a V-ITS-S 410 or R-ITS-S 430. In the central station, the sensor system includes sensors that may be located on the side of the road, but directly report their data to the central station, without the involvement of a V-ITS-S 410 or R-ITS-S 430. In some cases, the sensor system may additionally include gyroscope(s), accelerometer(s), microphones and/or other audio sensors, and/or the like (see e.g., sensor circuitry 1042 of FIG. 10). These elements are discussed in more detail infra w.r.t FIGS. 7, 8, and 9.

3.2. Den Basic Service Aspects

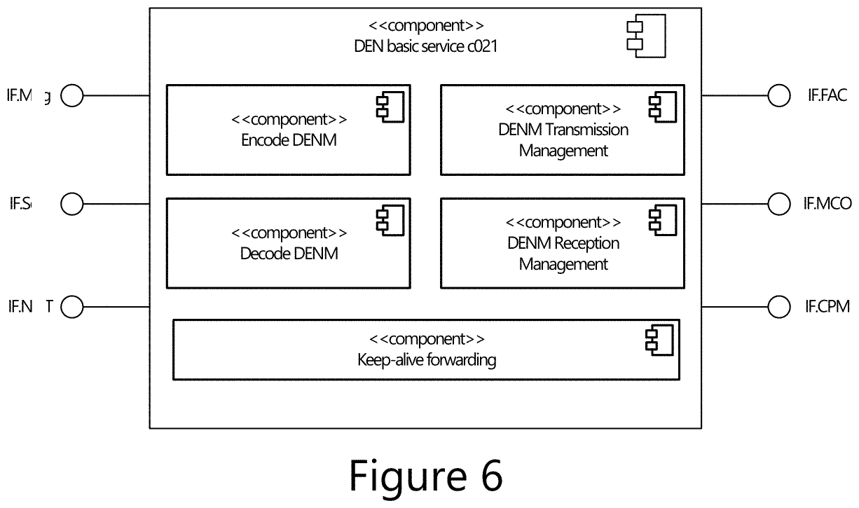

FIG. 6 shows an example DENBS 521 functional architecture. The encode DENM sub-function constructs the DENMs 200 according to the format specified in Annex A of [EN302637-3]. The decode DENM sub-function decodes received DENMs 200.

The DENM transmission management sub-function implements the DENM protocol operation of the Tx ITS-S as specified in [EN302637-3] § 8.2. This includes, for example, the generation of a new DENM 200 as requested by the ITS-S applications at the Tx ITS-S; the generation of an update DENM 200 as requested by the ITS-S applications at the Tx ITS-S; and the termination of the DENM 200 transmission as requested by the ITS-S applications at the Tx ITS-S. DENM termination refers to the generation of a cancellation DENM 200 or a negation DENM 200 as defined in [EN302637-3] § 4.2.

The DENM reception management sub-function implements the DENM protocol operation of the Tx ITS-S as specified in [EN302637-3] § 8.4. This includes, for example, the update of the Rx ITS-S message table as defined in [EN302637-3] § 8.4.1; discarding of received invalid DENMs 200; and provisioning of received DENM data to ITS-S applications and/or to other facilities layer entities of the Rx ITS-S.

The DENM Keep Alive Forwarding (KAF) sub-function implements the DENM protocol operation of the forwarding ITS-S. In one possible KAF protocol, the KAF stores a received DENM during its validity duration, and forwards the DENM when applicable as specified in [EN302637-3] § 8.3. The usage conditions of the KAF may either be defined by the ITS applications requirements or by a cross-layer functionality of the management entity.

Interfaces of the DENBS 621 include a management layer interface (IF.Mng), a security layer interface (IF. Sec), an N&T layer interface (IF.N&T), a DENM transmission interface (IF.DEN.1), and a DENM reception interface (IF.DEN.2).

An ITS-S app is an ITS application layer 501 entity that implements the application logic of one or more ITS use cases. It requests the generation of different types of DENMs 200 (see e.g., [EN302637-3] § 4.2) according to pre-defined or configured conditions, for example, as specified in [TS101539-1], [TS101539-2], and [TS101539-3]. The DENBS 621 provides APIs to ITS-S apps for the processing of the DENM protocol of the Tx ITS-S 500, the forwarding ITS-S 500, and the Rx ITS-S 500. As illustrated in FIG. 6, the interface IF.DEN.1 is the API for DENM transmission and the interface IF.DEN.2 is the API for DENM reception. Data is exchanged between the DENBS 621 and ITS-S applications via these APIs. In one implementation, these APIs may be implemented as FA-SAP.

At the Tx ITS-S 500, the ITS-S app sends a request to the DENBS 621 to generate DENM 200 and to start the DENM transmission. Three types of application request are defined: AppDENM_trigger (e.g., the Tx ITS-S 500 detects a new event and triggers the transmission of a new DENM 200); AppDENM_update (e.g., the Tx ITS-S 500 detects the evolution of a detected event and requests the transmission of an update DENM with update information); and AppDENM_termination (e.g., the Tx ITS-S 500 detects the termination of an event and requests the transmission of a cancellation DENM 200 or a negation DENM 200 to inform other ITS-Ss 500 of the event termination).

According to the application request type, a DENM 200 of a specific type as defined in [EN302637-3] § 4.2 is generated and transmitted by the DENBS 621. Table 3-1 defines the mapping between the application request types and generated DENM types.

TABLE 3-1
Mapping between application request types and DENM types

| Application request | |
|---|---|
| Type | DENM type to be generated |
| AppDENM_trigger | New DENM |
| AppDENM_update | Update DENM |
| AppDENM_termination | Cancellation DENM if the originating ITS-S |
| | has generated the new DENM, or negation |
| | DENM otherwise |

[EN302637-3] §§ 5.4.1.2 to 5.4.1.5 provide examples of data being passed via the interfaces IF.DEN.1 and IF.DEN.2. For the sake of the presentation clearness, the data is categorized into data passed from the ITS-S application to the DENBS 621 and data returned from the DENBS 621 to the requesting ITS-S application.

Data passed via the IF.DEN.1 interface for the request type AppDENM_trigger are shown by Table 3-2. Data passed via IF.DEN.1 interface for the request type AppDENM_update is shown by Table 3-3. Data passed via interface IF.DEN.1 for the request type AppDENM_termination is shown by Table 3-4.

TABLE 3-2
Data passed via the interface IF.DEN.1 for AppDENM_trigger

| Category | Data | Definition (Data format is up to implementation) | Remarks |
|---|---|---|---|
| Data passed | Event detection time | {DENM.denm.management.detectionTime} as specified | |
| from ITS-S | | in Annex A of [EN302637-3]. | |
| application to | Event position | {DENM.denm.management.eventPosition} as specified | |
| DENBS | | in Annex A of [EN302637-3]. | |
| | Event validity | {DENM.denm.management.validityDuration} as specified | Optional (see note 1) |
| | duration | in Annex A of [EN302637-3]. | |
| | Repetition duration | Duration of the DENM repetition in units of milliseconds, | Optional (see note 2) |
| | | denoted as repetitionDuration. | |
| | Transmission | {DENM.denm.management.transmissionInterval} as | Optional (see note 3) |
| | interval | specified in Annex A of [EN302637-3]. | |
| | Repetition interval | Interval of DENM repetition in units of milliseconds, | Optional (see note 2) |
| | | denoted as repetitionInterval. | |
| | Information | {DENM.denm.situation} as specified in Annex A of | Optional (see note 4) |
| | contained in the | [EN302637-3]. | |
| | situation container | | |
| | Information | {DENM.denm.location} as specified in Annex A of | Optional (see note 4) |
| | contained in the | [EN302637-3]. | |
| | location container | | |
| | Information | {DENM.denm.alacarte} as specified in Annex A of | Optional (see note 5) |
| | contained in the à la | [EN302637-3]. | |
| | carte container | | |
| | Relevance area of the | {DENM.denm.management.relevanceDistance} and | Optional (see note 6) |
| | event | {DENM.denm.management.relevanceTrafficDirection} as | |
| | | specified in Annex A of [EN302637-3]. | |
| | Destination area | Destination area for DENM dissemination as specified in | |
| | | [EN302931]. | |
| | Traffic class | GN traffic class of the DENM as defined in | |
| | | [EN302636-4-1] if GeoNetworking/BTP is used. | |
| Data returned | actionID or other | {DENM.denm.management.actionID} as specified in | |
| from DENBS to | applicable identifier | Annex A of [EN302637-3]. | |
| the requesting | (see note 7) | The DENBS returns the actionID or other applicable | |
| ITS-S | | identifier created by the DENBS | |
| application | | to the requesting ITS-S application, in case the request | |
| | | was successfully handled. | |
| | Failure notification | The DENBS returns a failure notification to the | Applicable as specified in |
| | | requesting application under the condition as specified in | clause 8 of [EN302637-3] |
| | | clause 8 of [EN302637-3]. | |

note 1:
Applicable if the ITS-S application detects or estimates the event expiration time.
note 2:
Applicable if the ITS-S application requests the DENM repetition.
note 3:
Applicable if the ITS-S application requests the KAF for the DENM.
note 4:
As alternative of providing data via IF.DEN.1, the requesting ITS-S application may request DENBS to collect data from other facilities of the facilities layer.
note 5:
Applicable if the ITS-S application requests the transmission of an à la carte container.
note 6:
Applicable if the ITS-S application has the knowledge of the relevance area.
note 7:
An applicable identifier is associated to the actionID as created by the DENBS, it may be used for the interaction between the ITS-S application and the DENBS.

TABLE 3-3
Data passed via the interface IF.DEN.1 for AppDENM_update

| Category | Data | Definition (Data format is up to implementation) | Remarks |
|---|---|---|---|
| Data passed | actionID or other | ActionID or other applicable identifier for which the | |
| from application | applicable identifier | update is detected (An applicable identifier is | |
| to DENBS | | associated to the actionID as created by the | |
| | | DENBS, it may be used for the interaction between | |
| | | the ITS-S application and DENBS). | |
| | | {DENM.denm.management.actionID} as specified in | |
| | | Annex A of [EN302637-3]. | |
| | Event update | {DENM.denm.management.detectionTime} as | |
| | detection time | specified in Annex A of [EN302637-3]. | |
| | Event position | {DENM.denm.management.eventPosition} as | |
| | | specified in Annex A of [EN302637-3]. | |
| | Event validity | {DENM.denm.management.validityDuration} as | Applicable if an update of the |
| | duration | specified in Annex A of [EN302637-3]. | data is detected |
| | Repetition duration | Duration of the DENM repetition in units of | Applicable if an update of the |
| | | milliseconds, denoted as repetitionDuration. | data is detected; |
| | | | Applicable if the ITS-S |
| | | | application requests the DENM |
| | | | repetition |
| | Transmission | {DENM.denm.management.transmissionInterval} | Applicable if an update of the |
| | interval | as specified in Annex A of [EN302637-3]. | data is detected; |
| | | | Applicable if the ITS-S |
| | | | application requests the KAF for |
| | | | the DENM |
| | Repetition interval | Interval of DENM repetition in units of milliseconds, | Applicable if an update of the |
| | | denoted as repetitionInterval. | data is detected; |
| | | | Applicable if the ITS-S |
| | | | application requests the DENM |
| | | | repetition |
| | Information | {DENM.denm.situation} as specified in Annex A of | Applicable if an update of the |
| | contained in the | [EN302637-3]. | data is detected |
| | situation | | |
| | container | | |
| | Information | {DENM.denm.location} as specified in Annex A of | Applicable if an update of the |
| | contained in the | [EN302637-3]. | data is detected |
| | location | | |
| | container | | |
| | Information | {DENM.denm.alacarte} as specified in Annex A of | Applicable if an update of the |
| | contained in the à | [EN302637-3]. | data is detected |
| | la carte | | |
| | container | | |
| | Relevance area of the | {DENM.denm.management.relevanceDistance} | Applicable if an update of the |
| | event | and {DENM.denm.management. | data is detected; |
| | | relevanceTrafficDirection} as specified in Annex A of | Applicable if the ITS-S |
| | | [EN302637-3]. | application has the knowledge of |
| | | | the relevance area |
| | Destination area | Destination area for DENM dissemination as | |
| | | specified in [EN302931] | |
| | Traffic class | GN traffic class of the DENM as defined in | Applicable if an update of the |
| | | [EN302636-4-1], if GeoNetworking/BTP is used. | data is detected |
| Data returned | actionID or other | {DENM.denm.management.actionID} as specified in | |
| from DENBS to | applicable identifier | Annex A. | |
| the requesting | (see note 1) | The DENBS returns the actionID or other applicable | |
| application | | identifier created by the DENBS to the requesting | |
| | | ITS-S application. | |
| | Failure notification | The DENBS returns a failure notification to the | Applicable as specified in clause |
| | | requesting application under the condition as | 8 of [EN302637-3] |
| | | specified in clause 8 of [EN302637-3]. | |

TABLE 3-4
Data passed via the interface IF.DEN.1 for AppDENM_termination

| Category | Data | Definition (Data format is up to implementation) | Remarks |
|---|---|---|---|
| Data passed | actionID or other | actionID or other applicable identifier for which the | |
| from application | applicable identifier | termination is detected (An applicable identifier is | |
| to DENBS: | | associated to the actionID as created by the DENBS, | |
| | | it may be used for the interaction between the ITS-S | |
| | | application and DENBS). | |
| | | {DENM.denm.management.actionID} as specified in | |
| | | Annex A of [EN302637-3]. | |
| | Event termination | {DENM.denm.management.detectionTime} as | |
| | detection time | specified in the Annex A of [EN302637-3]. | |
| | Event position | Position at which the event termination is detected. | |
| | | {DENM.denm.management.eventPosition} as | |
| | | specified in Annex A of [EN302637-3]. | |
| | Event validity | Validity of the event termination information. | Applicable if the application |
| | duration | {DENM.denm.management.validityDuration} as | detects the event |
| | | specified in Annex A of [EN302637-3]. | termination information |
| | | | expiry time. |
| | Repetition duration | Duration of the DENM repetition in units of | Applicable if the application |
| | | milliseconds, denoted as repetitionDuration. | requests the DENM |
| | | | repetition |
| | Transmission | {DENM.denm.management.transmissionInterval} as | Applicable if the ITS-S |
| | interval | specified in Annex A of [EN302637-3]. | application requests the |
| | | | KAF for the DENM |
| | Repetition interval | Interval of DENM repetition in units of milliseconds, | Applicable if the application |
| | | denoted as repetitionInterval. | requests the DENM |
| | | | repetition |
| | Relevance area of the | {DENM.denm.management.relevanceDistance} and | Applicable if the ITS-S |
| | event | {DENM.denm.management. relevanceTrafficDirection} | application has the |
| | | as specified in Annex A of [EN302637-3]. | knowledge of the relevance |
| | | | area |
| | Destination area | Destination area for DENM dissemination as specified | |
| | | in [EN302931] | |
| | Traffic class | GN traffic class of the DENM as defined in | |
| | | [EN302636-4-1], if GeoNetworking/BTP is used. | |
| Data returned | actionID or other | {DENM.denm.management.actionID} as specified in | |
| from DENBS to | applicable identifier | Annex A of [EN302637-3]. | |
| the requesting | (see note 1) | The DENBS returns the actionID or other applicable | |
| application | | identifier created by the DENBS to the requesting | |
| | | ITS-S application. | |
| | Failure notification | The DENBS returns a failure notification to the | Applicable as specified in |
| | | requesting application under the condition as specified | clause 8 of [EN302637-3] |
| | | in clause 8 of [EN302637-3]. | |

At the Rx ITS-S, the DENBS 621 may provide the received DENM content in whole or in part to ITS-S applications via the interface IF.DEN.2. The list of data passed via the interface IF.DEN.2 from the DENBS 621 may vary depending to the ITS application needs. Alternatively, ITS-S applications may receive DENM information via the LDM database as described in [EN302637-3] § 5.2. Table 3-5 provides an example of data passed via IF.DEN.2.

TABLE 3-5
Data passed via the interface IF.DEN.2

| Category | Data | Definition (Data format is up to implementation) | Remarks |
|---|---|---|---|
| Data passed | DENM | {denm} in whole or in part as specified in Annex A | Applicable if ITS-S |
| from DENBS to | | of [EN302637-3]. | application of the Rx |
| ITS-S | | | ITS-S requests the |
| applications | | | content of received |
| | | | DENM |

In some implementations of IF.DEN.2, DENM content is provided directly by the DENBS 621 to the ITS-S app when a DENM is received (e.g., push mode), or on demand when an ITS-S application requests specific DENM content to the DENBS 621 (e.g., pull mode). Additionally or alternatively, both push and pull modes may be implemented. Similar data exchange methods may also be used for IF.DEN.1 interface implementations. When an ITS-S app sends a request to the DENBS 621, data is pushed from the app to the DENBS 621, and the DENBS 621 returns data as specified in [EN302637-3] §§ 5.4.1.2, 5.4.1.3 and 5.4.1.4 to the ITS-S app.

The DENBS 621 exchanges information with the N&T layer 503 via the IF.N&T interface, which may be realized as the NF-SAP in FIG. 5 (see e.g., ETSI TS 102 723-11 v1.1.1 (2013 November) (“[TS102723-11]”)). For ITS apps specified in [TS101539-1], [TS101539-2], and [TS101539-3], point-to-multipoint communication as defined in ETSI EN 302 636-2 v1.2.1 (2013 November) and ETSI TS 102 636-3 v1.2.1 (2014 December) (“[TS102636-3]”) is used for the dissemination of DENMs. At the Tx ITS-S, the DENBS 621 delivers a DENM to the N&T layer 503. The DENBS 621 provides, for example, the protocol control information (PCI) specified in Table 3-6 to the N&T layer 503. At Rx ITS-S, if the Rx ITS-S is considered as the destination of the DENM dissemination, the N&T layer 503 delivers the received DENM to the DENBS 621. Table 3-6 provides minimum data being passed between the DENBS 621 and ITS N&T layer 503 for the originating and Rx ITS-S.

TABLE 3-6
Data passed between the DEN basic service and the ITS N&T layer

| Category | Data | Definition (Data format is up to implementation) | Remarks |
|---|---|---|---|
| Data passed | DENM | {denm} as specified in Annex A of [EN302637-3]. | |
| from DENBS to | Destination area | Destination area for DENM dissemination. The definition of | |
| the ITS N&T | | DENM destination area is specified in [EN302931]. | |
| layer | Repetition interval | In units of milliseconds. | Applicable if the ITS-S |
| | | | application requests the |
| | | | DENM repetition by the ITS |
| | | | N&T layer. The repetition |
| | | | may also be performed by the |
| | | | DENBS at the facility layer |
| | | | as described in clause 5.4.1 |
| | | | of [EN302637-3] |
| Data passed | Received DENM | {denm} as specified in Annex A of [EN302637-3]. | Applicable of the Rx ITS-S |
| from the ITS | | | is considered by the ITS N&T |
| N&T layer | | | layer as inside the |
| | | | destination area |

A DENM may rely on services provided by the GeoNetworking/BTP stack to disseminate a DENM to a geographic destination area. For ITS applications specified in [TS101539-1], [TS101539-2], and [TS101539-3], BTP header type B and GeoBroadcast protocol is used for the DENM dissemination. Data passed between the DENBS 621 and the GeoNetworking/BTP stack is specified in Table 3-6 and Table 3-7.

TABLE 3-7
Data passed from DENBS to GeoNetworking/BTP at the originating ITS-S

| | | Requirement (Data format is up to | |
|---|---|---|---|
| Category | Data | implementation) | Remarks |
| Data passed | BTP type | BTP header type B (ETSI EN 302 636-5- | Applicable if the value is not provided |
| from the DENBS | | 1 v2.2.1 (2019 May) (“[EN302636-5-1]”), | or different from the ITS-S |
| to GeoNetworking/ | | clause 7.2.2). | configuration |
| BTP | Destination port | As specified in [EN302636-5-1]. When a | Applicable if the value is not provided |
| | | global registration authority for ITS | or different from the ITS-S |
| | | application ISO EN 17419 is operational, | configuration |
| | | the BTP destination port registered with | |
| | | this authority should be used. | |
| | Destination port info | As specified in [EN302636-5-1]. | Applicable if the value is not provided |
| | | | or different from the ITS-S |
| | | | configuration |
| | GN Packet transport | GeoNetworking GeoBroadcast protocol. | Applicable if the value is not provided |
| | type | | or different from the ITS-S |
| | | | configuration |
| | GN Destination | Specified as Destination area in Table 6. | |
| | address | | |
| | GN communication | Unspecified, ITS G5 or LTE-V2X. | Applicable if the value is not provided |
| | profile | | or different from the ITS-S |
| | | | configuration |
| | GN security profile | SECURED or UNSECURED. | Applicable if the value is not provided |
| | | | or different from the ITS-S |
| | | | configuration |
| | Traffic class | As defined in [EN302636-4-1]. | |
| | GN Maximum packet | should not exceed validityDuration. | Applicable if the value is not provided |
| | lifetime | | or different from the ITS-S |
| | | | configuration |
| | GN Hoplimit | | Applicable if the value is not provided |
| | | | or different from the ITS-S |
| | | | configuration |
| | Length | Length of the DENM. | |

A DENM may rely on the IPv6 stack or the combined IPv6/GeoNetworking stack as defined in [TS102636-3] for DENM dissemination. When the DENM dissemination makes use of the combined IPv6/GeoNetworking stack, the interface between the DENBS 621 and the combined IPv6/GeoNetworking stack may be identical to the interface between the DENBS 621 and IPv6 stack.

The DENBS 621 may exchange information with the ITS management entity 505 via the IF.Mng interface. The IF.Mng interface may be realized as the MF-SAP (see e.g., ETSI TS 102 723-5 v1.1.1 (2012 November)). The DENBS 621 may exchange information with the ITS security entity 506 via the IF.SEC interface. In some implementations, the IF.SEC interface may be realized using the SF-SAP or using the NF-SAP (see e.g., [TS102723-11] and SN-SAP (see e.g., ETSI TS 102 723-8 v1.1.1 (2016 April)). In case the NF-SAP and SN-SAP are used for the realization of IF.SEC. The DENM payload is passed through NF-SAP to SN-SAP.

3.2.1. Den Protocol Operation

The protocol operations of the DENBS 621 include three roles: originating ITS-S operation; forwarding ITS-S operation; and receiving ITS-S operation. The protocol operation includes protocol data setting rules specify the setting of the relevant parameters used by the protocol. The general protocol operation specifies the sequence of protocol operations. The exception handling specifies additional protocol operations that extend the general protocol operation. They are applied when special conditions, referred to exceptions (for example inconsistent data) occur. An ITS-S maintains a local data structure, referred to as an “ITS-S message table”, which holds information about sent or received DENM messages.

3.2.1.1. Originating ITS-S Operation

3.2.1.1.1. Protocol Data Setting Rules

The data setting for the originating ITS-S operation are specified in Annex B of [EN302637-3] and follow the rules discussed herein and/or defined in [EN302637-3].

For the application request type AppDENM_trigger, a new actionID is assigned to an unused value. The sequenceNumber in the actionID is set to a next unused value each time a new event is detected by the originating ITS-S.

For the application request type AppDENM_update, the application may pass actionID to the DENBS 621 in the application request. For update DENM, the actionID remains unchanged, as long as the originating ITS-S stationID is unchanged. For the application request type AppDENM_termination, the application may pass actionID to the DENBS 621 in the application request. For cancellation DENM, the actionID remains unchanged, as long as the originating ITS-S stationID is unchanged. For negation DENM, the actionID is set to the actionID for which the negation DENM refers to. In case ITS application requests the DENM repetition, the actionID remains unchanged during DENM repetition, as long as the originating ITS-S stationID is unchanged.

For the application request type AppDENM_trigger, the reference Time is set to the time at which the new DENM is generated by the DENBS 621. For the application request type AppDENM_update, the reference Time is set to the time at which update DENM is generated by the DENBS 621 for each update. For the application request type AppDENM_termination, DENBS 621 generates a cancellation DENM if the originating ITS-S message table as defined in [EN302637-3] § 8.2.1.6 contains a DENM of the same actionID. The DENBS 621 generates a negation DENM if the receiving ITS-S message table as defined in [EN302637-3] § 8.4.1.6 contains a DENM of the same actionID. Otherwise, the DENBS 621 ignores the application request and sends a failure notification to the ITS-S application. For cancellation DENM, the reference Time is set to the time at which cancellation DENM is generated. For negation DENM, the reference Time is set to the latest value of the DENM of the same actionID in the receiving ITS-S message table. This is to enable receiving ITS-Ss to match to which event update the negation DENM is referring to (see e.g., [EN302637-3] § 6.1.2.4). In case application requests the DENM repetition, the reference Time remains unchanged during the DENM repetition.

For the application request type AppDENM_trigger, the termination DE is not included in DENM. For the application request type AppDENM_update, the termination DE may be present, depending on the DENM type for which the update is requested by the ITS-S application. For the application request type AppDENM_termination, the termination is set to 1 if a negation DENM is to be generated. The termination is set to 0 if a cancellation DENM is to be generated.

The timer T_O_Validity is the time that indicates the end of the DENM validity for the originating ITS-S protocol operation. Its expiration time is set to: the offset of the validityDuration starting from the detection Time, if the validityDuration is provided by the application; and/or the default offset of 600 s starting from the detectionTime, if the validityDuration is not provided by the application.

The timer T_RepetitionDuration is the time that indicates the end of the DENM repetition by the DENBS 621 of the originating ITS-S. Its expiration time is set to: the offset of the repetitionDuration starting from the reference Time, if the repetitionDuration is provided by the application; and/or an invalid value, if the repetitionDuration is not provided by the application. In some examples, the repetitionDuration is not included in DENM.

The timer T_Repetition schedules the DENM repetition. Its timeout value is set to: the repetitionInterval, if the parameter is provided by the ITS-S application; and/or an invalid value, if the repetitionInterval is not provided by the ITS-S application. In some examples, the T_Repetition is set to invalid, the DENM is transmitted only once. Additionally or alternatively, repetitionInterval is not included in DENM. For all application request types, the T_Repetition and T_RepetitionDuration is not greater than the validityDuration.

Originating ITS-S message table: the DENBS 621 maintains at least all data as defined in the [EN302637-3] in the originating ITS-S message table. At a point in time, any DENM entry in the originating ITS-S message table may be associated with one of three states: ACTIVE state: The termination data is not set for DENM entry of the actionID; CANCELLED state: The termination value is set to 0 for DENM entry of the actionID; NEGATED state: The termination value is set to 1 for DENM entry of the actionID. The state of a DENM indicates the most updated status of a DENM entry of the same actionID. For application that requests the DENM repetition, the DENM is stored in the originating ITS-S message table.

3.2.1.1.2. General Protocol Operation

Upon reception of a request from ITS-S application via the interface IF.DEN.1, the DENBS 621 executes the following operations:

For application request type appDENM_trigger: (1) Calculate expiration time for timer T_O_Validity (see e.g., [EN302637-3] § 8.2.1.5): (a) If expiration time of timer T_O_Validity is in the past, send a failure notification to the ITS-S application and omit the execution of further steps; (b) Otherwise, continue the operation. (2) Assign unused actionID value (see e.g., [EN302637-3] § 8.2.1.2). (3) If transmissionInternval is provided by the application request: (a) Set transmissionInterval; (b) Otherwise, continue the operation. (4) Set other fields of DENM management container, situation container, location container and á la carte container (see e.g., [EN302637-3] § Annex A). (5) Set referenceTime to the current time. (6) Construct DENM. (7) Pass the DENM to the ITS N&T layer. (8) Create an entry in the originating ITS-S message table and set the state to ACTIVE. (9) Start/restart timer T_O_Validity. (10) If repentionDuration>0 and repetitionInterval>0: (a) Calculate and start timer T_RepetitionDuration and T_Repetition; (b) Otherwise, continue the operation. (11) Send actionID to the requesting ITS-S application. (12) End.

For application request type appDENM_update: (1) Calculate expiration time for timer T_O_Validity (see e.g., [EN302637-3] § 8.2.1.5): (a) If expiration time of timer T_O_Validity is in the past, send a failure notification to the ITS-S application and omit the execution of further steps. (b) Otherwise, continue the operation. (2) Compare actionID in the application request with entries in the originating ITS-S message table: (a) If actionID provided by the ITS-S application request does not exist in the originating ITS-S message table, send a failure notification to the ITS-S application and omit the execution of further steps. (b) Otherwise, continue the operation. (3) Stop T_O_Validity, T_RepetitionDuration and T_Repetition if applicable. (4) If transmissionInternval is provided by the application request: (a) Set transmissionInterval. (b) Otherwise, continue the operation. (5) Set other fields of DENM management container, situation container, location container and á la carte container (see e.g., [EN302637-3] § Annex A). (6) Set referenceTime to the current time. (7) Construct DENM. (8) Pass the DENM to the ITS N&T layer. (9) Update the entry in the originating ITS-S message table. (10) Start/restart timer T_O_Validity. (11) If repetitionDuration>0 and repetitionInterval>0: (a) Calculate and restart timer T_RepetitionDuration and T_Repetition. (b) Otherwise, continue the operation. (12) Send actionID to the requesting ITS-S application. (13) End.

For application request type appDENM_termination: (1) Set expiration time for timer T_O_Validity (see e.g., [EN302637-3] § 8.2.1.5): (a) If expiration time of timer T_O_Validity is in the past, send a failure notification to the ITS-S application and omit the execution of further steps. (b) Otherwise, continue the operation. (2) Compare actionID in the application request with entries in the originating ITS-S message table and the receiving ITS-S message table: (a) If actionID exists in the originating ITS-S message table and the entry state is ACTIVE, then set termination to isCancellation. (b) If actionID exists in the receiving ITS-S message table and, if applicable, the SSP is valid for that CauseCode; the entry state is ACTIVE, then set termination to isNegation. (c) Otherwise, send a failure notification to the ITS-S application and omit the execution of further steps. (3) Set referenceTime: (a) If termination is set to 0, set referenceTime to the current time. (b) If termination is set to 1, set referenceTime to the referenceTime value of receiving ITS-S message table DENM entry. (4) Stop T_O_Validity, T_RepetitionDuration and T_Repetition if applicable. (5) If transmissionInternval is provided by the application request: (a) Set transmissionInterval. (b) Otherwise, continue the operation. (6) Set other fields of the DENM management container (see e.g., [EN302637-3] § Annex A). (7) Construct DENM. (8) Pass the DENM to the ITS N&T layer. (9) Update the entry: (a) If termination is set to 0, update the entry in the originating ITS-S message table and set the state to CANCELLED. (b) If termination is set to 1, create an entry in the originating ITS-S message table and set the state to NEGATED. (10) Start/restart timer T_O_Validity. (11) If repentionDuration>0 and repetitionInterval>0: (a) Calculate and restart timer T_RepetitionDuration and T_Repetition. (b) Otherwise, continue the operation. (12) Send actionID to the requesting ITS-S application. (13) End.

When the timer T_O_Validity expires, the DENBS 621 executes the following operations: (1) Stop timer T_Repetition if exists. (2) Stop timer T_RepetitionDuration if exists. (3) Discard the expired DENM entry from the originating ITS-S message table.

When the timer T_RepetitionDuration expires, DENBS 621 executes the following operations: (1) Stop timer T_Repetition.

When the timer T_Repetition expires, DENBS 621 executes the following operations: (1) Pass the DENM to ITS N&T layer. (2) Restart timer T_Repetition.

3.2.1.1.3. Exception Handling

The originating ITS-S applies the exception handling rules specified in [EN302637-3].

DENM construction exceptions: If the DENBS 621 cannot construct a DENM successfully, the DENBS 621 sends a failure notification to the ITS-S application. This exception is valid for all application request types. The failure of the DENM construction may happen, if the DENBS 621 was not able to collect all required data for the DENM construction, or the collected data are not compliant to the DENM format as specified in Annex A (e.g., the value of a data is out of authorized range of the ASN.1 definition).

actionID non-existence exception: This exception applies to the application request types AppDENM_update and AppDENM_termination. For the application request type AppDENM_update, if the corresponding actionID does not exist in the originating ITS-S message table, the DENBS 621 sends a failure notification to the ITS-S application. For the application request type AppDENM_termination, if the corresponding actionID exists neither in the originating ITS-S message table (defined in [EN302637-3] § 8.2.1.6), nor in the receiving ITS-S message table (defined in [EN302637-3] § 8.4.1.6), the DENBS 621 sends a failure notification to the ITS-S application.

Time operation exception: If the expiration time of the timer T_O_Validity lies in the past when the application request is processed, the DENBS 621 sends a failure notification to the ITS-S application. This may happen, if the DENBS 621 is not able to process the application request in time, due to the processing delay of the ITS-S system.

3.2.1.2. Forwarding ITS-S Operation

The following clauses describe the protocol operation of a one possible KAF protocol as introduced in [EN302637-3] § 6.1.4.2. The KAF is a sub-function of the DENBS 621 that forwards a received DENM from the facilities layer to the ITS N&T layer when necessary. It may be deactivated either by the ITS-S application, the ITS-S configuration, the management layer or the DENBS 621 itself. The triggering of the KAF may be useful for some applications or some event types. This means that among the received DENM, it can be the case that only DENMs with certain actionIDs will be forwarded by the KAF protocol. An ITS-S may also deactivate the KAF protocol for all DENMs.

3.2.1.2.1. Protocol Data Setting Rules

The data setting for the forwarding ITS-S operation is as specified in Annex B and follows the rules defined in [EN302637-3]. The forwarding ITS-S does not set the actionID. The forwarding ITS-S does not set the reference Time. The forwarding ITS-S does not set the termination.

The timer T_F_Validity schedules the end of the DENM validity for the KAF protocol operation. Its expiration time is set to: the offset of the validityDuration starting from the detection Time, if the validityDuration is included in the received DENM; and/or an invalid value, if the validityDuration is not included in the received DENM. In some examples, if the timer T_F_Validity is set to an invalid value, the DENM is not forwarded and the KAF is deactivated.

The timer T_Forwarding schedules the DENM forwarding from the DENBS 621 to the ITS N&T layer. Its timeout value is set to: two times of the received transmissionInterval plus a random delay in the range of 0 ms to 150 ms, if the transmissionInterval and validityDuration are present in the received DENM and the resulting timeout value is not greater than the validityDuration; validityDuration, if transmissionInterval and validityDuration are present in the received DENM and two times of the transmissionInterval plus a random delay in the range 0 ms to 150 ms is greater than the validityDuration; an invalid value, if the transmissionInterval is not present in the received DENM; an invalid value, if the timeout of the timer T_F_Validity is set to an invalid value. In some examples, the random delay addresses the potential synchronization of the keep-alive forwarding functionality among multiple ITS-Ss. In some examples, if the timer T_F_Validity is set to an invalid value, the DENM is not forwarded. Therefore there is no need to set the timeout value and start/stop the timer T_Forwarding. In some examples, if the transmissionInterval is not present in the DENM, the originating ITS-S does not require the DENM to be kept alive and to be forwarded by an intermediate ITS-S.

Forwarding ITS-S message table: The DENBS 621 maintains a forwarding ITS-S message table. This message table at least stores the DENMs for which the KAF is activated. The forwarding ITS-S message table stores the received DENM payload. The update of the forwarding ITS-S message table follows the rules as defined in the receiving ITS-S operation specified in [EN302637-3] § 8.4. In some examples, the update of the forwarding ITS-S message table allows forwarding of the latest update DENM.

DENM reconstruction: When a DENM is being forwarded, the DENBS 621 reconstructs the DENM before forwarding it to the ITS N&T layer. For this reconstruction, the management container, situation container, location container and á la carte container of the DENM is not modified. The ITS PDU header is replaced by the ITS PDU header constructed by the forwarding ITS-S.

3.2.1.2.2. General Protocol Operation

Upon reception of a DENM with an actionID for which the KAF is activated, the DENBS 621 executes the following operations: (1) Check if the termination exists in received DENM: (a) If yes, continue the operation. (b) Otherwise, omit execution of further steps. (2) Check if the referenceTime of the received DENM is equal or greater than the referenceTime value of the DENM entry in the forwarding ITS-S message table of the same actionID: (a) If the received referenceTime is equal to the entry reference Time, start/restart T_F_Forwarding and omit execution of further steps. (b) If the received referenceTime is less than the entry reference Time, discard the received DENM and omit execution of further steps. (c) Otherwise, continue the operation. (3) Calculate expiration time of timer T_F_Validity (see e.g., [EN302637-3] § 8.3.2.5): (a) If timer T_F_Validity is set to invalid value, omit execution of further steps. (b) Otherwise, continue operation. (4) Calculate timeout value for timer T_Forwarding (see e.g., [EN302637-3] § 8.3.2.5): (a) If timer T_Forwarding is set to invalid value, omit execution of further steps. (b) Otherwise, continue operation. (5) Start/restart timer T_F_Validity and T_Forwarding. (6) Reconstruct DENM by replacing the ITS PDU header. (7) Update DENM entry in forwarding ITS-S message table. (8) End.

When the timer T_F_Validity expires, the DENBS 621 executes the following operations: (1) Stop T_Forwarding timer. (2) delete DENM entry from the forwarding message table. When the timer T_Forwarding expires, the DENBS 621 executes the following operations: (1) Check if the forwarding ITS-S is located in the relevance area or the destination area: (a) If not, omit execution of further steps. (b) Otherwise, continue operation. (2) Pass reconstructed DENM to ITS N&T layer. (3) Restart timer T_Forwarding.

3.2.1.2.3. Exception Handling

The forwarding ITS-S applies the exception handling rule specified in [EN302637-3].

DENM construction exception: If the DENBS 621 cannot construct a DENM successfully, the DENBS 621 stops executing further operations of the forwarding. The failure of the DENM reconstruction may happen, if the DENBS 621 was not able to collect all required data for the DENM reconstruction, or the collected data are not compliant to the DENM format as specified herein and/or in [EN302637-3], Annex A (e.g., the value of a data is out of range of the ASN.1 definition).

3.2.1.3. Receiving ITS-S Operation

3.2.1.3.1. Protocol Data Setting Rules

The data setting for the receiving ITS-S operation is as specified in [EN302637-3], Annex B and may follow the rules defined in [EN302637-3]. The receiving ITS-S does not set the actionID. The receiving ITS-S does not set the referenceTime. The receiving ITS-S does not set the termination.

The T_R_Validity is the time that indicates the end of DENM validity. It is used in the receiving ITS-S message table for keeping up-to-date DENM information. Its expiration time may be set to:the offset of the validityDuration starting from the detection Time, if the validityDuration is present in the received DENM; and/or the default offset of the validityDuration of 600 s starting from the detection Time, if the validityDuration is not present in the received DENM.

The DENBS 621 may maintain an (Rx) ITS-S message table with at least the following data for the receiving protocol operation: actionID: actionID value of the received DENMs until the T_R_Validity is expired; referenceTime: The value of the referenceTime refers to the most recent value of received DENMs of the same actionID; termination: The value of the termination refers to the most recent value of received DENMs of the same actionID; detection Time: The value of the detectionTime refers to the most recent value of received DENMs of the same actionID. In some examples, DENMs stored in the receiving ITS-S message table are indexed with actionID.

A DENM with a specific actionID may be stored in the receiving ITS-S message table as long as the timer T_R_Validity is not expired. When the timer T_R_Validity expires, all data related to the corresponding actionID (including the actionID entry) may be deleted from the receiving ITS-S message table.

At a point in time, any stored DENM in the receiving ITS-S message table may be associated with one of three states: ACTIVE state: Receiving ITS-S has not received the termination data from all received DENMs of the actionID; CANCELLED state: The termination value of DENM stored in the receiving ITS-S message table is 0; NEGATED state: The termination value of DENM stored in the receiving ITS-S message table is 1. The state of a DENM indicates the most updated status of received DENMs of the same actionID.

The receiving ITS-S message table may be updated upon the reception of a DENM, under the following conditions: the reference Time of a received DENM is greater than the latest value stored in the receiving message table; or the state of the DENM is changed due to a received DENM when the reference Time or detectionTime of a received DENM is equal or greater than the latest values stored in the receiving message table; or the DENM entry with the actionID is deleted when the timer T_R_Validity expires.

If a received DENM does not satisfy any of the above conditions, the received DENM is considered to be outdated and may be discarded by the receiving ITS-S. The receiving ITS-S message table is not updated with this received DENM.

3.2.1.3.2. General Protocol Operation

Upon reception of a DENM, the DENBS 621 may execute the following operations: (1) Decode DENM; Calculate expiration time for timer T_R_Validity (see e.g., [EN302637-3] § 8.4.1.5): (a) If expiration time is in the past, discard the received DENM and omit execution of further steps. (b) Otherwise, continue the operation. (2) Lookup entries in the receiving ITS-S message table with the received actionID: (a) If entry does not exist in the receiving ITS-S message table, check if termination data exists in the received DENM: (i) If yes, discard the received DENM and omit execution of further steps. (ii) Otherwise, check SSP and CauseCode if available: (ii.a) If SSP value is not consistent with causeCode in eventType, discard the received DENM and omit execution of further steps. (ii.b) Otherwise, create an entry in the receiving ITS-S message table with the received DENM and set the state to ACTIVE. (b) If entry does exist in the receiving ITS-S message table, check if the received reference Time is less than the entry reference Time, or the received detectionTime is less than the entry detectionTime: (i) If yes, discard the received DENM and omit execution of further steps. (ii) Otherwise, check if the received DENM is a repeated DENM of the entry, e.g., the received referenceTime equals to the entry referenceTime, the received detectionTime equals to the entry detectionTime, and the received termination value equals to the entry state: (ii.1) If yes, discard received DENM and omit execution of further steps. (ii.2) Otherwise, check SSP and CauseCode if available: (ii.2.a) If SSP value is not consistent with causeCode in eventType, discard the received DENM and omit execution of further steps. (ii.2.b) Otherwise, update the entry in receiving ITS-S message table, set entry state according to the termination value of the received DENM. (3) Start/restart T_R_Validity timer. (4) Inform ITS-S applications of the DENM entry and state if applicable. (5) End.

When the timer T_R_Validity expires, the DENBS 621 may execute the following operations: (1) Delete DENM entry from the receiving ITS-S message table. (2) Notify application if necessary (see e.g., [EN302637-3] § 5.4.1).

3.2.1.3.3. Exception Handling

The receiving ITS-S may apply the exception handling rules specified in [EN302637-3]. DENM decoding exception: If the received DENM cannot be decoded by the DENBS 621, the operation may stop, and the received DENMs may be discarded.

3.2.2. DENM Dissemination Constraints

Special data confidence constraints may apply to some data provided in the DENM, depending on the detection capabilities of the ITS-S, such as position accuracy constraint, time accuracy constraint and event detection quality constraint. These confidence constraints are presented in the data element and data frame definitions as specified in [EN302637-3] Annex A and in [TS102894-2]. According to the requirements of specific ITS-S application, data contained in a DENM may be obtained from different sources, e.g., from the in vehicle network or from ITS-S users via specific Human Machine Interface (HMI). Corresponding requirements are defined in ITS applications specifications, such as [TS101539-1], [TS101539-2], and [TS101539-3].

The security mechanisms for ITS consider the authentication of messages transferred between ITS-Ss with certificates. A certificate indicates its holder's permissions, e.g., what statements the holder is allowed to make or privileges it is allowed to assert in a message signed by that certificate. The format for the certificates is specified in ETSI TS 103 097. Permissions are indicated by a pair of identifiers within the certificate, the ITS-Application Identifier (ITS-AID) and the service specific permissions (SSP). The ITS-AID as given in ETSI TR 102 965 v2.1.1 (2021 November) (“[TR102965]”) indicates the overall type of permissions being granted. For example, there is an ITS-AID that indicates that the originating ITS-S is entitled to send DENMs.

The SSP is a field that indicates specific sets of permissions within the overall permissions indicated by the ITS-AID: for example, there may be an SSP value associated with the ITS-AID for DENM that indicates the originating ITS-S is entitled to send DENMs with a causeCode (defined in [EN302637-3] § 7.1.4) set. ITS-S provides SSP information in its certificate for all generated, signed DENMs. This applies to new DENM, update DENM, cancellation DENM, and negation DENM. A received signed DENM is accepted by the receiving ITS-S if the DENM is consistent with the ITS-AID and SSP in its certificate.

3.2.3. ITS-S Configurations and Arrangements

FIG. 7 depicts an example vehicle computing system 700. In this example, the vehicle computing system 700 includes a V-ITS-S 701 and Electronic Control Units (ECUs) 744. The V-ITS-S 701 includes a V-ITS-S gateway 711, an ITS-S host 712, and an ITS-S router 713. The V-ITS-S gateway 711 provides functionality to connect the components at the in-vehicle network (e.g., ECUs 744) to the ITS station-internal network. The interface to the in-vehicle components (e.g., ECUs 744) may be the same or similar as those discussed herein (see e.g., IX 1006 of FIG. 10) and/or may be a proprietary interface/interconnect. Access to components (e.g., ECUs 744) may be implementation specific. The ECUs 744 may be the same or similar to the driving control units (DCUs) 414 discussed previously w.r.t FIG. 4. The ITS station connects to ITS ad hoc networks via the ITS-S router 713.

FIG. 8 depicts an example personal computing system 800. The personal ITS sub-system 800 provides the app and communication functionality of ITSC in mobile devices, such as smartphones, tablet computers, wearable devices, PDAs, portable media players, laptops, and/or other mobile devices. The personal ITS sub-system 800 contains a personal ITS station (P-ITS-S) 801 and various other entities not included in the P-ITS-S 801, which are discussed in more detail infra. The device used as a personal ITS station may also perform HMI functionality as part of another ITS sub-system, connecting to the other ITS sub-system via the ITS station-internal is network (not shown). For purposes of the present disclosure, the personal ITS sub-system 800 may be used as a VRU ITS-S 410v.

FIG. 9 depicts an example roadside infrastructure system 900. In this example, the roadside infrastructure system 900 includes an R-ITS-S 901, output device(s) 905, sensor(s) 908, and one or more radio units (RUs) 910. The R-ITS-S 901 includes a R-ITS-S gateway 911, an ITS-S host 912, an ITS-S router 913, and an ITS-S border router 914. The ITS station connects to ITS ad hoc networks and/or ITS access networks via the ITS-S router 913. The R-ITS-S gateway 711 provides functionality to connect the components of the roadside system (e.g., output devices 905 and sensors 908) at the roadside network to the ITS station-internal network. The interface to the in-vehicle components (e.g., ECUs 744) may be the same or similar as those discussed herein (see e.g., IX 1006 of FIG. 10) and/or may be a proprietary interface/interconnect. Access to components (e.g., ECUs 744) may be implementation specific. The sensor(s) 908 may be inductive loops and/or sensors that are the same or similar to the sensors 412 discussed infra w.r.t FIG. 4 and/or sensor circuitry 1042 discussed infra w.r.t FIG. 10.

The actuators 913 are devices that are responsible for moving and controlling a mechanism or system. The actuators 913 are used to change the operational state (e.g., on/off, zoom or focus, and/or the like), position, and/or orientation of the sensors 908. The actuators 913 are used to change the operational state of some other roadside equipment, such as gates, traffic lights, digital signage or variable message signs (VMS), and/or the like The actuators 913 are configured to receive control signals from the R-ITS-S 901 via the roadside network, and convert the signal energy (or some other energy) into an electrical and/or mechanical motion. The control signals may be relatively low energy electric voltage or current. The actuators 913 comprise electromechanical relays and/or solid state relays, which are configured to switch electronic devices on/off and/or control motors, and/or may be that same or similar or actuators 1044 discussed infra w.r.t FIG. 10.

Each of FIGS. 7, 8, and 9 also show entities which operate at the same level but are not included in the ITS-S including the relevant HMI 706, 806, and 906; vehicle motion control 708 (only at the vehicle level); local device sensor system and IoT platform 705, 805, and 905; local device sensor fusion and actuator app 704, 804, and 904; local perception and trajectory prediction apps 702, 802, and 902; motion prediction 703 and 803, or mobile objects trajectory prediction 903 (at the RSU level); and connected system 707, 807, and 907.

The local device sensor system and IoT Platform 705, 805, and 905 collects and shares IoT data. The sensor system and IoT Platform 805 is at least composed of the PoTi management function present in each ITS-S of the system (see e.g., ETSI EN 302 890-2 (“[EN302890-2]”)). The PoTi entity provides the global time common to all system elements and the real time position of the mobile elements. Local sensors may also be embedded in other mobile elements as well as in the road infrastructure (e.g., camera in a smart traffic light, electronic signage, and/or the like). An IoT platform, which can be distributed over the system elements, may contribute to provide additional information related to the environment surrounding the device/system 700, 800, 900. The sensor system can include one or more cameras, radars, LiDARs, and/or other sensors (see e.g., sensors 1042 of FIG. 10), in a V-ITS-S 410 or R-ITS-S 430. In personal computing system 800 (or VRU 410v), the sensor system 805 may include gyroscope(s), accelerometer(s), and/or other sensors (see e.g., sensors 1042 of FIG. 10). In a central station (not shown), the sensor system includes sensors that may be located on the side of the road, but directly report their data to the central station, without the involvement of a V-ITS-S 410, an R-ITS-S 430, or VRU 410v.

The (local) sensor data fusion function and/or actuator apps 704, 804, and 904 provides the fusion of local perception data obtained from the VRU sensor system and/or different local sensors. This may include aggregating data flows issued by the sensor system and/or different local sensors. The local sensor fusion and actuator app(s) may contain machine learning (ML)/Artificial Intelligence (AI) algorithms and/or models. Sensor data fusion usually relies on the consistency of its inputs and then to their timestamping, which correspond to a common given time. Various ML/AI techniques can be used to carry out the sensor data fusion and/or may be used for other purposes, such as any of the AI/ML techniques and technologies discussed herein. Where the apps 704, 804, and 904 are (or include) AI/ML functions, the apps 704, 804, and 904 may include AI/ML models that have the ability to learn useful information from input data (e.g., context information, and/or the like) according to supervised learning, unsupervised learning, reinforcement learning (RL), and/or neural network(s) (NN). Separately trained AI/ML models can also be chained together in a AI/ML pipeline during inference or prediction generation.

The input data may include AI/ML training information and/or AI/ML model inference information. The training information includes the data of the ML model including the input (training) data plus labels for supervised training, hyperparameters, parameters, probability distribution data, and other information needed to train a particular AI/ML model. The model inference information is any information or data needed as input for the AI/ML model for inference generation (or making predictions). The data used by an AI/ML model for training and inference may largely overlap, however, these types of information refer to different concepts. The input data is called training data and has a known label or result.

Supervised learning is an ML task that aims to learn a mapping function from the input to the output, given a labeled data set. Examples of supervised learning include regression algorithms (e.g., Linear Regression, Logistic Regression,), and the like), instance-based algorithms (e.g., k-nearest neighbor, and the like), Decision Tree Algorithms (e.g., Classification And Regression Tree (CART), Iterative Dichotomiser 3 (ID3), C4.5, chi-square automatic interaction detection (CHAID), and/or the like), Fuzzy Decision Tree (FDT), and the like), Support Vector Machines (SVM), Bayesian Algorithms (e.g., Bayesian network (BN), a dynamic BN (DBN), Naive Bayes, and the like), and Ensemble Algorithms (e.g., Extreme Gradient Boosting, voting ensemble, bootstrap aggregating (“bagging”), Random Forest and the like). Supervised learning can be further grouped into Regression and Classification problems. Classification is about predicting a label whereas Regression is about predicting a quantity. For unsupervised learning, Input data is not labeled and does not have a known result. Unsupervised learning is an ML task that aims to learn a function to describe a hidden structure from unlabeled data. Some examples of unsupervised learning are K-means clustering and principal component analysis (PCA). Neural networks (NNs) are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like), Linear Dynamical System (LDS), Switching LDS (SLDS), Optical NNs (ONNs), an NN for reinforcement learning (RL) and/or deep RL (DRL), and/or the like. In RL, an agent aims to optimize a long-term objective by interacting with the environment based on a trial and error process. Examples of RL algorithms include Markov decision process, Markov chain, Q-learning, multi-armed bandit learning, and deep RL.

The (local) sensor data fusion function and/or actuator apps 704, 804, and 904 can use any suitable data fusion or data integration technique(s) to generate fused data, union data, and/or composite information. For example, the data fusion technique may be a direct fusion technique or an indirect fusion technique. Direct fusion combines data acquired directly from multiple sensors or other data sources, which may be the same or similar (e.g., all devices or sensors perform the same type of measurement) or different (e.g., different device or sensor types, historical data, and/or the like). Indirect fusion utilizes historical data and/or known properties of the environment and/or human inputs to produce a refined data set. Additionally or alternatively, the data fusion technique can include one or more fusion algorithms, such as a smoothing algorithm (e.g., estimating a value using multiple measurements in real-time or not in real-time), a filtering algorithm (e.g., estimating an entity's state with current and past measurements in real-time), and/or a prediction state estimation algorithm (e.g., analyzing historical data (e.g., geolocation, speed, direction, and signal measurements) in real-time to predict a state (e.g., a future signal strength/quality at a particular geolocation coordinate)). Additionally or alternatively, data fusion functions can be used to estimate various device/system parameters that are not provided by that device/system. As examples, the data fusion algorithm(s) 704, 804, and 904 may be or include one or more of a structured-based algorithm (e.g., tree-based (e.g., Minimum Spanning Tree (MST)), cluster-based, grid and/or centralized-based), a structure-free data fusion algorithm, a Kalman filter algorithm, a fuzzy-based data fusion algorithm, an Ant Colony Optimization (ACO) algorithm, a fault detection algorithm, a Dempster-Shafer (D-S) argumentation-based algorithm, a Gaussian Mixture Model algorithm, a triangulation based fusion algorithm, and/or any other like data fusion algorithm(s), or combinations thereof.

In one example, the ML/AI techniques are used for object tracking. The object tracking and/or computer vision techniques may include, for example, edge detection, corner detection, blob detection, a Kalman filter, Gaussian Mixture Model, Particle filter, Mean-shift based kernel tracking, an ML object detection technique (e.g., Viola-Jones object detection framework, scale-invariant feature transform (SIFT), histogram of oriented gradients (HOG), and/or the like), a deep learning object detection technique (e.g., fully convolutional neural network (FCNN), region proposal convolution neural network (R-CNN), single shot multibox detector, ‘you only look once’ (YOLO) algorithm, and/or the like), and/or the like.

In another example, the ML/AI techniques are used for motion detection based on the y sensor data obtained from the one or more sensors. Additionally or alternatively, the ML/AI techniques are used for object detection and/or classification. The object detection or recognition is models may include an enrollment phase and an evaluation phase. During the enrollment phase, one or more features are extracted from the sensor data (e.g., image or video data). A feature is an individual measurable property or characteristic. In the context of object detection, an object feature may include an object size, color, shape, relationship to other objects, and/or any region or portion of an image, such as edges, ridges, corners, blobs, and/or some defined regions of interest (ROI), and/or the like. The features used may be implementation specific, and may be based on, for example, the objects to be detected and the model(s) to be developed and/or used. The evaluation phase involves identifying or classifying objects by comparing obtained image data with existing object models created during the enrollment phase. During the evaluation phase, features extracted from the image data are compared to the object identification models using a suitable pattern recognition technique. The object models may be qualitative or functional descriptions, geometric surface information, and/or abstract feature vectors, and may be stored in a suitable database that is organized using some type of indexing scheme to facilitate elimination of unlikely object candidates from consideration.

Any suitable data fusion or data integration technique(s) may be used to generate the composite information. For example, the data fusion technique may be a direct fusion technique or an indirect fusion technique. Direct fusion combines data acquired directly from multiple vUEs or sensors, which may be the same or similar (e.g., all vUEs or sensors perform the same type of measurement) or different (e.g., different vUE or sensor types, historical data, and/or the like). Indirect fusion utilizes historical data and/or known properties of the environment and/or human inputs to produce a refined data set. Additionally, the data fusion technique may include one or more fusion algorithms, such as a smoothing algorithm (e.g., estimating a value using multiple measurements in real-time or not in real-time), a filtering algorithm (e.g., estimating an entity's state with current and past measurements in real-time), and/or a prediction state estimation algorithm (e.g., analyzing historical data (e.g., geolocation, speed, direction, and signal measurements) in real-time to predict a state (e.g., a future signal strength/quality at a particular geolocation coordinate)). As examples, the data fusion algorithm may be or include a structured-based algorithm (e.g., tree-based (e.g., Minimum Spanning Tree (MST)), cluster-based, grid and/or centralized-based), a structure-free data fusion algorithm, a Kalman filter algorithm and/or Extended Kalman Filtering, a fuzzy-based data fusion algorithm, an Ant Colony Optimization (ACO) algorithm, a fault detection algorithm, a Dempster-Shafer (D-S) argumentation-based algorithm, a Gaussian Mixture Model algorithm, a triangulation based fusion algorithm, and/or any other like data fusion algorithm

A local perception function (which may or may not include trajectory prediction app(s)) 702, 802, and 902 is provided by the local processing of information collected by local sensor(s) associated to the system element. The local perception (and trajectory prediction) function 702, 802, and 902 consumes the output of the sensor data fusion app/function 704, 804, and 904 and feeds ITS-S apps with the perception data (and/or trajectory predictions). The local perception (and trajectory prediction) function 702, 802, and 902 detects and characterize objects (static and mobile) which are likely to cross the trajectory of the considered moving objects. The infrastructure, and particularly the road infrastructure 900, may offer services relevant to the VRU support service. The infrastructure may have its own sensors detecting VRUs 416/410v evolutions and then computing a risk of collision if also detecting local vehicles' evolutions, either directly via its own sensors or remotely via a cooperative perception supporting services such as the CPS 521 (see e.g., [TR103562]). Additionally, road marking (e.g., zebra areas or crosswalks) and vertical signs may be considered to increase the confidence level associated with the VRU detection and mobility since VRUs 416/410v usually have to respect these marking/signs.

The motion dynamic prediction function 703 and 803, and the mobile objects trajectory prediction 903 (at the RSU level), are related to the behavior prediction of the considered moving objects. The motion dynamic prediction function 703 and 803 predict the trajectory of the vehicle 410 and the VRU 416, respectively. The motion dynamic prediction function 703 may be part of the VRU Trajectory and Behavioral Modeling module and trajectory interception module of the V-ITS-S 410. The motion dynamic prediction function 803 may be part of the dead reckoning module and/or the movement detection module of the VRU ITS-S 410v. Alternatively, the motion dynamic prediction functions 703 and 803 may provide motion/movement predictions to the aforementioned modules. Additionally or alternatively, the mobile objects trajectory prediction 903 predict respective trajectories of corresponding vehicles 410 and VRUs 416, which may be used to assist the vehicles 410 and/or VRU ITS-S 410v in performing dead reckoning and/or assist the V-ITS-S 410 with VRU Trajectory and Behavioral Modeling entity. Motion dynamic prediction includes a moving object trajectory resulting from evolution of the successive mobile positions. A change of the moving object trajectory or of the moving object velocity (acceleration/deceleration) impacts the motion dynamic prediction. In most cases, when VRUs 416/410v are moving, they still have a large amount of possible motion dynamics in terms of possible trajectories and velocities. This means that motion dynamic prediction 703, 803, 903 is used to identify which motion dynamic will be selected by the vehicles 410 and/or VRU 416 as quickly as possible, and if this selected motion dynamic is subject to a risk of collision with another VRU or a vehicle. The motion dynamic prediction functions 703, 803, 903 analyze the evolution of mobile objects and the potential trajectories that may meet at a given time to determine a risk of collision between them. The motion dynamic prediction works on the output of cooperative perception considering the current trajectories of considered device (e.g., VRU device 410v) for the computation of the path prediction; the current velocities and their past evolutions for the considered mobiles for the computation of the velocity evolution prediction; and the reliability level which can be associated to these variables. The output of this function is provided to a risk analysis function.

In many cases, working only on the output of the cooperative perception is not sufficient to make a reliable prediction because of the uncertainty which exists in terms of device/system trajectory selection and its velocity. However, complementary functions may assist in increasing consistently the reliability of the prediction. For example, the use of the device's navigation system, which provides assistance to the user to select the best trajectory for reaching its planned destination. With the development of Mobility as a Service (MaaS), multimodal itinerary computation may also indicate to the device or user dangerous areas and then assist to the motion dynamic prediction at the level of the multimodal itinerary provided by the system. In another example, the knowledge of the user habits and behaviors may be additionally or alternatively used to improve the consistency and the reliability of the motion predictions. Some users follow the same itineraries, using similar motion dynamics, for example when going to the main Point of Interest (POI), which is related to their main activities (e.g., going to school, going to work, doing some shopping, going to the nearest public transport station from their home, going to sport center, and/or the like). The device, system, or a remote service center may learn and memorize these habits. In another example, the indication by the user itself of its selected trajectory in particular when changing it (e.g., using a right turn or left turn signal similar to vehicles when indicating a change of direction).

The vehicle motion control 708 may be included for computer-assisted and/or automated vehicles 410. Both the HMI entity 706 and vehicle motion control entity 708 may be triggered by one or more ITS-S apps. The vehicle motion control entity 708 may be a function under the responsibility of a human driver or of the vehicle if it is able to drive in automated mode.

The Human Machine Interface (HMI) 706, 806, and 906, when present, enables the configuration of initial data (parameters) in the management entities (e.g., VRU profile management) and in other functions (e.g., VBS management). The HMI 706, 806, and 906 enables communication of external events related to the VBS to the device owner (user), including the alerting about an immediate risk of collision (TTC<2 s) detected by at least one element of the system and signaling a risk of collision (e.g., TTC>2 seconds) being detected by at least one element of the system. For a VRU system 410v (e.g., personal computing system 800), similar to a vehicle driver, the HMI provides the information to the VRU 416, considering its profile (e.g., for a blind person, the information is presented with a clear sound level using accessibility capabilities of the particular platform of the personal computing system 800). In various implementations, the HMI 706, 806, and 906 may be part of the alerting system.

The connected systems 707, 807, and 907 refer to components/devices used to connect a system with one or more other systems. As examples, the connected systems 707, 807, and 907 may include communication circuitry and/or radio units. The system 700, 800, 900 may be a connected system made of various/different levels of equipment (e.g., up to 4 levels). The system 700, 800, 900 may also be an information system which collects, in real time, information resulting from events, processes the collected information and stores them together with processed results. At each level of the system 700, 800, 900, the information collection, processing and storage is related to the functional and data distribution scenario which is implemented.

FIG. 10 illustrates an example of components that may be present in an compute node 1000 for implementing the techniques (e.g., operations, processes, methods, and methodologies) described herein. This compute node 1000 provides a closer view of the respective components of node 1000 when implemented as or as part of a computing device or system. The compute node 1000 can include any combination of the hardware or logical components referenced herein, and may include or couple with any device usable with a communication network or a combination of such networks. In particular, any combination of the components depicted by FIG. 10 can be implemented as individual ICs, discrete electronic devices, or other modules, instruction sets, programmable logic or algorithms, hardware, hardware accelerators, software, firmware, or a combination thereof adapted in the compute node 1000, or as components otherwise incorporated within a chassis of a larger system. Additionally or alternatively, any combination of the components depicted by FIG. 10 can be implemented as a system-on-chip (SoC), a single-board computer (SBC), a system-in-package (SiP), a multi-chip package (MCP), and/or the like, in which a combination of the hardware elements are formed into a single IC or a single package. Furthermore, the compute node 1000 may be or include a client device, server, appliance, network infrastructure, machine, robot, drone, and/or any other type of computing devices such as any of those discussed herein. For example, the compute node 1000 may correspond to any of the UEs 410, NAN 430, edge compute node 440, NFs in network 465, and/or application functions (AFs)/servers 490 of FIG. 4; ITS 500 of FIG. 5; vehicle computing system 700 of FIG. 7; personal computing system 800 of FIG. 8; roadside infrastructure 900 of FIG. 9; and/or any other computing device/system discussed herein.

The compute node 1000 includes one or more processors 1002 (also referred to as “processor circuitry 1002”). The processor circuitry 1002 includes circuitry capable of sequentially and/or automatically carrying out a sequence of arithmetic or logical operations, and recording, storing, and/or transferring digital data. Additionally or alternatively, the processor circuitry 1002 includes any device capable of executing or otherwise operating computer-executable instructions, such as program code, software modules, and/or functional processes. The processor circuitry 1002 includes various hardware elements or components such as, for example, a set of processor cores and one or more of on-chip or on-die memory or registers, cache and/or scratchpad memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. Some of these components, such as the on-chip or on-die memory or registers, cache and/or scratchpad memory, may be implemented using the same or similar devices as the memory circuitry 1010 discussed infra. The processor circuitry 1002 is also coupled with memory circuitry 1010 and storage circuitry 1020, and is configured to execute instructions stored in the memory/storage to enable various apps, OSs, or other software elements to run on the platform 1000. In particular, the processor circuitry 1002 is configured to operate app software (e.g., instructions 1001, 1011, 1021) to provide one or more services to a user of the compute node 1000 and/or user(s) of remote systems/devices.

As examples, the processor circuitry 1002 can be embodied as, or otherwise include one or multiple central processing units (CPUs), application processors, graphics processing units (GPUs), RISC processors, Acorn RISC Machine (ARM) processors, complex instruction set computer (CISC) processors, DSPs, FPGAs, programmable logic devices (PLDs), ASICs, baseband processors, radio-frequency integrated circuits (RFICs), microprocessors or controllers, multi-core processors, multithreaded processors, ultra-low voltage processors, embedded processors, a specialized x-processing units (xPUs) or a data processing unit (DPUs) (e.g., Infrastructure Processing Unit (IPU), network processing unit (NPU), and the like), and/or any other processing devices or elements, or any combination thereof. In some implementations, the processor circuitry 1002 is embodied as one or more special-purpose processor(s)/controller(s) configured (or configurable) to operate according to the various implementations and other aspects discussed herein. Additionally or alternatively, the processor circuitry 1002 includes one or more hardware accelerators (e.g., same or similar to acceleration circuitry 1050), which can include microprocessors, programmable processing devices (e.g., FPGAs, ASICs, PLDs, DSPs. and/or the like), and/or the like.

The system memory 1010 (also referred to as “memory circuitry 1010”) includes one or more hardware elements/devices for storing data and/or instructions 1011 (and/or instructions 1001, 1021). Any number of memory devices may be used to provide for a given amount of system memory 1010. As examples, the memory 1010 can be embodied as processor cache or scratchpad memory, volatile memory, non-volatile memory (NVM), and/or any other machine readable media for storing data. Examples of volatile memory include random access memory (RAM), static RAM (SRAM), dynamic RAM (DRAM), synchronous DRAM (SDRAM), thyristor RAM (T-RAM), content-addressable memory (CAM), and/or the like. Examples of NVM can include read-only memory (ROM) (e.g., including programmable ROM (PROM), erasable PROM (EPROM), electrically EPROM (EEPROM), flash memory (e.g., NAND flash memory, NOR flash memory, and the like), solid-state storage (SSS) or solid-state ROM, programmable metallization cell (PMC), and/or the like), non-volatile RAM (NVRAM), phase change memory (PCM) or phase change RAM (PRAM) (e.g., Intel® 3D XPoint™ memory, chalcogenide RAM (CRAM), Interfacial Phase-Change Memory (IPCM), and the like), memistor devices, resistive memory or resistive RAM (ReRAM) (e.g., memristor devices, metal oxide-based ReRAM, quantum dot resistive memory devices, and the like), conductive bridging RAM (or PMC), magnetoresistive RAM (MRAM), electrochemical RAM (ECRAM), ferroelectric RAM (FeRAM), anti-ferroelectric RAM (AFeRAM), ferroelectric field-effect transistor (FeFET) memory, and/or the like. Additionally or alternatively, the memory circuitry 1010 can include spintronic memory devices (e.g., domain wall memory (DWM), spin transfer torque (STT) memory (e.g., STT-RAM or STT-MRAM), magnetic tunneling junction memory devices, spin—orbit transfer memory devices, Spin—Hall memory devices, nanowire memory cells, and/or the like). In some implementations, the individual memory devices 1010 may be formed into any number of different package types, such as single die package (SDP), dual die package (DDP), quad die package (Q17P), memory modules (e.g., dual inline memory modules (DIMMs), microDIMMs, and/or MiniDIMMs), and/or the like. Additionally or alternatively, the memory circuitry 1010 is or includes block addressable memory device(s), such as those based on NAND or NOR flash memory technologies (e.g., single-level cell (“SLC”), multi-level cell (“MLC”), quad-level cell (“QLC”), tri-level cell (“TLC”), or some other NAND or NOR device). Additionally or alternatively, the memory circuitry 1010 can include resistor-based and/or transistor-less memory architectures. In some examples, the memory circuitry 1010 can refer to a die, chip, and/or a packaged memory product. In some implementations, the memory 1010 can be or include the on-die memory or registers associated with the processor circuitry 1002. Additionally or alternatively, the memory 1010 can include any of the devices/components discussed infra w.r.t the storage circuitry 1020.

The storage 1020 (also referred to as “storage circuitry 1020”) provides persistent storage of information, such as data, OSs, apps, instructions 1021, and/or other software elements. As examples, the storage 1020 may be embodied as a magnetic disk storage device, hard disk drive (HDD), microHDD, solid-state drive (SSD), optical storage device, flash memory devices, memory card (e.g., secure digital (SD) card, eXtreme Digital (XD) picture card, USB flash drives, SIM cards, and/or the like), and/or any combination thereof. The storage circuitry 1020 can also include specific storage units, such as storage devices and/or storage disks that include optical disks (e.g., DVDs, CDs/CD-ROM, Blu-ray disks, and the like), flash drives, floppy disks, hard drives, and/or any number of other hardware devices in which information is stored for any duration (e.g., for extended time periods, permanently, for brief instances, for temporarily buffering, and/or caching). Additionally or alternatively, the storage circuitry 1020 can include resistor-based and/or transistor-less memory architectures. Further, any number of technologies may be used for the storage 1020 in addition to, or instead of, the previously described technologies, such as, for example, resistance change memories, phase change memories, holographic memories, chemical memories, among many others. Additionally or alternatively, the storage circuitry 1020 can include any of the devices or components discussed previously w.r.t the memory 1010.

Computer program code for carrying out operations of the present disclosure (e.g., computational logic and/or instructions 1001, 1011, 1021) may be written in any combination of one or more programming languages, including object oriented programming languages, procedural programming languages, scripting languages, markup languages, and/or some other suitable programming languages including proprietary programming languages and/or development tools, or any other languages tools. The computer program/code 1001, 1011, 1021 for carrying out operations of the present disclosure may also be written in any combination of programming languages and/or machine language, such as any of those discussed herein. The program code may execute entirely on the system 1000, partly on the system 1000, as a standalone software package, partly on the system 1000 and partly on a remote computer or entirely on the remote computer or server. In the latter scenario, the remote computer may be connected to the system 1000 through any type of network, including a LAN or WAN, or the connection may be made to an external computer (e.g., through the Internet, enterprise network, and/or some other network). Additionally or alternatively, the computer program/code 1001, 1011, 1021 can include one or more operating systems (OS) and/or other software to control various aspects of the compute node 1000. The OS can include drivers to control particular devices that are embedded in the compute node 1000, attached to the compute node 1000, and/or otherwise communicatively coupled with the compute node 1000. Example OSs include consumer-based OS, real-time OS (RTOS), hypervisors, and/or the like.

The storage 1020 may include instructions 1021 in the form of software, firmware, or hardware commands to implement the techniques described herein. Although such instructions 1021 are shown as code blocks included in the memory 1010 and/or storage 1020, any of the code blocks may be replaced with hardwired circuits, for example, built into an ASIC, FPGA memory blocks/cells, and/or the like. In an example, the instructions 1001, 1011, 1021 provided via the memory 1010, the storage 1020, and/or the processor 1002 are embodied as a non-transitory or transitory machine-readable medium (also referred to as “computer readable medium” or “CRM”) including code (e.g., instructions 1001, 1011, 1021, accessible over the IX 1006, to direct the processor 1002 to perform various operations and/or tasks, such as a specific sequence or flow of actions as described herein and/or depicted in any of the accompanying drawings. The CRM may be embodied as any of the devices/technologies described for the memory 1010 and/or storage 1020.

The various components of the computing node 1000 communicate with one another over an interconnect (IX) 1006. The IX 1006 may include any number of IX (or similar) technologies including, for example, instruction set architecture (ISA), extended ISA (eISA), Inter-Integrated Circuit (I²C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX, RapidIO™ IX, Coherent Accelerator Processor Interface (CAPI), OpenCAPI, Advanced Microcontroller Bus Architecture (AMBA) IX, cache coherent interconnect for accelerators (CCIX), Gen-Z Consortium IXs, a HyperTransport IX, NVLink provided by NVIDIA®, ARM Advanced eXtensible Interface (AXI), a Time-Trigger Protocol (TTP) system, a FlexRay system, PROFIBUS, Ethernet, USB, On-Chip System Fabric (IOSF), Infinity Fabric (IF), and/or any number of other IX technologies. The IX 1006 may be a proprietary bus, for example, used in a SoC based system.

The communication circuitry 1060 comprises a set of hardware elements that enables the compute node 1000 to communicate over one or more networks (e.g., cloud 1065) and/or with other devices 1090. Communication circuitry 1060 includes various hardware elements, such as, for example, switches, filters, amplifiers, antenna elements, and the like to facilitate over-the-air (OTA) communications. Communication circuitry 1060 includes modem circuitry 1061 that interfaces with processor circuitry 1002 for generation and processing of baseband signals and for controlling operations of transceivers (TRx) 1062, 1063. The modem circuitry 1061 handles various radio control functions according to one or more communication protocols and/or RATs, such as any of those discussed herein. The modem circuitry 1061 includes baseband processors or control logic to process baseband signals received from a receive signal path of the TRxs 1062, 1063, and to generate baseband signals to be provided to the TRxs 1062, 1063 via a transmit signal path.

The TRxs 1062, 1063 include hardware elements for transmitting and receiving radio waves according to any number of frequencies and/or communication protocols, such as any of those discussed herein. The TRxs 1062, 1063 can include transmitters (Tx) and receivers (Rx) as separate or discrete electronic devices, or single electronic devices with Tx and Rx functionally. In either implementation, the TRxs 1062, 1063 may be configured to communicate over different networks or otherwise be used for different purposes. In one example, the TRx 1062 is configured to communicate using a first RAT (e.g., W-V2X and/or [IEEE802] RATs, such as [IEEE80211], [IEEE802154], [WiMAX], IEEE 802.11bd, ETSI ITS-G5, and/or the like) and TRx 1063 is configured to communicate using a second RAT (e.g., 3GPP RATs such as 3GPP LTE or NR/5G including C-V2X). In another example, the TRxs 1062, 1063 may be configured to communicate over different frequencies or ranges, such as the TRx 1062 being configured to communicate over a relatively short distance (e.g., devices 1090 within about 10 meters using a local Bluetooth®, devices 1090 within about 50 meters using ZigBee®, and/or the like), and TRx 1062 being configured to communicate over a relatively long distance (e.g., using [IEEE802], [WiMAX], and/or 3GPP RATs). The same or different communications techniques may take place over a single TRx at different power levels or may take place over separate TRxs.

A network interface circuitry 1030 (also referred to as “network interface controller 1030” or “NIC 1030”) provides wired communication to nodes of the cloud 1065 and/or to connected devices 1090. The wired communications may be provided according to Ethernet (e.g., [IEEE802.3]) or may be based on other types of networks, such as Controller Area Network (CAN), Local Interconnect Network (LIN), DeviceNet, ControlNet, Data Highway+, or PROFINET, among many others. As examples, the NIC 1030 may be embodied as a SmartNIC and/or one or more intelligent fabric processors (IFPs). One or more additional NICs 1030 may be included to enable connecting to additional networks. For example, a first NIC 1030 can provide communications to the cloud 1065 over an Ethernet network (e.g., [IEEE802.3]), a second NIC 1030 can provide communications to connected devices 1090 over an optical network (e.g., optical transport network (OTN), Synchronous optical networking (SONET), and synchronous digital hierarchy (SDH)), and so forth.

Given the variety of types of applicable communications from the compute node 1000 to another component, device 1090, and/or network 1065, applicable communications circuitry used by the compute node 1000 may include or be embodied by any combination of components 1030, 1040, 1050, or 1060. Accordingly, applicable means for communicating (e.g., receiving, transmitting, broadcasting, and so forth) may be embodied by such circuitry.

The acceleration circuitry 1050 (also referred to as “accelerator circuitry 1050”) includes any suitable hardware device or collection of hardware elements that are designed to perform one or more specific functions more efficiently in comparison to general-purpose processing elements. The acceleration circuitry 1050 can include various hardware elements such as, for example, one or more GPUs, FPGAs, DSPs, SoCs (including programmable SoCs and multi-processor SoCs), ASICs (including programmable ASICs), PLDs (including complex PLDs (CPLDs) and high capacity PLDs (HCPLDs), xPUs (e.g., DPUs, IPUs, and NPUs) and/or other forms of specialized circuitry designed to accomplish specialized tasks. Additionally or alternatively, the acceleration circuitry 1050 may be embodied as, or include, one or more of artificial intelligence (AI) accelerators (e.g., vision processing unit (VPU), neural compute sticks, neuromorphic hardware, deep learning processors (DLPs) or deep learning accelerators, tensor processing units (TPUs), physical neural network hardware, and/or the like), cryptographic accelerators (or secure cryptoprocessors), network processors, I/O accelerator (e.g., DMA engines and the like), and/or any other specialized hardware device/component. The offloaded tasks performed by the acceleration circuitry 1050 can include, for example, AI/ML, tasks (e.g., training, feature extraction, model execution for inference/prediction, classification, and so forth), visual data processing, graphics processing, digital and/or analog signal processing, network data processing, infrastructure function management, object detection, rule analysis, and/or the like.

The TEE 1070 operates as a protected area accessible to the processor circuitry 1002 and/or other components to enable secure access to data and secure execution of instructions. In some implementations, the TEE 1070 may be a physical hardware device that is separate from other components of the system 1000 such as a secure-embedded controller, a dedicated SoC, a trusted platform module (TPM), a tamper-resistant chipset or microcontroller with embedded processing devices and memory devices, and/or the like. Additionally or alternatively, the TEE 1070 is implemented as secure enclaves (or “enclaves”), which are isolated regions of code and/or data within the processor and/or memory/storage circuitry of the compute node 1000, where only code executed within a secure enclave may access data within the same secure enclave, and the secure enclave may only be accessible using the secure app (which may be implemented by an app processor or a tamper-resistant microcontroller). In some implementations, the memory circuitry 1004 and/or storage circuitry 1008 may be divided into one or more trusted memory regions for storing apps or software modules of the TEE 1070. Additionally or alternatively, the processor circuitry 1002, acceleration circuitry 1050, memory circuitry 1010, and/or storage circuitry 1020 may be divided into, or otherwise separated into virtualized environments using a suitable virtualization technology, such as, for example, virtual machines (VMs), virtualization containers, and/or the like. These virtualization technologies may be managed and/or controlled by a virtual machine monitor (VMM), hypervisor container engines, orchestrators, and the like. Such virtualization technologies provide execution environments in which one or more apps and/or other software, code, or scripts may execute while being isolated from one or more other apps, software, code, or scripts.

The input/output (I/O) interface circuitry 1040 (also referred to as “interface circuitry 1040”) is used to connect additional devices or subsystems. The interface circuitry 1040, is part of, or includes circuitry that enables the exchange of information between two or more components or devices such as, for example, between the compute node 1000 and various additional/external devices (e.g., sensor circuitry 1042, actuator circuitry 1044, and/or positioning circuitry 1043). Access to various such devices/components may be implementation specific, and may vary from implementation to implementation. At least in some examples, the interface circuitry 1040 includes one or more hardware interfaces such as, for example, buses, input/output (I/O) interfaces, peripheral component interfaces, network interface cards, and/or the like. Additionally or alternatively, the interface circuitry 1040 includes a sensor hub or other like elements to obtain and process collected sensor data and/or actuator data before being passed to other components of the compute node 1000.

The sensor circuitry 1042 includes devices, modules, or subsystems whose purpose is to detect events or changes in its environment and send the information (sensor data) about the detected events to some other a device, module, subsystem, and the like. In some implementations, the sensor(s) 1042 are the same or similar as the sensors 412 of FIG. 4. Individual sensors 1042 may be exteroceptive sensors (e.g., sensors that capture and/or measure environmental phenomena and/external states), proprioceptive sensors (e.g., sensors that capture and/or measure internal states of the compute node 1000 and/or individual components of the compute node 1000), and/or exproprioceptive sensors (e.g., sensors that capture, measure, or correlate internal states and external states). Examples of such sensors 1042 include inertia measurement units (IMU), microelectromechanical systems (MEMS) or nanoelectromechanical systems (NEMS), level sensors, flow sensors, temperature sensors (e.g., thermistors, including sensors for measuring the temperature of internal components and sensors for measuring temperature external to the compute node 1000), pressure sensors, barometric pressure sensors, gravimeters, altimeters, image capture devices (e.g., visible light cameras, thermographic camera and/or thermal imaging camera (TIC) systems, forward-looking infrared (FLIR) camera systems, radiometric thermal camera systems, active infrared (IR) camera systems, ultraviolet (UV) camera systems, and/or the like), light detection and ranging (LiDAR) sensors, proximity sensors (e.g., IR radiation detector and the like), depth sensors, ambient light sensors, optical light sensors, ultrasonic transceivers, microphones, inductive loops, and/or the like. The IMUs, MEMS, and/or NEMS can include, for example, one or more 3-axis accelerometers, one or more 3-axis gyroscopes, one or more magnetometers, one or more compasses, one or more barometers, and/or the like.

Additional or alternative examples of the sensor circuitry 1042 used for various aerial asset and/or vehicle control systems can include one or more of exhaust sensors including exhaust oxygen sensors to obtain oxygen data and manifold absolute pressure (MAP) sensors to obtain manifold pressure data; mass air flow (MAF) sensors to obtain intake air flow data; intake air temperature (IAT) sensors to obtain IAT data; ambient air temperature (AAT) sensors to obtain AAT data; ambient air pressure (AAP) sensors to obtain AAP data; catalytic converter sensors including catalytic converter temperature (CCT) to obtain CCT data and catalytic converter oxygen (CCO) sensors to obtain CCO data; vehicle speed sensors (VSS) to obtain VSS data; exhaust gas recirculation (EGR) sensors including EGR pressure sensors to obtain ERG pressure data and EGR position sensors to obtain position/orientation data of an EGR valve pintle; Throttle Position Sensor (TPS) to obtain throttle position/orientation/angle data; a crank/cam position sensors to obtain crank/cam/piston position/orientation/angle data; coolant temperature sensors; pedal position sensors; accelerometers; altimeters; magnetometers; level sensors; flow/fluid sensors, barometric pressure sensors, vibration sensors (e.g., shock & vibration sensors, motion vibration sensors, main and tail rotor vibration monitoring and balancing (RTB) sensor(s), gearbox and drive shafts vibration monitoring sensor(s), bearings vibration monitoring sensor(s), oil cooler shaft vibration monitoring sensor(s), engine vibration sensor(s) to monitor engine vibrations during steady-state and transient phases, and/or the like), force and/or load sensors, remote charge converters (RCC), rotor speed and position sensor(s), fiber optic gyro (FOG) inertial sensors, Attitude & Heading Reference Unit (AHRU), fibre Bragg grating (FBG) sensors and interrogators, tachometers, engine temperature gauges, pressure gauges, transformer sensors, airspeed-measurement meters, vertical speed indicators, and/or the like.

The actuators 1044 allow compute node 1000 to change its state, position, and/or orientation, or move or control a mechanism or system. The actuators 1044 comprise electrical and/or mechanical devices for moving or controlling a mechanism or system, and converts energy (e.g., electric current or moving air and/or liquid) into some kind of motion. Additionally or alternatively, the actuators 1044 can include electronic controllers linked or otherwise connected to one or more mechanical devices and/or other actuation devices. As examples, the actuators 1044 can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors, servos, clutches, rotors, and the like), projectile actuators/mechanisms (e.g., mechanisms that shoot or propel objects or elements), payload actuators, audible sound generators (e.g., speakers and the like), LEDs and/or visual warning devices, and/or other like electromechanical components. Additionally or alternatively, the actuators 1044 can include virtual instrumentation and/or virtualized actuator devices.

Additionally or alternatively, the interface circuitry 1040 and/or the actuators 1044 can include various individual controllers and/or controllers belonging to one or more components of the compute node 1000 such as, for example, host controllers, cooling element controllers, baseboard management controller (BMC), platform controller hub (PCH), uncore components (e.g., shared last level cache (LLC) cache, caching agent (Cbo), integrated memory controller (IMC), home agent (HA), power control unit (PCU), configuration agent (Ubox), integrated I/O controller (110), and interconnect (IX) link interfaces and/or controllers), and/or any other components such as any of those discussed herein. The compute node 1000 may be configured to operate one or more actuators 1044 based on one or more captured events, instructions, control signals, and/or configurations received from a service provider, client device, and/or other components of the compute node 1000. Additionally or alternatively, the actuators 1044 can include mechanisms that are used to change the operational state (e.g., on/off, zoom or focus, and/or the like), position, and/or orientation of one or more sensors 1042.

In some implementations, such as when the compute node 1000 is part of a vehicle system (e.g., V-ITS-S 410 of FIG. 4), the actuators 1044 correspond to the driving control units (DCUs) 414 discussed previously w.r.t FIG. 4. In some implementations, such as when the compute node 1000 is part of roadside equipment (e.g., R-ITS-S 430 of FIG. 4), the actuators 1044 can be used to change the operational state of the roadside equipment or other roadside equipment, such as gates, traffic lights, digital signage or variable message signs (VMS), and/or the like. The actuators 1044 are configured to receive control signals from the R-ITS-S 430 via a roadside network, and convert the signal energy (or some other energy) into an electrical and/or mechanical motion. The control signals may be relatively low energy electric voltage or current.

The positioning circuitry (pos) 1043 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), and the like), or the like. The positioning circuitry 1045 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 1045 may include a Micro-Technology for Positioning, Navigation, and Timing (Micro-PNT) IC that uses a master timing clock to perform position tracking/estimation without GNSS assistance. The positioning circuitry 1045 may also be part of, or interact with, the communication circuitry 1060 to communicate with the nodes and components of the positioning network. The positioning circuitry 1045 may also provide position data and/or time data to the application circuitry (e.g., processor circuitry 1002), which may use the data to synchronize operations with various infrastructure (e.g., radio base stations), for turn-by-turn navigation, or the like. In some implementations, the positioning circuitry 1045 is, or includes an INS, which is a system or device that uses sensor circuitry 1042 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 1000 without the need for external references.

In some examples, various I/O devices may be present within or connected to, the compute node 1000, which are referred to as input circuitry 1046 and output circuitry 1045. The input circuitry 1046 and output circuitry 1045 include one or more user interfaces designed to enable user interaction with the platform 1000 and/or peripheral component interfaces designed to enable peripheral component interaction with the platform 1000. The input circuitry 1046 and/or output circuitry 1045 may be, or may be part of a Human Machine Interface (HMI), such as HMI 706, 806, 906. Input circuitry 1046 includes any physical or virtual means for accepting an input including buttons, switches, dials, sliders, keyboard, keypad, mouse, touchpad, touchscreen, microphone, scanner, headset, and/or the like. The output circuitry 1045 may be included to show information or otherwise convey information, such as sensor readings, actuator position(s), or other like information. Data and/or graphics may be displayed on one or more user interface components of the output circuitry 1045. Output circuitry 1045 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, and the like), with the output of characters, graphics, multimedia objects, and the like being generated or produced from the operation of the compute node 1000. The output circuitry 1045 may also include speakers or other audio emitting devices, printer(s), and/or the like. Additionally or alternatively, the sensor circuitry 1042 may be used as the input circuitry 1045 (e.g., an image capture device, motion capture device, or the like) and one or more actuators 1044 may be used as the output device circuitry 1045 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1080 can be used to power the compute node 1000, although, in examples in which the compute node 1000 is mounted in a fixed location, it may have a power supply coupled to an electrical grid, or the battery 1080 may be used as a backup power source. As examples, the battery 1080 can be a lithium ion battery or a metal-air battery (e.g., zinc-air battery, aluminum-air battery, lithium-air battery, and the like). Other battery technologies may be used in other implementations.

A battery monitor/charger 1082 may be included in the compute node 1000 to track the state of charge (SoCh) of the battery 1080, if included. The battery monitor/charger 1082 may be used to monitor other parameters of the battery 1080 to provide failure predictions, such as the state of health (SoH) and the state of function (SoF) of the battery 1080. The battery monitor/charger 1082 may include a battery monitoring IC. The battery monitor/charger 1082 may communicate the information on the battery 1080 to the processor 1002 over the IX 1006. The battery monitor/charger 1082 may also include an analog-to-digital (ADC) converter that enables the processor 1002 to directly monitor the voltage of the battery 1080 or the current flow from the battery 1080. The battery parameters may be used to determine actions that the compute node 1000 may perform, such as transmission frequency, mesh network operation, sensing frequency, and the like. A power block 1085, or other power supply coupled to a grid, may be coupled with the battery monitor/charger 1082 to charge the battery 1080. In some examples, the power block 1085 may be replaced with a wireless power receiver to obtain the power wirelessly, for example, through a loop antenna in the compute node 1000. A wireless battery charging circuit may be included in the battery monitor/charger 1082. The specific charging circuits may be selected based on the size of the battery 1080, and thus, the current required. The charging may be performed according to Airfuel Alliance standards, the Qi wireless charging standard, the Rezence charging standard, among others.

The example of FIG. 10 is intended to depict a high-level view of components of a varying device, subsystem, or arrangement of a computing node 1000. However, in other implementations, some of the components shown may be omitted, additional components may be present, and a different arrangement of the components shown may occur in other implementations. Further, these arrangements are usable in a variety of use cases and environments, including those discussed herein.

### 4. Artificial Intelligence and Machine Learning Aspects

Machine learning (ML) involves programming computing systems to optimize a performance criterion using example (training) data and/or past experience. ML refers to the use and development of computer systems that are able to learn and adapt without following explicit instructions, by using algorithms and/or statistical models to analyze and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply is “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model,” these terms may be used interchangeably for the purposes of the present disclosure. Any of the ML techniques discussed herein may be utilized, in whole or in part, and variants and/or combinations thereof, for any of the example embodiments discussed herein.

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used.

ML algorithms accept model parameters (or simply “parameters”) and/or hyperparameters that can be used to control certain properties of the training process and the resulting model. Model parameters are parameters, values, characteristics, configuration variables, and/or properties that are learnt during training. Model parameters are usually required by a model when making predictions, and their values define the skill of the model on a particular problem. Hyperparameters at least in some examples are characteristics, properties, and/or parameters for an ML process that cannot be learnt during a training process. Hyperparameter are usually set before training takes place, and may be used in processes to help estimate model parameters.

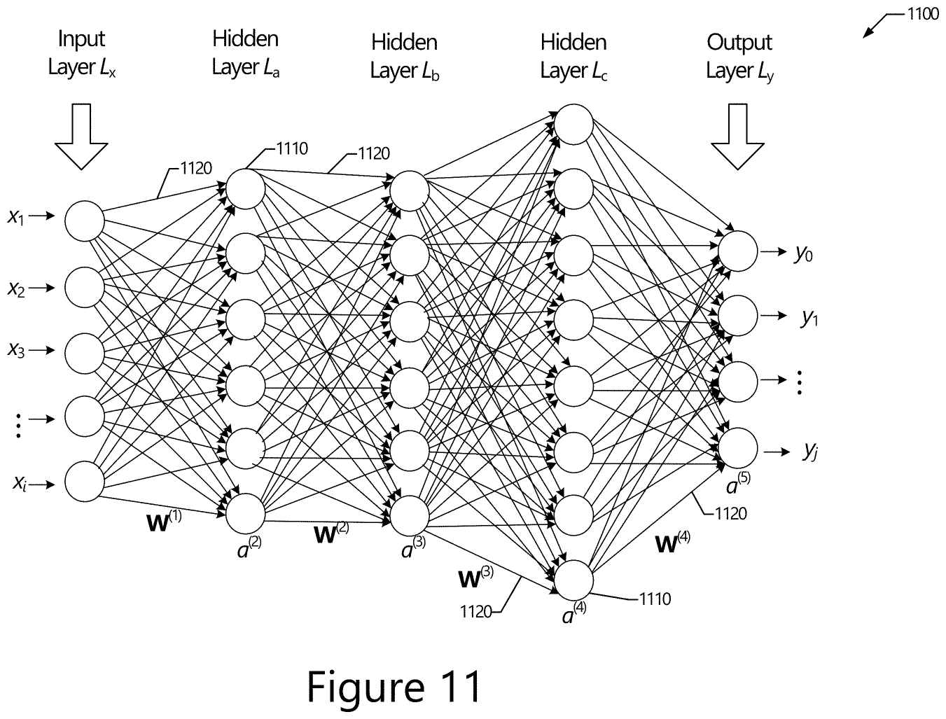

ML techniques generally fall into the following main types of learning problem categories: supervised learning, unsupervised learning, and reinforcement learning. Supervised learning involves building models from a set of data that contains both the inputs and the desired outputs. Unsupervised learning is an ML task that aims to learn a function to describe a hidden structure from unlabeled data. Unsupervised learning involves building models from a set of data that contains only inputs and no desired output labels. Reinforcement learning (RL) is a goal-oriented learning technique where an RL agent aims to optimize a long-term objective by interacting with an environment. Some implementations of AI and ML use data and neural networks (NNs) in a way that mimics the working of a biological brain. An example of such an implementation is shown by FIG. 11.

FIG. 11 illustrates an example NN 1100, which may be suitable for use by one or more of the computing systems (or subsystems) of the various implementations discussed herein, implemented in part by a HW accelerator, and/or the like. The NN 1100 may be deep neural network (DNN) used as an artificial brain of a compute node or network of compute nodes to handle very large and complicated observation spaces. Additionally or alternatively, the NN 1100 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an attention network, a self-attention network, an NN for reinforcement learning (RL) and/or deep RL (DRL), and/or the like. NNs are usually used for supervised learning, but can be used for unsupervised learning and/or RL. Additionally or alternatively, the NN 1100 can be used to solve one or more objective functions and/or optimization problems.

The NN 1100 may encompass a variety of ML techniques where a collection of connected artificial neurons 1110 that (loosely) model neurons in a biological brain that transmit signals to other neurons/nodes 1110. The neurons 1110 may also be referred to as nodes 1110, processing elements (PEs) 1110, or the like. The connections 1120 (or edges 1120) between the nodes 1110 are (loosely) modeled on synapses of a biological brain and convey the signals between nodes 1110. Note that not all neurons 1110 and edges 1120 are labeled in FIG. 11 for the sake of clarity.

Each neuron 1110 has one or more inputs and produces an output, which can be sent to one or more other neurons 1110 (the inputs and outputs may be referred to as “signals”). Inputs to the neurons 1110 of the input layer Lₓ can be feature values of a sample of external data (e.g., input variables xᵢ). The input variables xᵢ can be set as a vector containing relevant data (e.g., observations, ML features, and the like). The inputs to hidden units 1110 of the hidden layers Lₐ, L_{b}, and L_{c} may be based on the outputs of other neurons 1110. The outputs of the final output neurons 1110 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like).

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 1110 may have a threshold such that a signal is sent only if the aggregate signal crosses that threshold. A node 1110 may include an activation function, which defines the output of that node 1110 given an input or set of inputs. Additionally or alternatively, a node 1110 may include a propagation function that computes the input to a neuron 1110 from the outputs of its predecessor neurons 1110 and their connections 1120 as a weighted sum. A bias term can also be added to the result of the propagation function.

The NN 1100 also includes connections 1120, some of which provide the output of at least one neuron 1110 as an input to at least another neuron 1110. Each connection 1120 may be assigned a weight that represents its relative importance. The weights may also be adjusted as learning proceeds. The weight increases or decreases the strength of the signal at a connection 1120.

The neurons 1110 can be aggregated or grouped into one or more layers L where different layers L may perform different transformations on their inputs. In FIG. 11, the NN 1100 comprises an input layer Lₓ, one or more hidden layers Lₐ, L_{b}, and L_{c}, and an output layer L_{y} (where a, b, c, x, and y may be numbers), where each layer L comprises one or more neurons 1110. Signals travel from the first layer (e.g., the input layer L₁), to the last layer (e.g., the output layer L_{y}), possibly after traversing the hidden layers Lₐ, L_{b}, and L_{c} multiple times. In FIG. 11, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of FIG. 11, for simplicity of illustration, there are only three hidden layers Lₐ, L_{b}, and L_{c} in the NN 1100, however, the NN 1100 may include many more (or fewer) hidden layers Lₐ, L_{b}, and L_{c} than are shown.

In some example implementations, the inputs xᵢ include sensor data (e.g., raw sensor data) from 1 to n sensors (where n is a number) (e.g., sensors 705, 805, 905, and/or 1042 discussed previously) is processed as part of a low-level data management entity, and the outputs yⱼ include a set of perceived/tracked object candidates. The relevant facility (e.g., DENBS 621, CPS, VBS and/or the like) then selects object candidates to be transmitted as part of an ITS message (e.g., DENM 200, CPM, VAM, CAM, and/or the like). In another example implementation, the relevant facility selects object candidates to be transmitted as part of the ITS message from a high-level fused object list, thereby abstracting the original sensor measurement (e.g., raw sensor data) used in the fusion process. In either example implementation, the relevant facility selects object candidates according to ETSI TR 103 562 V2.1.1 (2019 December) (“[TR103562]”) § 4.3, [TS103324] § 6, [TR103300-1], [TS103300-2], [TS103300-3], [EN302637-3], [TR103832], and/or the like, and the ITS message provides data fields to indicate the source of the object. In either example implementation, the sensor data is also provided to a data fusion function for high-level object fusion, and the fused data is then provided to one or more ADAS applications and/or other facilities. In some examples, the data fusion function can be an NN with a same or similar arrangement as NN 1100, and/or can be any other type of AI/ML model, such as any of those discussed herein

Raw sensor data refers to low-level data generated by a local perception sensor that is mounted to, or otherwise accessible by, an ITS-S. This data is specific to a sensor type (e.g., reflexions, time of flight, point clouds, camera image, audio signals, and/or the like). In the context of environment perception, this data is usually analyzed and subjected to sensor-specific analysis processes to detect and compute a mathematical representation for a detected object from the raw sensor data. The ITS-S sensor may provide raw sensor data as a result of their measurements, which is then used by a sensor specific low-level object fusion system (e.g., sensor hub, dedicated is processor(s), AI/ML model, and/or the like) to provide a list of objects as detected by the measurement of the sensor(s). The detection mechanisms and data processing capabilities are specific to each sensor and/or hardware configurations. This means that the definition and mathematical representation of an object (e.g., a state space representation) can vary. Depending on the sensor type, a state space representation may comprise multiple dimensions (e.g., relative distance components of the feature to the sensor, speed of the feature, geometric dimensions, sound waves and/or doppler effect, and/or the like). A state space representation is generated for each detected object of a particular measurement. In some examples, a suitable NN 1100 (e.g., a CNN, RNN, and/or the like) can be used to generate the state space representation. Depending on the sensor type, measurements are performed cyclically, periodically, and/or based on some defined trigger condition or event After each measurement, the computed state space of each detected object is provided in an object list that is specific to the timestamp of the measurement.

The object (data) fusion system maintains one or more lists of objects that are currently perceived by the ITS-S. The object fusion mechanism performs prediction of each object to timestamps at which no measurement is available from sensors; associates objects from other potential sensors mounted to the station or received from other ITS-Ss with objects in the tracking list; and merges the prediction and an updated measurement for an object. At each point in time, the data fusion mechanism is able to provide an updated object list based on consecutive measurements from (possibly) multiple sensors containing the state spaces for all tracked objects. V2X information (e.g., CAMs, CPMs, DENMs 200 (including alacarte container 202), and/or the like) from other ITS-Ss may additionally be fused with locally perceived information. Other approaches additionally provide alternative representations of the processed sensor data, such as an occupancy grid.

The data fusion mechanism also performs various housekeeping tasks such as, for example, adding state spaces to the list of objects currently perceived by an ITS-S in case a new object is detected by a sensor; updating objects that are already tracked by the data fusion system with new measurements that should be associated to an already tracked object; and removing objects from the list of tracked objects in case new measurements should not be associated to already tracked objects. Depending on the capabilities of the fusion system, objects can also be classified (e.g., some sensor systems may be able to classify a detected object as a particular road user, while others are merely able to provide a distance measurement to an object within the perception range). These tasks of object fusion may be performed either by an individual sensor, or by a high-level data fusion system or process.

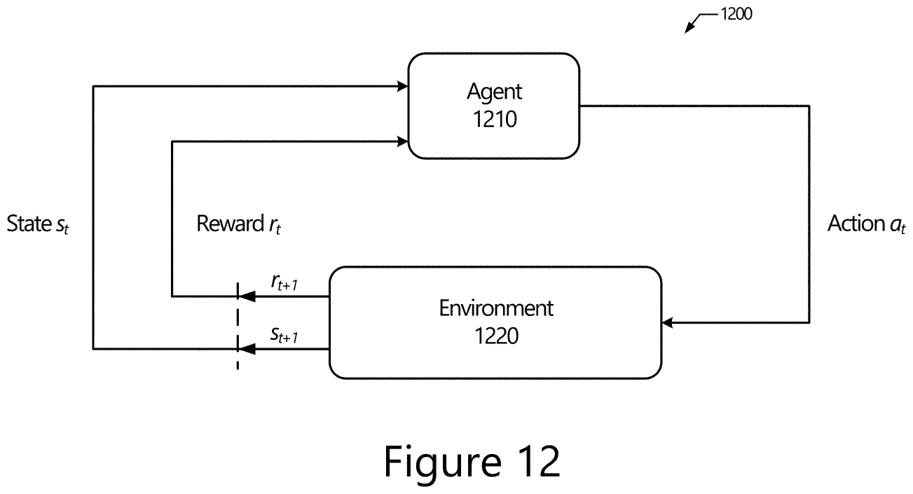

FIG. 12 shows an RL architecture 1200 comprising an agent 1210 and an environment 1220. The agent 1210 (e.g., software agent or AI agent) is the learner and decision maker, and the environment 1220 comprises everything outside the agent 1210 that the agent 1210 interacts with. The environment 1220 is typically stated in the form of a Markov decision process (MDP), which may be described using dynamic programming techniques. An MDP is a discrete-time stochastic control process that provides a mathematical framework for modeling decision making in situations where outcomes are partly random and partly under the control of a decision maker.

RL is a goal-oriented learning based on interaction with environment. RL is an ML paradigm concerned with how software agents (or AI agents) ought to take actions in an environment in order to maximize a numerical reward signal. In general, RL involves an agent taking actions in an environment that is/are interpreted into a reward and a representation of a state, which is then fed back into the agent. In RL, an agent aims to optimize a long-term objective by interacting with the environment based on a trial and error process. In many RL algorithms, the agent receives a reward in the next time step (or epoch) to evaluate its previous action. Examples of RL algorithms include Markov decision process (MDP) and Markov chains, associative RL, inverse RL, safe RL, Q-learning, multi-armed bandit learning, and deep RL.

The agent 1210 and environment 1220 continually interact with one another, wherein the agent 1210 selects actions A to be performed and the environment 1220 responds to these Actions and presents new situations (or states 5) to the agent 1210. The action A comprises all possible actions, tasks, moves, etc., that the agent 1210 can take for a particular context. The state S is a current situation such as a complete description of a system, a unique configuration of information in a program or machine, a snapshot of a measure of various conditions in a system, and/or the like. In some implementations, the agent 1210 selects an action A to take based on a policy a. The policy it is a strategy that the agent 1210 employs to determine next action A based on the current state S. The environment 1220 also gives rise to rewards R, which are numerical values that the agent 1210 seeks to maximize over time through its choice of actions.

The environment 1220 starts by sending a state Sₜ to the agent 1210. In some implementations, the environment 1220 also sends an initial a reward Rₜ to the agent 1210 with the state Sₜ. The agent 1210, based on its knowledge, takes an action Aₜ in response to that state Sₜ, (and reward Rₜ, if any). The action Aₜ is fed back to the environment 1220, and the environment 1220 sends a state-reward pair including a next state Sₜ₊₁ and reward Rₜ₊₁ to the agent 1210 based on the action Aₜ. The agent 1210 will update its knowledge with the reward Rₜ₊₁ returned by the environment 1220 to evaluate its previous action(s). The process repeats until the environment 1220 sends a terminal state S, which ends the process or episode. Additionally or alternatively, the agent 1210 may take a particular action A to optimize a value V. The value Van expected long-term return with discount, as opposed to the short-term reward R. Vπ(S) is defined as the expected long-term return of the current state S under policy π.

Q-learning is a model-free RL algorithm that learns the value of an action in a particular state. Q-learning does not require a model of an environment 1220, and can handle problems with stochastic transitions and rewards without requiring adaptations. The “Q” in Q-learning refers to the function that the algorithm computes, which is the expected reward(s) for an action A taken in a given state S. In Q-learning, a Q-value is computed using the state Sₜ and the action Aₜ at time t using the function Q_{π}(Sₜ, Aₜ). Q_{π}(Sₜ, Aₜ) is the long-term return of a current state S taking action A under policy π. For any finite MDP (FMDP), Q-learning finds an optimal policy π in the sense of maximizing the expected value of the total reward over any and all successive steps, starting from the current state S. Additionally, examples of value-based deep RL include Deep Q-Network (DQN), Double DQN, and Dueling DQN. DQN is formed by substituting the Q-function of the Q-learning by an artificial neural network (ANN) such as a convolutional neural network (CNN).

In some example implementations, the RL model 1200 is used to control an ADAS application and/or CA/AD vehicle, such as any of those discussed herein. In some examples, the RL model 1200 is trained on perception data and/or the aforementioned state space representation, where it learns the types of decisions it should make (or actions to take) based on the state and/or environment. During training, the agent (e.g., the CA/AD vehicle) learns by taking a certain action in a certain state, and receives a reward based on the state-action pair. This process takes place over multiple epochs or training iterations, and at each epoch/iteration, the agent updates its memory of rewards; this may be the aforementioned policy π that describes how the agent makes decisions and/or defines the behavior of the agent at a given time. The policy is changed for every negative decision the agent makes, and in order to avoid receiving negative rewards, the agent checks the quality of a certain action against the policy. This is measured by the state-value function, where the state-value can be measured using the Bellman expectation equation. Additionally or alternatively, the observations from the underlying state is mapped to appropriate action(s) and the perception data is/are also mapped with appropriate action(s). Here, a Partially Observable Markov Decision Process (POMDP) can be used to make decisions based on the observation. In the POMDP, the agent senses the environment state with observations received from the perception data and takes a certain action followed by receiving a reward. The POMDP has six components and it can be denoted as POMDP M:=(I, S, A, R, P, γ), where, I is the observations, S is the finite set of states, A is a finite set of actions, R is a reward function, P is a transition probability function, and y is a discounting factor for future rewards. The objective of the RL model 1200 is to find the desired policy that maximizes the reward at each given time step or to find an optimal value-action function (Q-function). Additionally or alternatively, Q-learning can be used, where the agent will try to approximate the optimal state-action pair. The policy still determines which action-value pairs and/or the Q-value are visited and updated. The goal is to find optimal policy by interacting with the environment while modifying the same when the agent makes an error. With enough samples or observation (perception) data, the Q-learning RL model 1200 will learn optimal state-action value pairs.

### 5. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example [0284] include a method of operating a decentralized environmental notification service (DEN) facility of an originating Intelligent Transport System Station (ITS-S), comprising: receiving a DEN message (DENM) trigger request from an ITS-S application (app) when a safety metric is within a safety metric threshold; triggering generation of the DENM to include the safety metric based on the DENM trigger request; and causing transmit or broadcast the generated DENM to one or more other ITS-Ss.

Example [0285] includes the method of example [0284] and/or some other example(s) herein, wherein the safety metric is a minimum safe distance metric based on one or more of a distance between the originating ITS-S and a perceived object, a relative position of a perceived object with respect to the originating ITS-S, a relative speed between the originating ITS-S and the perceived object, a maximum possible acceleration of the originating ITS-S or the perceived object, a maximum possible deceleration of the originating ITS-S or the perceived object, a minimum possible deceleration of the originating ITS-S or the perceived object, and a response time of the originating ITS-S or the perceived object.

Example [0286] includes the method of example [0285] and/or some other example(s) herein, wherein the minimum safe distance metric is based on one or more of a comparison of a lateral distance (LaD) between the originating ITS-S and the perceived object with a minimum safe LaD (MSLaD); a comparison of a Longitudinal Distance (LoD) between the originating ITS-S and the perceived object with a minimum safe LoD (MSLoD); and/or a comparison of a Vertical Distance (VD) between the originating ITS-S and the perceived object with a minimum safe VD (MSVD), wherein the safety metric threshold is based on one or more of the MSLaD, the MSLoD, and the MSVD.

Example [0287] includes the method of example [0286] and/or some other example(s) herein, wherein the minimum safe distance metric is a minimum safe distance factor (MSDF), wherein the MSDF is based on one or more of a ratio of the LaD to the MSLaD; a ratio of the LoD to the MSLoD); and/or a ratio of the Vertical Distance VD to the MSVD.

Example [0288] includes the method of examples [0284]-[0287] and/or some other example(s) herein, wherein the safety metric is a rules of the road violation based on an instance of the originating ITS-S or a perceived object violating a traffic regulation.

Example [0289] includes the method of examples [0284]-[0288] and/or some other example(s) herein, wherein the safety metric is a driving behavioral competency value based on the originating ITS-S or a perceived object having correctly executed a specific behavioral competency action.

Example [0290] includes the method of examples [0284]-[0289] and/or some other example(s) herein, wherein the safety metric is a modified time to collision (MTTC), wherein the MTTC is a predicted time until a collision takes place between the originating ITS-S and a perceived object when the originating ITS-S and/or the perceived object maintain one or more of a speed, acceleration, or trajectory profile.

Example [0291] includes the method of examples [0284]-[0290] and/or some other example(s) herein, wherein the safety metric is a post encroachment time (PET), wherein the PET is a time from an end of encroachment of the originating ITS-S to a beginning of an encroachment of a perceived object to a potential point of a conflict between the originating ITS-S and the perceived object.

Example [0292] includes the method of examples [0284]-[0291] and/or some other example(s) herein, wherein the method comprises: generating the DENM to include the safety metric and a corresponding confidence level of the safety metric.

Example [0293] includes the method of examples [0284]-[0292] and/or some other example(s) herein, wherein the method comprises: generating the DENM to include the safety metric in an á la-carte container of the DENM.

Example [0294] includes the method of examples [0284]-[0293] and/or some other example(s) herein, wherein the method comprises: generating the DENM to include a cause code as an event type in an situation container of the DENM.

Example [0295] includes the method of examples [0284]-[0294] and/or some other example(s) herein, wherein the originating ITS-S is a vehicle ITS-S, a roadside ITS-S, or a vulnerable road user ITS-S.

Example [0296] includes a method of operating a decentralized environmental notification service (DEN) facility, comprising: receiving a DEN message (DENM) trigger request from an ITS-S application (app) when a safety metric is within a safety metric threshold, and generating a DENM to include the safety metric in an á la-carte container of the DENM based on the DENM trigger request; and causing transmission or broadcast the DENM to one or more other ITS-Ss.

Example [0297] includes the method of example [0296] and/or some other example(s) herein, wherein the safety metric includes one or more of one or more minimum safe distances; one or more minimum safety distance factors; a proper response action; a rules of the road violation; a driving behavioral competency metric; a modified time to collision; and a post encroachment time metric.

Example [0298] includes the method of examples [0296]-[0297] and/or some other example(s) herein, wherein the method includes: obtaining a DENM update trigger based on a detected update of the safety metric after receipt of the DENM trigger request; generating an update DENM to include the updated safety metric in the á la-carte container of the update DENM based on the DENM update trigger; and causing transmission or broadcast the update DENM to the one or more other ITS-Ss.

Example [0299] includes the method of examples [0296]-[0298] and/or some other example(s) herein, wherein the method includes: causing repeat transmission or broadcast of the DENM to the one or more other ITS-Ss based on a repitition interval.

Example [0300] includes the method of example [0296]-[0299] and/or some other example(s) herein, wherein the method includes obtaining an a DENM termination trigger based on a detected termination of an event related to the safety metric after receipt of the DENM trigger request; generating a termination DENM to terminate the DENM including the safety metric; and causing transmission or broadcast the termination DENM to the one or more other ITS-Ss.

Example [0301] includes the method of example [0300] and/or some other example(s) herein, wherein the termination DENM is a cancellation DENM or a negation DENM.

Example [0302] includes a method of operating a decentralized environmental notification service (DEN) facility of an Intelligent Transport System Station (ITS-S), the method comprising: receiving a DEN message (DENM) trigger request from an ITS-S application (app) of the ITS-S when a safety metric is within a safety metric threshold; generating a DENM to include: the safety metric in an à la-carte container of the DENM based on the DENM trigger request, and a cause code in an situation container of the DENM; and causing transmission or broadcast the DENM to one or more other ITS-Ss.

Example [0303] includes the method of example [0302] and/or some other example(s) herein, wherein the safety metric includes one or more of one or more minimum safe distances; one or more minimum safety distance factors; a proper response action; a rules of the road violation; a driving behavioral competency metric; a modified time to collision; and a post encroachment time metric.

Example [0304] includes the method of example [0302]-[0303] and/or some other example(s) herein, wherein the method includes: receiving an a DENM update trigger based on a detected update of the safety metric after receipt of the DENM trigger request; and generating an update DENM to include the updated safety metric in the à la-carte container of the update DENM based on the DENM update trigger; and causing transmission or broadcast the update DENM to the one or more other ITS-Ss.

Example [0305] includes the method of examples [0302]-[0304] and/or some other example(s) herein, wherein the method includes: causing repeat transmission or broadcast of the DENM to the one or more other ITS-Ss at a DENM repitition interval.

Example [0306] includes the method of examples [0302]-[0305] and/or some other example(s) herein, wherein the method includes: receiving an a DENM termination trigger based on a detected termination of an event related to the safety metric after receipt of the DENM trigger request; generating a termination DENM to terminate the DENM including the safety metric; and causing transmission or broadcast the termination DENM to the one or more other ITS-Ss.

Example [0307] includes the method of example [0306] and/or some other example(s) herein, wherein the termination DENM is a cancellation DENM or a negation DENM.

Example [0308] includes a method of operating a traffic safety ITS application of an originating Intelligent Transport System Station (ITS-S), comprising: receiving sensor data from respective sensors of a set of sensors accessible to the originating ITS-S; determining a safety metric based on the obtained sensor data; generating a decentralized environmental notification message (DENM) trigger request when the safety metric is within a safety metric threshold; and sending the DENM trigger request to a decentralized environmental notification service (DEN) facility when the safety metric is within the safety metric threshold.

Example [0309] includes the method of example [0308] and/or some other example(s) herein, wherein the traffic safety ITS application is the ITS application of any of examples [0284]-[307].

Example [0310] includes the method of examples [0284]-[0309] and/or some other example(s) herein, wherein the originating ITS-S is a vehicle ITS-S, a roadside ITS-S, or a vulnerable road user ITS-S.

Example [0311] includes one or more computer readable media comprising instructions, wherein execution of the instructions by processor circuitry is to cause the processor circuitry to perform the method of examples [0284]-[0310] and/or some other example(s) herein.

Example [0312] includes a computer program comprising the instructions of example [0311] and/or some other example(s) herein.

Example [0313] includes an Application Programming Interface defining functions, methods, variables, data structures, and/or protocols for the computer program of example [0312] and/or some other example(s) herein.

Example [0314] includes an apparatus comprising circuitry loaded with the instructions of example [0311] and/or some other example(s) herein.

Example [0315] includes an apparatus comprising circuitry operable to run the instructions of example [0311] and/or some other example(s) herein.

Example [0316] includes an integrated circuit comprising one or more of the processor circuitry and the one or more computer readable media of example [0311] and/or some other example(s) herein.

Example [0317] includes a computing system comprising the one or more computer readable media and the processor circuitry of example [0311] and/or some other example(s) herein.

Example [0318] includes an apparatus comprising means for executing the instructions of example [0311] and/or some other example(s) herein.

Example [0319] includes a signal generated as a result of executing the instructions of example [0311] and/or some other example(s) herein.

Example [0320] includes a data unit generated as a result of executing the instructions of example [0311] and/or some other example(s) herein.

Example [0321] includes the data unit of example [0320] and/or some other example(s) herein, wherein the data unit is a packet, frame, datagram, protocol data unit (PDU), service data unit (SDU), segment, message, data block, data chunk, cell, data field, data element, information element, type length value, set of bytes, set of bits, set of symbols, and/or database object.

Example [0322] includes a signal encoded with the data unit of examples [0320]-[0321] and/or some other example(s) herein.

Example [0323] includes an electromagnetic signal carrying the instructions of example [0311] and/or some other example(s) herein.

Example [0324] includes an apparatus comprising means for performing the method of examples [0284]-[0310] and/or some other example(s) herein.

### 6. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used w.r.t the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing.

The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least is in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit, a system of multiple circuits, and/or a combination of hardware elements configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system-on-chip (SoC), single-board computer (SBC), system-in-package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The terms “computer-readable medium”, “machine-readable medium”, “computer-readable storage medium”, and the like, at least in some examples refers to any tangible medium that is capable of storing, encoding, and/or carrying data structures, code, and/or instructions for execution by a processing device or other machine. Additionally or alternatively, the terms “computer-readable medium”, “machine-readable medium”, “computer-readable storage medium”, and the like, at least in some examples refers to any tangible medium that is capable of storing, encoding, and/or carrying data structures, code, and/or instructions that cause the processing device or machine to perform any one or more of the methodologies of the present disclosure. The terms “computer-readable medium”, “machine-readable medium”, “computer-readable storage medium”, and the like, at least in some examples refers include, but is/are not limited to, memory device(s), storage device(s) (including portable or fixed), and/or any other media capable of storing, containing, or carrying instructions or data.

The term “device” at least in some examples refers to a physical entity embedded inside, or attached to, another physical entity in its vicinity, with capabilities to convey digital information from or to that physical entity. The term “entity” at least in some examples refers to a distinct component of an architecture or device, or information transferred as a payload. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (MC), baseband processor, and the like). The term “network scheduler” at least in some examples can be used interchangeably with the terms “packet scheduler”, “queueing discipline” or “qdisc”, and/or “queueing algorithm”.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” may include any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM″ at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access

Network, Wireline BBF Access Network, and the like), network appliance, and/or some other network access hardware. The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “E-UTEAN NodeB”, “eNodeB”, or “eNB” at least in some examples refers to a RAN node providing E-UTRA user plane (PDCP/RLC/MAC/PHY) and control plane (RRC) protocol terminations towards a UE, and connected via an S1 interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (2022 Apr. 15) (“[TS37340]”)). Two or more en-gNBs are interconnected with each other (and/or with one or more eNBs) by means of an X2 interface. The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Transmission Reception Point” or “TRxP” at least in some examples refers to an antenna array with one or more antenna elements available to a network located at a specific geographical location for a specific area. The term “access point” or “AP” at least in some examples refers to an entity that contains one station (STA) and provides access to the distribution services, via the wireless medium (WM) for associated STAs. An AP comprises a STA and a distribution system access function (DSAF).

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “protocol” at least in some examples refers to a predefined procedure or method of performing one or more operations. Additionally or alternatively, the term “protocol” at least in some examples refers to a common means for unrelated objects or nodes to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (μTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet (e.g., IEEE Standard for Ethernet, IEEE Std 802.3-2018, pp. 1-5600 (31 Aug. 2018) (“[IEEE802.3]”), RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signaling Radio Bearers (SRBs) and Data Radio Bearers (DRBs); mobility functions/services; QoS management; and some sidelink specific services and functions over the Uu interface (see e.g., 3GPP TS 36.331 v17.2.0 (2022 Oct. 4) (“[TS36331]”) and/or 3GPP TS 38.331 v17.2.0 (2022 Oct.2) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022 Apr. 13)).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.1.0 (2022 Jul. 17) and/or 3GPP TS 38.323 v17.2.0 (2022 Sep. 29)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 38.322 v17.1.0 (2022 Jul. 17) and 3GPP TS 36.322 v17.0.0 (2022 Apr. 15)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v17.2.0 (2022 Oct. 1) and 3GPP TS 36.321 v17.2.0 (2022 Oct. 3)).

The term “physical layer”, “PHY layer”, or “PHY” at least in some examples refers to a protocol layer or sublayer that includes capabilities to transmit and receive modulated signals for communicating in a communications network (see e.g., [IEEE802], 3GPP TS 38.201 v17.0.0 (2022 Jan. 5) and 3GPP TS 36.201 v17.0.0 (2022 Mar. 31)).

The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network. The term “RAT type” at least in some examples may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MuLTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., [WiMAX] and variants thereof), Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.11ad, IEEE 802.11ay, and the like); short-range and/or wireless personal area network (WPAN) technologies/standards such as Bluetooth (and variants thereof such as Bluetooth 5.3, Bluetooth Low Energy (BLE), and the like), IEEE 802.15 technologies/standards (e.g., IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-G5B, ITS-GSC, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (WITS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples is provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “actionID” at least in some examples refers to an identifier of an detected event

The term “á la carte container or “alacarte container” at least in some examples refers to a container of DENM that includes information of the detected event in addition to management container, situation container and location container.

The term “basic set of applications” at least in some examples refers to a group of applications, supported by the vehicular communication system (see e.g., [TR102638])

The term “cancellation Decentralized Environmental Notification Message” or “cancellation DENM” at least in some examples refers to a DENM type generated by the ITS-S, which originated the new DENM, indicating the event termination

The term “Decentralized Environmental Notification basic service” or “DEN basic service” at least in some examples refers to a facility at the facilities layer to support ITS-S applications, DENM management and DENM dissemination.

The term “Decentralized Environmental Notification Message (DENM” at least in some examples refers to a ITS facilities layer PDU providing event information.

The term “Decentralized Environmental Notification Message (DENM) protocol” at least in some examples refers to a ITS facilities layer protocol that operates the DENM transmission, forwarding and reception.

The term “destination area” at least in some examples refers to a geographical area for DENM dissemination (see e.g., [EN302931]).

The term “downstream traffic” at least in some examples refers to a direction from the event position towards the departing traffic on the same carriageway.

The term “event” at least in some examples refers to a notable occurrence at a particular point in time. Additionally or alternatively, the term “event” at least in some examples refers to a road hazard, driving environment, or traffic condition. Additionally or alternatively, the term “event” at least in some examples refers to a set of outcomes of an experiment (e.g., a subset of a sample space) to which a probability is assigned. Additionally or alternatively, the term “event” at least in some examples refers to a software message indicating that something has happened. Additionally or alternatively, the term “event” at least in some examples refers to an object in time, or an instantiation of a property in an object. Additionally or alternatively, the term “event” at least in some examples refers to a point in space at an instant in time (e.g., a location in space-time).

The term “facility” at least in some examples refers to a functionality, service or data provided by the ITS facilities layer.

The term “forwarding Intelligent Transport System Station” or “forwarding ITS-S” at least in some examples refers to an ITS-S that forwards DENMs and implements the DENM protocol.

The term “location container” at least in some examples refers to a container of DENM that includes location data of the detected event

The term “management container” at least in some examples refers to a container of DENM that includes management data for DENM protocol.

The term “negation Decentralized Environmental Notification Message” or “negation DENM” at least in some examples refers to a DEN message type generated by an ITS-S other than the ITS-S, which originated the new DENM, indicating the event termination.

The term “new Decentralized Environmental Notification Message” or “new DENM” at least in some examples refers to a DEN message type indicating that the event is detected for the first time.

The term “originating Intelligent Transport System Station”, “originating ITS-S”, “transmitting ITS-S”, or “Tx ITS-S” at least in some examples refers to a ITS-S that generates DENMs or other ITS messages and implements the DENM protocol or other relevant ITS protocol.

The term “receiving Intelligent Transport System Station”, “receiving ITS-S”, or “Rx ITS-S” at least in some examples refers to a ITS-S that receives DENMs from the ITS networking & transport layer and implements the DENM protocol.

The term “relevance area” at least in some examples refers to a geographic area in which information concerning the event is identified as relevant for use or for further distribution

The term “situation container” at least in some examples refers to a container of DENM that includes data related to the detected event.

The term “update Decentralized Environmental Notification Message” or “update DENM” at least in some examples refers to a DEN message type indicating the evolution of the event.

The term “upstream traffic” at least in some examples refers to a direction from the event position towards the approaching traffic on the same carriageway.

The term “pre-crash situation” at least in some examples refers to a situation in which a collision is imminent, such as, for example, the time to collision is very low and/or a complete mitigation of a collision is unlikely.

The term “Collective Perception” or “CP” at least in some examples refers to the concept of sharing the perceived environment of an ITS-S based on perception sensors, wherein an ITS-S broadcasts information about its current (driving) environment. CP at least in some examples refers to the concept of actively exchanging locally perceived objects between different ITS-Ss by means of a V2X RAT. CP decreases the ambient uncertainty of ITS-Ss by contributing information to their mutual FoVs. The term “Collective Perception basic service”, “CP service”, or CPS” at least in some examples refers to a facility at the ITS-S facilities layer to receive and process CPMs, and generate and transmit CPMs. The term “Collective Perception Message” or “CPM” at least in some examples refers to a CP basic service PDU. The term “Collective Perception data” or “CPM data” at least in some examples refers to a partial or complete CPM payload. The term “Collective Perception protocol” or “CPM protocol” at least in some examples refers to an ITS facilities layer protocol for the operation of the CPM generation, transmission, and reception. The term “CP object” or “CPM object” at least in some examples refers to aggregated and interpreted abstract information gathered by perception sensors about other traffic participants and obstacles. CP/CPM Objects can be represented mathematically by a set of variables describing, amongst other, their dynamic state and geometric dimension. The state variables associated to an object are interpreted as an observation for a certain point in time and are therefore always accompanied by a time reference. The term “environment model” at least in some examples refers to a current representation of the immediate environment of an ITS-S, including all perceived objects perceived by either local perception sensors or received by V2X. The term “object” at least in some examples refers to the state space representation of a physically detected object within a sensor's perception range. The term “object list” refers to a collection of objects temporally aligned to the same timestamp.

The term “confidence level” at least in some examples refers to a probability with which an estimation of the location of a statistical parameter (e.g., an arithmetic mean) in a sample survey is also true for a population (e.g., a sample survey that is also true for an entire population from which the samples were taken). The term “confidence value” at least in some examples refers to an estimated absolute accuracy of a statistical parameter (e.g., an arithmetic mean) for a given confidence level (e.g., 95%). Additionally or alternatively, the term “confidence value” or “confidence interval” at least in some examples refers to an estimated interval associated with the estimate of a statistical parameter of a population using sample statistics (e.g., an arithmetic mean) within which the true value of the parameter is expected to lie with a specified probability, equivalently at a given confidence level (e.g., 95%). In some examples, confidence intervals are neither to be confused with nor used as estimated uncertainties (covariances) associated with either the output of stochastic estimation algorithms used for tasks such as kinematic and attitude state estimation and the associated estimate error covariance, or the measurement noise variance associated with a sensor's measurement of a physical quantity (e.g., variance of the output of an accelerometer or specific force meter). The term “detection confidence” at least in some examples refers to a measure related to the certainty, generally a probability. In some examples, the “detection confidence” refers to a sensor or sensor system associates with its output or outputs involving detection of an object or objects from a set of possibilities (e.g., with X % probability the object is a chair, with Y % probability the object is a couch, and with (1−X−Y)% probability it is something else). The term “free space existence confidence” or “perceived region confidence” at least in some examples refers to a quantification of the estimated likelihood that free spaces or unoccupied areas may be detected within a perceived region.

The term “ITS data dictionary” at least in some examples refers to a repository of DEs and DFs used in the ITS applications and ITS facilities layer. The term “ITS message” at least in some examples refers to messages exchanged at ITS facilities layer among ITS stations or messages exchanged at ITS applications layer among ITS stations.

The term “ITS station” or “ITS-S” at least in some examples refers to functional entity specified by the ITS station (ITS-S) reference architecture. The term “personal ITS-S” or “P-ITS-S” refers to an ITS-S in a nomadic ITS sub-system in the context of a portable device (e.g., a mobile device of a pedestrian). The term “Roadside ITS-S” or “R-ITS-S” at least in some examples refers to an ITS-S operating in the context of roadside ITS equipment. The term “Vehicle ITS-S” or “V-ITS-S” at least in some examples refers to an ITS-S operating in the context of vehicular ITS equipment. The term “ITS central system” or “Central ITS-S” refers to an ITS system in the backend, for example, traffic control center, traffic management center, or cloud system from road authorities, ITS application suppliers or automotive OEMs.

The term “object” at least in some examples refers to a material thing that can be detected and with which parameters can be associated that can be measured and/or estimated. The term “object existence confidence” at least in some examples refers to a quantification of the estimated likelihood that a detected object exists, e.g., has been detected previously and has continuously been detected by a sensor. The term “object list” at least in some examples refers to a collection of objects and/or a data structure including a collection of detected objects.

The term “geographical area”, “geographic area”, or “geo-area” at least in some examples refers to a defined two-dimensional (2D) or three-dimensional (3D) area, region, plot of land, or other demarcated terrestrial space that can be considered as a unit. In some examples, a “geographical area”, “geographic area”, or “geo-area” is represented by a bounding-box or one or more geometric shapes, such as circles, spheres, rectangles, cubes, cuboids, ellipses, ellipsoids, and/or any other 2D or 3D shape.

The term “geo-fence” or “geofence” at least in some examples refers to a virtual perimeter or boundary that corresponds to a real-world geographic area (or a geo-area). In some examples, a “geo-fence” or “geofence” can correspond to a predefined boundary or border (e.g., property/plot boundaries; school zones; neighborhood boundaries; national or provincial boundaries; a configured or user-selectable boundary; a cell provided by a network access node; a service area, registration area, tracking area, 5G enhanced positioning area, and/or 5G positioning service area, as defined by relevant 3GPP standards, and/or the like) and/or can be dynamically generated (e.g., radius around a point/location of an entity/element, or some other shape of a dynamic of predefined size surrounding a point/location of an entity/element). The term “geofencing” at least in some examples refers to the use of a geofence, for example, by using a location-aware device and/or location services to determine when a user enters and/or exits a geofence.

The term “sensor measurement” at least in some examples refers to abstract object descriptions generated or provided by feature extraction algorithm(s), which may be based on the measurement principle of a local perception sensor mounted to a station/UE, wherein a feature extraction algorithm processes a sensor's raw data (e.g., reflection images, camera images, and the like) to generate an object description. The term “state space tepresentation” at least om some examples refers to a mathematical description of a detected object (or perceived object), which includes a set of state variables, such as distance, position, velocity or speed, attitude, angular rate, object dimensions, and/or the like. In some examples, state variables associated with/to an object are interpreted as an observation for a certain point in time, and are accompanied by a time reference.

The term “vehicle” at least in some examples refers to a machine designed to carry people or cargo. Examples of “vehicles” include wagons, bicycles, motor vehicles (e.g., electric bicycles, motorcycles, cars, trucks, motor homes, buses, mobility scooters, Segways, and/or the like), railed vehicles (e.g., trains, trams, trolleybuses, and/or the like), watercraft (e.g., ships, boats, underwater vehicles, and/or the like), cable transport vehicles (e.g., cable cars, gondolas, chairlifts, a type of aerial lift, and/or the like), amphibious vehicles (e.g., screw-propelled vehicles, hovercraft, and/or the like), aircraft (e.g., airplanes, helicopters, aerostats, balloons, air ships, UAVs, and/or the like), and spacecraft (e.g., spaceships, satellites, and/or the like). Additionally, “vehicles” may be human-operated vehicles, semi-autonomous or computer-assisted vehicles, and/or autonomous vehicles. The term “electric vehicle” or “EV” at least in some examples refers to a vehicle that uses one or more electric motors for propulsion. In some examples, “electric vehicles” are powered by a collector system with electricity from extra-vehicular sources (e.g., overhead cables, electric third rails, group level power supplies, in-road inductive loop charging or wireless on-road charging systems, and/or the like) or powered autonomously by a battery, which can be charged by solar panels, or by converting fuel to electricity using fuel cells or a generator. The term “batter electric vehicle” or “BEV” at least in some examples refers to an EV that exclusively uses chemical energy stored in rechargeable battery packs for electric motors and motor controllers, with no secondary source of propulsion (e.g., hydrogen fuel cells, internal combustion engines, and the like). The term “plug-in electric vehicle” or “PEV” at least in some examples refers to a vehicle that can utilize an external source of electricity, such as a wall socket that connects to a power grid, to store electrical power within its onboard rechargeable battery packs, which then powers its electric motor(s) and contributes to propelling the vehicle.

The term “Vehicle-to-Everything” or “V2X” at least in some examples refers to vehicle to vehicle (V2V), vehicle to infrastructure (V2I), infrastructure to vehicle (I2V), vehicle to network (V2N), and/or network to vehicle (N2V) communications and associated RATs.

The term “application” at least in some examples refers to a computer program designed to carry out a specific task other than one relating to the operation of the computer itself. Additionally or alternatively, term “application” at least in some examples refers to a complete and deployable package, environment to achieve a certain function in an operational environment. The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like. The term “process” at least in some examples refers to an instance of a computer program that is being executed by one or more threads. In some implementations, a process may be made up of multiple threads of execution that execute instructions concurrently. The term “algorithm” at least in some examples refers to an unambiguous specification of how to solve a problem or a class of problems by performing calculations, input/output operations, data processing, automated reasoning tasks, and/or the like. The terms “instantiate,” “instantiation,” and the like at least in some examples refers to the creation of an instance. An “instance” also at least in some examples refers to a concrete occurrence of an object, which may occur, for example, during execution of program code.

The term “advanced driver-assistance system” or “ADAS” at least in some examples at least in some examples refers to a groups of electronic systems, devices, and/or other technologies that assist drivers in driving and parking functions. In some examples, ADAS uses automation technology, including sensors and computing devices, to detect nearby obstacles or driver errors, and respond accordingly. Examples of ADAS include cruise control and/or adaptive cruise control, anti-lock braking system, automatic parking, backup cameras, blind spot cameras/detection, collision avoidance system, crosswind stabilization, descent control, driver warning systems, electronic stability control, emergency driver assistance, head-up display (HUD), hill start-assist, lane centering, lane change assistance, navigation systems, night vision systems, omniview technology, rain sensing, traction control system, traffic sign recognition, vehicle communication systems, and/or the like.

The term “data unit” at least in some examples at least in some examples refers to a basic transfer unit associated with a packet-switched network; a datagram may be structured to have header and payload sections. The term “data unit” at least in some examples may be synonymous with any of the following terms, even though they may refer to different aspects: “datagram”, a “protocol data unit” or “PDU”, a “service data unit” or “SDU”, “frame”, “packet”, a “network packet”, “segment”, “block”, “cell”, “chunk”, “message”, “information element” or “IE”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a [IEEE802] protocol/standard (e.g., [IEEE80211] or the like), Type Length Value (TLV), and/or other like data structures.

The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. In some examples, the data stored in a data element may be referred to as the data element's content, “content item”, or “item”.

The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

The term “lateral” at least in some examples refers to directions or positions relative to an object spanning the width of a body of the object, relating to the sides of the object, and/or moving in a sideways direction with respect to the object. The term “lateral distance” or “LaD” at least in some examples refers to an estimated distance between an ego device and another device perpendicular to the direction of the ego device and/or other device heading.

The term “longitudinal” at least in some examples refers to directions or positions relative to an object spanning the length of a body of the object; relating to the top or bottom of the object, and/or moving in an upwards and/or downwards direction with respect to the object. The term is “longitudinal distance” or “LoD” at least in some examples refers to estimated distance between an ego device and another device along the direction of the ego device and/or other device heading.

The term “vertical” at least in some examples refers to a direction aligned with the direction of the force of gravity (e.g., up or down). The term “horizontal” at least in some examples refers to a direction or plane that is perpendicular to the vertical direction. The term “vertical distance” or “VD” at least in some examples refers to estimated distance in vertical direction (height) between an ego device and another device.

The term “Minimum Safe Lateral Distance” or “MSLaD” at least in some examples refers to minimum lateral separation between an ego device and another device for safety.

The term “Minimum Safe Longitudinal Distance” or “MSLoD” at least in some examples refers to minimum longitudinal separation between an ego device and another device for safety.

The term “Minimum Safe Vertical Distance” or “MSVD” at least in some examples refers to minimum vertical separation between an ego device and another device for safety.

The term “artificial intelligence” or “AI” at least in some examples refers to any intelligence demonstrated by machines, in contrast to the natural intelligence displayed by humans and other animals. Additionally or alternatively, the term “artificial intelligence” or “AI” at least in some examples refers to the study of “intelligent agents” and/or any device that perceives its environment and takes actions that maximize its chance of successfully achieving a goal.

The term “converge” or “convergence” at least in some examples refers to the stable point found at the end of a sequence of solutions via an iterative optimization algorithm. Additionally or alternatively, the term “converge” or “convergence” at least in some examples refers to the output of a function or algorithm getting closer to a specific value over multiple iterations of the function or algorithm.

The term “optimization” at least in some examples refers to an act, process, or methodology of making something (e.g., a design, system, or decision) as fully perfect, functional, or effective as possible. Optimization usually includes mathematical procedures such as finding the maximum or minimum of a function. The term “optimal” at least in some examples refers to a most desirable or satisfactory end, outcome, or output. The term “optimum” at least in some examples refers to an amount or degree of something that is most favorable to some end. The term “optima” at least in some examples refers to a condition, degree, amount, or compromise that produces a best possible result. Additionally or alternatively, the term “optima” at least in some examples refers to a most favorable or advantageous outcome or result.

The term “standard deviation” at least in some examples refers to a measure of the amount of variation or dispersion of a set of values. Additionally or alternatively, the term “standard deviation” at least in some examples refers to the square root of a variance of a random variable, a sample, a statistical population, a dataset, or a probability distribution.

Although many of the previous examples are provided with use of specific cellular/mobile network terminology, including with the use of 4G/5G 3GPP network components (or expected terahertz-based 6G/6G+technologies), it will be understood these examples may be applied to many other deployments of wide area and local wireless networks, as well as the integration of wired networks (including optical networks and associated fibers, transceivers, and/or the like). Furthermore, various standards (e.g, 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. An originating Intelligent Transport System Station (ITS-S), comprising:
communication circuitry to transmit or broadcast a generated DEN message (DENM) to one or more other ITS-Ss; and
processor circuitry connected to the communication circuitry, wherein the processor circuitry is to operate a decentralized environmental notification service (DEN) facility to:
receive a DENM trigger request from an ITS-S application (app) when a safety metric is within a safety metric threshold, and
trigger generation of the DENM to include the safety metric based on the DENM trigger request.

2. The originating ITS-S of claim 1, wherein the safety metric is a minimum safe distance metric based on one or more of a distance between the originating ITS-S and a perceived object, a relative position of a perceived object with respect to the originating ITS-S, a relative speed between the originating ITS-S and the perceived object, a maximum possible acceleration of the originating ITS-S or the perceived object, a maximum possible deceleration of the originating ITS-S or the perceived object, a minimum possible deceleration of the originating ITS-S or the perceived object, and a response time of the originating ITS-S or the perceived object.

3. The originating ITS-S of claim 2, wherein the minimum safe distance metric is based on one or more of:
a comparison of a lateral distance (LaD) between the originating ITS-S and the perceived object with a minimum safe LaD (MSLaD);
a comparison of a Longitudinal Distance (LoD) between the originating ITS-S and the perceived object with a minimum safe LoD (MSLoD); and
a comparison of a Vertical Distance (VD) between the originating ITS-S and the perceived object with a minimum safe VD (MSVD),
wherein the safety metric threshold is based on one or more of the MSLaD, the MSLoD, and the MSVD.

4. The originating ITS-S of claim 3, wherein the minimum safe distance metric is a minimum safe distance factor (MSDF), wherein the MSDF is based on one or more of:
a ratio of the LaD to the MSLaD;
a ratio of the LoD to the MSLoD); and
a ratio of the Vertical Distance VD to the MSVD.

5. The originating ITS-S of claim 1, wherein the safety metric is a rules of the road violation based on an instance of the originating ITS-S or a perceived object violating a traffic regulation.

6. The originating ITS-S of claim 1, wherein the safety metric is a driving behavioral competency value based on the originating ITS-S or a perceived object having correctly executed a specific behavioral competency action.

7. The originating ITS-S of claim 1, wherein the safety metric is a modified time to collision (MTTC), wherein the MTTC is a predicted time until a collision takes place between the originating ITS-S and a perceived object when the originating ITS-S and/or the perceived object maintain one or more of a speed, acceleration, or trajectory profile.

8. The originating ITS-S of claim 1, wherein the safety metric is a post encroachment time (PET), wherein the PET is a time from an end of encroachment of the originating ITS-S to a beginning of an encroachment of a perceived object to a potential point of a conflict between the originating ITS-S and the perceived object.

9. The originating ITS-S of claim 1, wherein the processor circuitry is to operate the DEN facility to:
generate the DENM to include the safety metric and a corresponding confidence level of the safety metric.

10. The originating ITS-S of claim 1, wherein the processor circuitry is to operate the DEN facility to:
generate the DENM to include the safety metric in an á la-carte container of the DENM.

11. The originating ITS-S of claim 1, wherein the processor circuitry is to operate the DEN facility to:
generate the DENM to include a cause code as an event type in an situation container of the DENM.

12. The originating ITS-S of claim 1, wherein the processor circuitry is to operate the ITS app to:
obtain sensor data from respective sensors of a set of sensors; and
determine the safety metric based on the obtained sensor data; and
send the DENM trigger request to the DEN facility when the safety metric is within the safety metric threshold.

13. The originating ITS-S of claim 1, wherein the originating ITS-S is a vehicle ITS-S, a roadside ITS-S, or a vulnerable road user ITS-S.

14. One or more non-transitory computer readable medium comprising instructions of a decentralized environmental notification service (DEN) facility, wherein execution of the instructions is to cause an originating Intelligent Transport System Station (ITS-S) to:
receive a DEN message (DENM) trigger request from an ITS-S application (app) when a safety metric is within a safety metric threshold, and
generate a DENM to include the safety metric in an á la-carte container of the DENM based on the DENM trigger request; and
cause transmission or broadcast the DENM to one or more other ITS-Ss.

15. The one or more non-transitory computer readable medium of claim 14, wherein the safety metric includes one or more of one or more minimum safe distances; one or more minimum safety distance factors; a proper response action; a rules of the road violation; a driving behavioral competency metric; a modified time to collision; and a post encroachment time metric.

16. The one or more non-transitory computer readable medium of claim 14, wherein execution of the instructions is to cause the originating ITS-S to:
obtain an a DENM update trigger based on a detected update of the safety metric after receipt of the DENM trigger request; and
generate an update DENM to include the updated safety metric in the á la-carte container of the update DENM based on the DENM update trigger; and
cause transmission or broadcast the update DENM to the one or more other ITS-Ss.

17. The one or more non-transitory computer readable medium of claim 14, wherein execution of the instructions is to cause the originating ITS-S to:
cause repeat transmission or broadcast of the DENM to the one or more other ITS-Ss based on a repitition interval.

18. The one or more non-transitory computer readable medium of claim 14, wherein execution of the instructions is to cause the originating ITS-S to:
obtain an a DENM termination trigger based on a detected termination of an event related to the safety metric after receipt of the DENM trigger request; and
generate a termination DENM to terminate the DENM including the safety metric; and
cause transmission or broadcast the termination DENM to the one or more other ITS-Ss.

19. The one or more non-transitory computer readable medium of claim 18, wherein the termination DENM is a cancellation DENM or a negation DENM.

20. A method of operating a decentralized environmental notification service (DEN) facility of an Intelligent Transport System Station (ITS-S), the method comprising:
receiving a DEN message (DENM) trigger request from an ITS-S application (app) of the ITS-S when a safety metric is within a safety metric threshold;
generating a DENM to include:
the safety metric in an á la-carte container of the DENM based on the DENM trigger request, and
a cause code in an situation container of the DENM; and
causing transmission or broadcast the DENM to one or more other ITS-Ss.

21. The method of claim 20, wherein the safety metric includes one or more of one or more minimum safe distances; one or more minimum safety distance factors; a proper response action;
a rules of the road violation; a driving behavioral competency metric; a modified time to collision;
and a post encroachment time metric.

22. The method of claim 20, wherein the method includes:
receiving an a DENM update trigger based on a detected update of the safety metric after receipt of the DENM trigger request; and
generating an update DENM to include the updated safety metric in the á la-carte container of the update DENM based on the DENM update trigger; and
causing transmission or broadcast the update DENM to the one or more other ITS-Ss.

23. The method of claim 20, wherein the method includes:
causing repeat transmission or broadcast of the DENM to the one or more other ITS-Ss at a DENM repitition interval.

24. The method of claim 20, wherein the method includes:
receiving an a DENM termination trigger based on a detected termination of an event related to the safety metric after receipt of the DENM trigger request; and
generating a termination DENM to terminate the DENM including the safety metric; and
causing transmission or broadcast the termination DENM to the one or more other ITS-Ss.

25. The method of claim 24, wherein the termination DENM is a cancellation DENM or a negation DENM.
